(19) United States
(12) Patent Application Publication
(10) Pub. No.: US 2026/0367360 A1
(43) Pub. Date: Nov. 19, 2026

(54) OPTICAL SYSTEM AND CAMERA MODULE

(71) Applicant: LG INNOTEK CO., LTD., Seoul (KR)

(72) Inventor: Ju Yong SHIM, Seoul (KR)

(21) Appl. No.: 19/147,925

(22) PCT Filed: Jan. 10, 2024
(86) PCT No.: PCT/KR2024/000508

§ 371 Date: Jul. 14, 2025

(30) Foreign Application Priority Data
Jan. 12, 2023 (KR) 10-2023-0005028
Apr. 19, 2023 (KR) 10-2023-0051651

(51) Int. Cl. G02B 13/00; G02B 1/04; G02B 3/00; G02B 7/02; G02B 9/64

(52) U.S. Cl. CPC G02B 13/0045; G02B 1/041; G02B 7/028; G02B 9/64; G02B 2003/0093

(57) ABSTRACT

An optical system, according to one embodiment of the present invention, comprises, first to ninth lenses disposed along an optical axis, wherein the first lens has negative (−) refractive power, the fourth lens has positive (+) refractive power, the sixth lens has positive (+) refractive power, the seventh lens has negative (−) refractive power, the eighth lens has positive (+) refractive power, and the ninth lens has negative (−) refractive power. The thickness of the eighth lens is the largest among the first to ninth lenses on the optical axis, and the distance between the first lens and the second lens is the largest among the distances between adjacent lenses on the optical axis.

### TECHNICAL FIELDS

The teachings in accordance with exemplary and non-limiting embodiments of the present invention relate generally to an optical system for improved optical performance and a camera module including the same.

### BACKGROUND ARTS OF THE INVENTION

ADAS (Advanced Driving Assistance System) is an advanced driver assistance system designed to assist drivers in driving. It consists of sensing the situation ahead, judging the situation based on the sensed results, and controlling the vehicle's behavior based on the situation judgment. For example, ADAS sensor devices detect vehicles ahead and recognize lanes. Once the target lane, target speed, or target ahead is determined, systems such as ESC (Electrical Stability Control), EMS (Engine Management System), and MDPS (Motor Driven Power Steering) are controlled. Typically, ADAS can be implemented as an automatic parking system, low-speed city driving assistance system, or blind spot warning system. Sensors used in ADAS to detect the front situation include GPS sensors, laser scanners, front radars, and Lidar, with the most representative being cameras that capture images of the vehicle's front, rear, and sides.

Such cameras can be placed outside or inside a vehicle to detect the vehicle's surroundings. In addition, the cameras can be placed inside the vehicle to detect the driver's and passengers' conditions. For example, the cameras can film the driver from a position adjacent to the driver and detect the driver's health condition, drowsiness, and drunkenness. Furthermore, the camera can film passengers from a position adjacent to them, detect whether they are asleep or their health condition, and provide the driver with information about the passengers.

In particular, the most important element for obtaining an image from a camera is the imaging lens that forms the image. Recently, there has been increasing interest in high-performance features such as high-resolution and high-definition, and research is being conducted on optical systems incorporating multiple lenses to achieve these features. However, when the camera is exposed to harsh environments, such as high temperatures, low temperatures, moisture, or high humidity, either inside or outside the vehicle, the characteristics of the optical system may change. In such cases, it is difficult to consistently achieve excellent optical characteristics and aberration characteristics.

Therefore, a new optical system and camera capable of addressing the aforementioned issues are required.

### SUMMARY OF THE INVENTION

### Technical Subject

The embodiment is intended to provide an optical system and camera module with improved optical characteristics.

The embodiment is intended to provide an optical system with excellent optical performance in low-temperature to high-temperature environments and a camera module.

The embodiment is intended to provide an optical system that can prevent or minimize changes in optical characteristics over a wide temperature range and a camera module.

### Technical Solution

To solve the above technical subjects, an optical system, according to one embodiment of the present invention, comprises, first to ninth lenses disposed along an optical axis, wherein the first lens has negative (−) refractive power, the fourth lens has positive (+) refractive power, the sixth lens has positive (+) refractive power, the seventh lens has negative (−) refractive power, the eighth lens has positive (+) refractive power, and the ninth lens has negative (−) refractive power. The thickness of the eighth lens is the largest among the first to ninth lenses on the optical axis, and the distance between the first lens and the second lens is the largest among the distances between adjacent lenses on the optical axis.

Preferably, but not necessarily, at least one of the first lens and the fourth lens may be made of glass, and at least one of the second to third lenses and the fifth to ninth lenses may be made of plastic.

Preferably, but not necessarily, an aperture may be disposed between the second lens and the third lens, and at least one of the curvature radii of the sensor side surface of the second lens facing the aperture and the curvature radii of the sensor side surface of the third lens may satisfy the range of 10 or more to 20 or less.

Preferably, but not necessarily, the first lens may have a convex meniscus shape toward the object side and the ninth lens may have a convex meniscus shape toward the sensor side.

Preferably, but not necessarily, the absolute value of the focal length of the fifth lens may be the largest among the first to ninth lenses.

Preferably, but not necessarily, the maximum distance between the two lenses with the largest difference in Abbe number among the lenses disposed adjacent to each other from the optical axis to the effective diameter area may be smaller than the maximum distance between other adjacent pairs of lenses.

Preferably, but not necessarily, the sixth lens and the seventh lens may have the largest difference in Abbe number among the adjacent lenses.

Preferably, but not necessarily, the following condition may be satisfied. <Condition>80<FOV_H<90

(In the above condition, FOV_H refers to the horizontal field of view (Horizontal Degree) of the above optical system.)

Preferably, but not necessarily, the following condition may be satisfied. <Condition>0.2<CG1/ΣCG<0.7

(In the above condition, CG1 is the distance between the first lens and the second lens on the optical axis, and ΣCG is the sum of the gaps (intervals) between adjacent lenses on the optical axis.)

Preferably, but not necessarily, the following condition may be satisfied. <Condition>5<TTL/ImgH<6

(In the above condition, TTL is the distance along the optical axis from the vertex of the object side surface of the first lens to the image surface of the image sensor, and ImgH is ½ of the maximum diagonal length of the image sensor.)

To solve the above technical subjects, an optical system, according to one embodiment of the present invention, may comprise, first to ninth lenses disposed along an optical axis, wherein the first lens has a negative (−) refractive power, the fourth lens has a positive (+) refractive power, the sixth lens has a positive (+) refractive power, the seventh lens has a negative (−) refractive power, the eighth lens has a positive (+) refractive power, and the ninth lens has a negative (−) refractive power. The effective diameter of the second lens or the third lens is the smallest among the first to ninth lenses, and the effective diameter of the first lens is the largest among the first to ninth lenses.

Preferably, but not necessarily, the distance between the first lens and the second lens may be the largest among the distances between adjacent lenses on the optical axis.

Preferably, but not necessarily, an aperture may be disposed between the third lens and the fourth lens, and the optical system may comprise: first lens group disposed on the object side with respect to the aperture and the second lens group disposed on the sensor side with respect to the aperture, and the sign of the composite focal length of the first lens group may be different from that of the second lens group.

Preferably, but not necessarily, At least one of the lenses disposed on the object side and sensor side of the aperture may be made of glass.

Preferably, but not necessarily, the maximum distance between the sixth lens and the seventh lens, from the optical axis to the effective diameter area, may be smaller than the maximum distance between other adjacent lenses.

Preferably, but not necessarily, the following condition may be satisfied. <Condition>1.5<ΣCT/ΣCG<2.5

(In the above condition, ΣCT refers to the sum of the center thicknesses of the first to ninth lenses on the optical axis, and ΣCG refers to the sum of gaps between adjacent lenses on the optical axis.)

### Advantageous Effects

The optical system and camera module according to the embodiment may have improved optical characteristics. More specifically, in the optical system according to the embodiment, the plural lenses may have a set thickness, refractive power, and gap (spacing) between adjacent lenses. As a result, the optical system and camera module according to the embodiment may have improved MTF characteristics, aberration control characteristics, resolution characteristics, etc., within a predetermined field of view range, and may exhibit good optical performance in the peripheral regions of the field of view.

Additionally, the optical system and camera module according to the embodiment may exhibit good optical performance within a temperature range of low to high temperatures (−40 °C to 105 °C). In detail, the multiple lenses included in the optical system may have a set material, refractive power, and refractive index. As a result, when the refractive index of each lens changes due to temperature changes, and consequently the focal length of each lens changes, the plastic lenses and glass lenses can compensate for each other. In other words, the optical system can effectively distribute refractive power across the low-temperature to high-temperature range and prevent or minimize changes in optical characteristics within the temperature range. Therefore, the optical system and camera module according to the embodiment can maintain improved optical characteristics over a wide temperature range.

Furthermore, the optical system and camera module according to the embodiment can satisfy the set field of view and achieve excellent optical characteristics through a combination of plastic lenses and glass lenses. As a result, the optical system can provide a slimmer vehicle camera module. Therefore, the optical system and camera module can be provided for various applications and devices, and maintain excellent optical characteristics even under harsh temperature conditions, such as exposure to the exterior of a vehicle or high temperatures inside a vehicle during summer.

### BRIEF DESCRIPTION OF DRAWINGS

FIG. 1 is a side cross-sectional view of an optical system and a camera module having the same according to a first embodiment.

FIG. 2 is a table showing the aspheric coefficients of the lenses in the optical system of FIG. 1.

FIG. 3 is a table showing the thickness of each lens in the optical system of FIG. 1 and the gap (spacing) between adjacent lenses.

FIG. 4 is a table showing the Sag values of the lens surfaces of the first to ninth lenses in the optical system of FIG. 1.

FIG. 5 is a table showing the slope angle values of the lens surfaces of the first to ninth lenses in the optical system of FIG. 1.

FIG. 6 is a graph showing the diffraction MTF (Modulation Transfer Function) data at room temperature for the optical system of FIG. 1.

FIG. 7 is a graph showing the aberration characteristics data at room temperature for the optical system of FIG. 1.

FIG. 8 is a graph showing the diffraction MTF data at low temperatures for the optical system shown in FIG. 1.

FIG. 9 is a graph showing the aberration characteristics data at low temperatures for the optical system shown in FIG. 1.

FIG. 10 is a graph showing the diffraction MTF data at high temperatures for the optical system shown in FIG. 1.

FIG. 11 is a graph showing data on the aberration characteristics of the optical system in FIG. 1 at high temperatures.

FIG. 12 is a graph showing the peripheral light intensity ratio of the optical system in FIG. 1.

FIG. 13 is a side cross-sectional view of the optical system and a camera module having the same according to a second embodiment.

FIG. 14 is a table showing the aspheric coefficients of the lenses in the optical system of FIG. 13.

FIG. 15 is a table showing the thickness of each lens and the gap (spacing) between adjacent lenses in the optical system of FIG. 13.

FIG. 16 is a table showing the sag values of the lens surfaces of the first to ninth lenses in the optical system of FIG. 13.

FIG. 17 is a table showing the slope angles of the lens surfaces of the first to ninth lenses in the optical system of FIG. 13.

FIG. 18 is a graph showing data on the diffraction MTF (Modulation Transfer Function) at room temperature for the optical system of FIG. 13.

FIG. 19 is a graph showing the aberration characteristics data of the optical system shown in FIG. 13 at room temperature.

FIG. 20 is a graph showing the diffraction MTF data of the optical system shown in FIG. 13 at low temperature.

FIG. 21 is a graph showing data on the aberration characteristics of the optical system in FIG. 13 at low temperatures.

FIG. 22 is a graph showing data on the diffraction MTF of the optical system in FIG. 13 at high temperatures.

FIG. 23 is a graph showing data on the aberration characteristics of the optical system in FIG. 13 at high temperatures.

FIG. 24 is a graph showing the peripheral light intensity ratio of the optical system shown in FIG. 13.

FIG. 25 is a side cross-sectional view of the optical system and a camera module having the same according to a third embodiment.

FIG. 26 is a table showing the aspheric coefficients of the lenses in the optical system shown in FIG. 25.

FIG. 27 is a table showing the thickness of each lens and the gap (spacing) between adjacent lenses in the optical system of FIG. 25.

FIG. 28 is a table showing the sag values of the lens surfaces of the first to ninth lenses in the optical system of FIG. 25.

FIG. 29 is a table showing the slope angles of the lens surfaces of the first to ninth lenses in the optical system of FIG. 25.

FIG. 30 is a graph showing the data for the diffraction MTF at room temperature of the optical system of FIG. 25.

FIG. 31 is a graph showing data on the aberration characteristics of the optical system in FIG. 25 at room temperature.

FIG. 32 is a graph showing data on the diffraction MTF (Modulation Transfer Function) of the optical system in FIG. 25 at low temperatures.

FIG. 33 is a graph showing data on the aberration characteristics of the optical system in FIG. 25 at low temperatures.

FIG. 34 is a graph showing the diffraction MTF data of the optical system shown in FIG. 25 at high temperatures.

FIG. 35 is a graph showing the aberration characteristics data of the optical system shown in FIG. 25 at high temperatures.

FIG. 36 is a graph showing the peripheral light intensity ratio of the optical system shown in FIG. 25.

FIG. 37 is a cross-sectional view of the optical system and a camera module comprising the same according to a fourth embodiment.

FIG. 38 is a table showing the aspheric coefficients of the lenses in the optical system of FIG. 37.

FIG. 39 is a table showing the thickness of each lens and the gap (spacing) between adjacent lenses in the optical system of FIG. 37.

FIG. 40 is a table showing the sag values of the lens surfaces of the first to ninth lenses in the optical system of FIG. 37.

FIG. 41 is a table showing the slope angles of the lens surfaces of the first to ninth lenses in the optical system of FIG. 37.

FIG. 42 is a graph showing data on the diffraction MTF (Modulation Transfer Function) at room temperature for the optical system of FIG. 37.

FIG. 43 is a graph showing data on the aberration characteristics of the optical system in FIG. 37 at room temperature.

FIG. 44 is a graph showing data on the diffraction MTF of the optical system in FIG. 37 at low temperatures.

FIG. 45 is a graph showing data on the aberration characteristics of the optical system in FIG. 37 at low temperatures.

FIG. 46 is a graph showing the diffraction MTF data at high temperatures for the optical system shown in FIG. 37.

FIG. 47 is a graph showing the aberration characteristics data at high temperatures for the optical system shown in FIG. 37.

FIG. 48 is a graph showing the peripheral light intensity ratio of the optical system shown in FIG. 37.

FIG. 49 is an example of a vehicle equipped with an optical system according to an embodiment of the invention.

### BEST MODE

Hereinafter, exemplary embodiments of the present invention will be described in detail with reference to the accompanying drawings.

However, the present invention is not limited to the given exemplary embodiments described, but may be implemented in a variety of different forms, and one or more of components among the exemplary embodiments may be optionally combined or substituted between embodiments within the scope of the present invention.

Furthermore, terms (including technical and scientific terms) used in the embodiments of the present invention, unless expressly specifically defined and described, are to be interpreted in the sense in which they would be understood by a person of ordinary skill in the art to which the present invention belongs, and commonly used terms, such as dictionary-defined terms, are to be interpreted in light of their contextual meaning in the relevant art.

Furthermore, the terms used in the embodiments of the invention are intended to describe the embodiments and are not intended to limit the invention.

In this specification, the singular may include the plural unless the context otherwise requires, and references to “at least one (or more) of A and (or) B and C” may include one or more of any combination of A, B, and C that may be assembled.

In addition, the terms first, second, A, B, (a), (b), and the like may be used to describe components of embodiments of the invention. Such terms are intended only to distinguish one component from another, and are not intended to limit the nature or sequence or order of such components by such terms.

Furthermore, when a component is described as “connected,” “coupled,” or “attached” to another component, it can include cases where the component is “connected,” “coupled,” or “attached” to the other component directly, as well as cases where the component is “connected,” “coupled,” or “attached” to another component that is between the component and the other component.

Still furthermore, when described as being formed or disposed “above” or “below” each component, “above” or “below” includes not only when two components are in direct contact with each other, but also when one or more other components are formed or disposed between the two components. Furthermore, when expressed as “above” or “below”, it may include the meaning of upward as well as downward with respect to a single component.

In the description of the invention, ‘object side surface’ may refer to the surface of the lens facing the object side with respect to the optical axis (OA), and ‘sensor side surface’ may refer to the surface of the lens facing the imaging surface (image sensor) with respect to the optical axis. ‘Object side surface’ may be referred to as “object surface,” and “sensor side surface” may be referred to as “image side surface.” A convex surface of a lens may refer to a convex shape on the optical axis or paraxial region, and a concave surface of a lens may refer to a concave shape on the optical axis or paraxial region. The curvature radius, center thickness, and optical axis gap (spacing) between lenses listed in the lens data table may refer to values measured along the optical axis (unit: mm). The vertical direction may refer to the direction perpendicular to the optical axis, and the end of the lens or lens surface may refer to the end of the effective area (region) of the lens through which incident light passes. The size of the effective diameter of the lens surface may have a measurement error of up to ±0.4 mm depending on the measurement method. The term ‘paraxial region (near-axis) region’ refers to a very narrow area near the optical axis, where the distance from the optical axis (OA) to the light rays is almost zero. Hereinafter, the term ‘optical axis’ may refer to the center of each lens or a very narrow area near the optical axis.

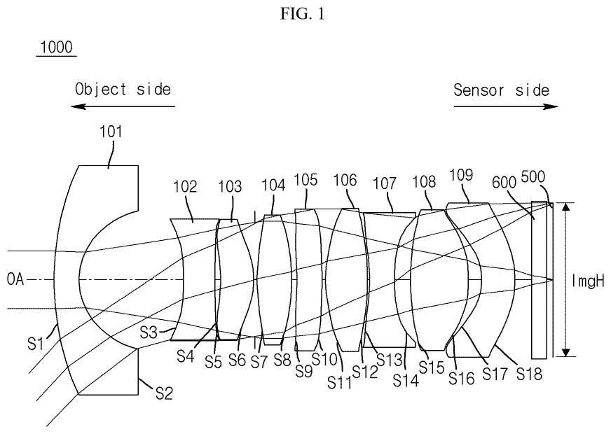

As shown in FIGS. 1, 13, 25, and 37, the optical system (1000, 1100, 1200, 1300) according to the first to fourth embodiments of the present invention may include five or more lenses. The optical systems (1000, 1100, 1200, 1300) and the camera modules including the same may be mounted inside or outside a vehicle to monitor the driver or sense external objects or lanes. The material of the lenses may be selected from glass or plastic, and the thermal expansion coefficient of glass is smaller than that of plastic. To suppress changes in the focal point imaging position due to temperature changes, glass lenses are employed. However, glass lenses are more expensive than plastic lenses and pose challenges in meeting cost-reduction requirements. Therefore, the lenses within the optical system (1000, 1100, 1200, 1300) require a hybrid configuration combining glass and plastic lenses. By adopting plastic lenses, the optical system (1000, 1100, 1200, 1300) can achieve lightweight and low-cost designs by reducing the thickness of plastic lenses, and plastic lenses can provide good correction for various aberrations such as spherical aberration and chromatic aberration. Additionally, plastic lenses can provide aspherical lenses, thereby minimizing distortion in the peripheral areas.

The optical system (1000, 1100, 1200, 1300) may include n lenses, where the nth lens is the last lens adjacent to the image sensor (500), and the n−1th lens may be the lens most adjacent to the last lens. n is an integer of 8 or more, for example, 8 to 10.

The ratio of glass lenses to plastic lenses among the n lenses may be in the range of 2:7 to 1:8. At least one lens closest to an object within the optical system (1000, 1100, 1200, 1300) may be made of glass.

At least one of the two or fewer lenses closest to the object, for example, one lens, may be made of glass material. Since glass lenses have a lower rate of contraction and expansion due to temperature changes compared to plastic lenses, glass lenses may be disposed in areas adjacent to the exterior within the lens barrel.

At least one lens adjacent to the aperture (STOP) within the optical system (1000, 1100, 1200, 1300) may be made of glass material. The lens closest to the aperture (STOP) on the sensor side may be made of glass material. Lenses disposed adjacent to the aperture (STOP) are lenses with significant influence within the optical system (1000, 1100, 1200, 1300), so lenses made of glass material may be disposed to minimize changes in contraction and expansion due to temperature variations.

Within the optical system (1000, 1100, 1200, 1300), at least one lens closest to the image sensor (500) may be made of plastic material. For example, at least two lenses closest to the image sensor (500) may be made of plastic material, and preferably at least two lenses adjacent to the image sensor (500) may be made of plastic material. That is, since the nth and (n−1)th lenses in the optical system (1000, 1100, 1200, 1300) are disposed as plastic lenses, various aberrations can be corrected for the incident light on the image sensor (500).

Within the optical system (1000, 1100, 1200, 1300), lenses made of plastic material may be disposed consecutively, and lenses made of glass material may be disposed consecutively. Within the optical system (1000, 1100, 1200, 1300), lenses made of plastic material may be disposed between lenses made of glass material. Within the optical system (1000, 1100, 1200, 1300), glass lenses may be disposed between plastic lenses.

Each lens (101-109, 201-209, 301-309, 401-409) may have an object side surface and a sensor side surface. The number of lenses with aspherical (non-spherical) sensor side surfaces and aspherical object side surfaces in the optical system may be greater than the number of plastic lenses. The number of lenses with a spherical sensor side surface and a spherical object side surface in an optical system may be smaller than the number of lenses with both sides being aspherical. The optical system (1000, 1100, 1200, 1300) has more aspherical lenses than spherical lenses, enabling correction of various aberrations.

Among the lenses in the optical system (1000, 1100, 1200, 1300), the lens with the highest refractive index may be disposed at the center of the optical system (1000, 1100, 1200, 1300). The maximum refractive index may be 1.7 or higher. The lens with the highest refractive index can increase the color dispersion of incident light and allow the central thickness to be thinner than the edge thickness. Additionally, since the lens with the highest refractive index is disposed on the object side, it facilitates changes in the curvature radius of subsequent lenses and allows for an increase in central thickness.

As shown in FIGS. 1, 13, 25, and 37, the optical systems (1000, 1100, 1200, 1300) according to the first to fourth embodiments of the invention may include a plurality of lens groups (LG1, LG2). In detail, each of the plural lens groups (LG1, LG2) includes at least one lens. For example, the optical system (1000, 1100, 1200, 1300) may include a first lens group (LG1) and a second lens group (LG2) disposed sequentially along the optical axis (OA) toward the image sensor (500) from the object side. The optical system (1000, 1100, 1200, 1300) may include n lenses, where the nth lens is the last lens, and the (n−1)th lens may be the lens most adjacent to the last lens. n is an integer of 8 or more, such as 8 to 10.

The optical system (1000, 1100, 1200, 1300) may include a first lens group (LG1) comprising multiple lenses disposed on the object side relative to an aperture (STOP) and a second lens group (LG2) comprising multiple lenses disposed on the sensor side relative to the aperture (STOP). The number of lenses in the first lens group (LG1) and the second lens group (LG2) may be different. The number of lenses in the second lens group (LG2) may be greater than the number of lenses in the first lens group (LG1).

The first lens group (LG1) may include at least one lens. The first lens group (LG1) may have three or fewer lenses. The first lens group (LG1) may preferably have two lenses. The second lens group (LG2) may include four or more lenses. The second lens group (LG2) may have five lenses.

The composite focal length of the first lens group (LG1) may be defined as F_LG1, and the composite focal length of the second lens group (LG2) may be defined as F_LG2. The signs of F_LG1 and F_LG2 may be different. F_LG1 may have a negative (−) value, and F_LG2 may have a positive (+) value. This allows light to be scattered by one lens group and then focused by the other lens group. The absolute value of the composite focal length (F_LG1) of the first lens group (LG1) may be within the range of 2 to 4 times the absolute value of the composite focal length (F_LG2) of the second lens group (LG2).

The aperture (STOP) may be disposed between the third lens (103, 203, 303, 403) and the fourth lens (104, 204, 304, 404), the first lens group (LG1) may include the first to third lenses (101-103, 201-203, 301-303, 401-403), the second lens group (LG2) may include the fourth to ninth lenses (104-109, 204-209, 304-309, 404-409). The composite focal length of the first lens group (LG1) has a negative (−) sign, and at least one of the focal lengths of the first lens (101, 201, 301, 401) and the second lens (102, 202, 302, 402) may have the same sign as the focal length of the first lens group (LG1). The Abbe number of the lens in the first lens group (LG1) that has the same sign as the sign of the composite focal length of the first lens group (LG1) may be 70 or higher. The Abbe number of the first lens (101, 201, 301, 401) may be 70 or higher, and preferably within the range of 75 to 90. This allows for the removal of aberrations in the light passing through each lens. However, lenses with relatively small refractive power may have an Abbe number of 70 or lower as an exception.

The composite focal length of the second lens group (LG2) may have a positive (+) sign, and at least one of the focal lengths of the fourth lens (104, 204, 304, 404), the sixth lens (106, 206, 306, 406), and the eighth lens (108, 208, 808, 408) may have the same sign as the focal length of the second lens group (LG2). The Abbe number of the lens in the second lens group (LG2) that has the same sign as the sign of the composite focal length of the second lens group (LG2) may be 40 or greater. At least one of the fourth lenses (104, 204, 304, 404), sixth lenses (106, 206, 306, 406), and eighth lenses (108, 208, 808, 408) may have an Abbe number of 40 or higher. This allows for the removal of aberrations in the light passing through each lens. However, lenses with relatively small refractive power may have an Abbe number of 40 or less as an exception.

Within the optical system (1000, 1100, 1200, 1300), the lens with the maximum effective diameter may be disposed at the center of the object side and the sensor side. As the distance increases from the object side to the sensor side, the effective diameter of the lens may increase and then decrease. Alternatively, as the distance increases from the object side to the sensor side, the effective diameter of the lens may decrease, then increase, and then decrease again. As a result, the light entering the optical system (1000, 1100, 1200, 1300) diverges from the optical axis and then converges back toward the optical axis, enabling the optical system (1000, 1100, 1200, 1300) to form a stable optical path.

The effective diameter is the diameter of the effective area where effective light enters each lens. The effective diameter is the length in the direction perpendicular to the optical axis (X, Y) and is an average of the effective diameter on the object side surface and the effective diameter on the sensor side surface of each lens. ‘Lens surface diameter’ may refer to ‘effective diameter of the lens.’ The ‘diameter of the lens’ may refer to the overall diameter of the lens, including the flange portion of the lens beyond the effective area. Although the flange of the lens is not shown in FIGS. 1, 13, 25, and 37, the flange may be a portion protruding perpendicular to the optical axis from the side of the lens for mounting the lens to the barrel. The flange may not allow effective light to enter. Spacers may be additionally disposed between the flanges of different lenses to allow the lenses to be mounted on the barrel.

Each of the lenses (101-109, 201-209, 301-309, 401-409) may include an effective area and an ineffective area. The effective area may be the region through which light incident on each lens passes. In other words, the effective area may be defined as the effective region or effective path where incident light is refracted to achieve optical characteristics. The non-effective region may be disposed around the effective region. The non-effective region may be an area where light that is effective in multiple lenses does not enter. In other words, the non-effective region may be an area unrelated to optical characteristics. Additionally, the ends (edges) of the non-effective region may be areas fixed to lens barrels or other structures that accommodate the lenses.

Within the optical system (1000, 1100, 1200, 1300), the TTL (Total top length) must exceed Imgh by 5 times. For example, it can be 6 times or more and 8 times or less. TTL (Total track length) is the distance along the optical axis (OA) from the center of the object side surface of the first lens to the image surface of the image sensor (500). Imgh is half of the maximum diagonal length of the image sensor (500). Within the optical system (1000, 1100, 1200, 1300), the effective focal length (EFL) is 5 mm or more, and the field of view (FOV_H) is 145 degrees or more and less than 160 degrees, enabling the optical system to be provided as an optical system for vehicle interior monitoring in a vehicle camera module. For example, the optical system and camera module according to the embodiment can be applied to a camera for an Advanced Driving Assistance System (ADAS) installed inside or outside a vehicle.

The optical system (1000, 1100, 1200, 1300) may have a TTL/Imgh ratio of 5 or higher and 7 or lower, for example, 5.5 or higher and 6.5 or lower. By setting the TTL/Imgh value of the optical system (1000, 1100, 1200, 1300) to 5 or higher and 7 or lower, a lens optical system for vehicles can be provided. As a result, the optical system (1000, 1100, 1200, 1300) can provide images with no exaggeration or distortion of the projected image.

Within the optical system (1000, 1100, 1200, 1300), the effective diameter of at least one plastic lens may be smaller than the length of the image sensor (500). The effective diameter is the diameter or length of the effective area through which light enters. The length of the image sensor (500) is the maximum length of the diagonal in a direction perpendicular to the optical axis (OA). Within the optical system (1000, 1100, 1200, 1300), the number of lenses with an effective diameter greater than the length of the image sensor (500) may be 10% or more and 20% or less, and the number of lenses with an effective diameter smaller than the length of the image sensor (500) may be 60% or more and 80% or less.

A lens unit may include a mixture of glass lenses and plastic lenses. The number of plastic lenses may account for 70% or more of the total number of lenses, and may be within the range of 75% to 85%. As a result, when more plastic lenses are disposed within the camera module, the weight of the camera module can be reduced. Additionally, plastic material facilitates polishing and processing, offers high resistance to external impacts, and provides cost competitiveness and ease of material procurement. Furthermore, plastic lenses can correct various aberrations, thereby preventing degradation of optical performance.

The effective diameter of the lens closest to the object side within the lens unit may be larger than the effective diameter of the lens closest to the image sensor (500). This allows control of the brightness of the optical system. The effective diameter may be the average effective diameter of the object side surface and sensor side surface of each lens. By controlling the effective diameter of each lens, the optical system (1000, 1100, 1200, 1300) can control incident light to compensate for resolution degradation and optical characteristic degradation due to temperature changes, improve chromatic aberration control characteristics, and improve the vignetting characteristics of the optical system (1000, 1100, 1200, 1300).

The lens unit may consist of the first lens (101, 201, 301, 401), the second lens (102, 202, 302, 402), the third lens (103, 203, 303, 403), the fourth lens (104, 204, 304, 404), the fifth lens (105, 205, 305, 405), the sixth lens (106, 206, 306, 406), the seventh lens (107, 207, 307, 407), an eighth lens (108, 208, 308, 408) and a ninth lens (109, 209, 309, 409).

The lens unit may be disposed in a camera module having an inner barrel on one side or the entire inner surface of the lens barrel. The lens unit may be disposed in a camera module having a plurality of inner barrels around different lenses of the lens barrel. The lens unit may be disposed in a camera module that includes a first inner barrel in contact with the outer surface of at least one lens of the lens barrel and a second inner barrel in contact with the outer surface of at least one lens of the lens barrel. The lens unit may be disposed in a camera module that includes multiple inner barrels each disposed between the outer side of at least one or two lenses and the lens barrel. The lens unit may be disposed in a camera module having multiple inner barrels made of a material different from that of the lens barrel.

Among the lenses constituting the lens unit, at least some of the lenses made of glass may be disposed in the lens barrel, and at least some of the lenses made of plastic may be disposed in the inner barrels disposed within the lens barrel. Through this, the optical system (1000, 1100, 1200, 1300) can maintain its resolution despite temperature changes. The lens unit, when disposed in a camera module with different barrels, can minimize the decenter of lenses that expand due to temperature changes, such as plastic lenses. The lens barrel in which the lens unit is disposed includes multiple inner barrels within the lens barrel, thereby maintaining the resolution of the optical system in response to temperature changes and suppressing deformation of the lenses. Therefore, the effective diameter of at least some of the glass lenses included in the lens unit may be smaller than the effective diameter of at least some of the plastic lenses.

Lenses within the lens unit that are larger than the average effective diameter of the plastic lenses may be one or more, for example, two or more. The average effective diameter of plastic lenses is PLca_Aver, and the average effective diameter of glass lenses is GLca_Aver. In this case, the condition PLca_Aver<GLca_Aver may be satisfied. Additionally, the condition 1<GLca_Aver/PLca_Aver<1.5 may be satisfied. Furthermore, the relationship between the length of the image sensor (500) and the average effective focal length of the plastic lens (PLca_Aver) may satisfy the condition 1.5<PLca_Aver/Imgh<2. Additionally, the relationship between the average effective focal length of the glass material and the length of the image sensor (500) may satisfy the condition 1.8<GLca_Aver/Imgh<2.2. The difference between the maximum length of the image sensor (500) and the effective focal length of the plastic lens can be kept small. As a result, by arranging plastic lenses with a small effective focal length adjacent to the image sensor (500), the plastic lenses can disperse color from the center to the periphery of the image sensor (500).

The average effective diameter of glass materials is 8 mm or more, for example, within the range of 9 mm to 11 mm. The average effective diameter of plastic materials is 7 mm or more, for example, within the range of 8 mm to 10 mm. Lenses with the minimum effective diameter may be made of plastic, and lenses with the maximum effective diameter may be made of glass. Within the lens unit, the minimum effective diameter may be within the range of 7 mm to 9 mm, and the maximum effective diameter may be within the range of 11 mm to 13 mm. Plastic lenses may be designed with a smaller effective diameter than glass lenses to prevent contact with the lens barrel, thereby minimizing optical performance changes caused by temperature variations. Additionally, the optical system (1000, 1100, 1200, 1300) can control incident light to improve resolution and chromatic aberration control characteristics, and improve the vignetting characteristics of the optical system (1000, 1100, 1200, 1300).

The optical system (1000, 1100, 1200, 1300) or camera module may include an image sensor (500). The image sensor (500) may be capable of detecting light and converting it into electrical signals. The image sensor (500) may be capable of detecting light that has sequentially passed through the lens unit. The image sensor (500) may include a device capable of detecting incident light, such as a CCD (Charge Coupled Device) or CMOS (Complementary Metal Oxide Semiconductor).

The optical system (1000, 1100, 1200, 1300) or camera module may include a filter (600). The filter (600) may be disposed between the last lens and the image sensor (500). The filter (600) may be disposed between the lens closest to the sensor side among the lenses in the lens unit and the image sensor (500). For example, the filter (600) may be disposed between the nth lens and the image sensor (500).

The cover glass may be disposed between the filter (600) and the image sensor (500), protecting the upper part of the image sensor (500) and preventing a decrease in the reliability of the image sensor (500). The cover glass may be removable. The cover glass may be a protective glass.

The filter (600) may include an infrared filter or an infrared cut-off filter (IR cut-off). The filter (600) can transmit light within a set wavelength band and filter out light from other wavelength bands. When the filter (600) includes an infrared filter, it can block radiant heat emitted from external light from being transmitted to the image sensor (500). Additionally, the filter (600) can transmit visible light and reflect infrared light. The optical system (1000, 1100, 1200, 1300) according to the embodiment may include an aperture (Stop). The aperture can control the amount of light entering the optical system (1000, 1100, 1200, 1300). In the lenses disposed between the object and the aperture, there is a tendency for the effective diameter of the lens surfaces to increase as they move from the object side toward the aperture. For the lens surfaces disposed between the aperture and the sensor, there is a tendency for the effective aperture of the lens surfaces to decrease as the distance from the aperture toward the sensor increases. The fact that there is a tendency for the effective aperture of the lens surfaces to increase or decrease does not mean that the effective aperture of the lens surfaces only increases or decreases. For example, it also includes cases where the effective diameter of the lens surfaces increases and then decreases as the distance from the aperture toward the sensor increases.

In the optical systems (1000, 1100, 1200, 1300) of the first to fourth embodiments, the sum of the refractive indices of the lenses in the lens unit may be 12 or more, for example, in the range of 13 to 15, and the average refractive index may be in the range of 1.5 to 1.6. The sum of the Abbe numbers of each lens may be 420 or more, for example, within the range of 430 to 440, and the average Abbe number may be 55 or less, for example, within the range of 45 to 50. The total central thickness of all lenses may be 15 mm or more, for example, within the range of 17 mm to 20 mm, and the average central thickness may be within the range of 1.5 mm to 2.5 mm. The total center distance between the lenses along the optical axis (OA) may be 8 mm or more, for example, within the range of 9 mm to 10 mm, and may be smaller than the total center thickness of the lenses. Additionally, the average value of the effective diameter of each lens surface (S1-S16) in the lens unit may be provided within the range of 8 mm or more, for example, within the range of 8.5 mm to 9.5 mm.

In the optical system according to the first to fourth embodiments of the invention, the F-number is 1.7 or less, for example, within the range of 1.5 to 1.65. The vehicle optical system may have a horizontal field of view (FOV_H) in the Y-axis direction exceeding 80 degrees and less than 90 degrees, for example, within the range of 80 degrees to 85 degrees. Additionally, the vertical field of view may be provided at an angle smaller than the horizontal field of view. The vertical field of view (FOV_V) may be greater than 50 degrees and less than 60 degrees, for example, within the range of 50 degrees to 55 degrees. The sensor length in the horizontal direction (Y) may be 8.64 mm±0.5 mm, and the sensor height in the vertical direction (X) may be 5.58 mm±0.5 mm. The horizontal field of view (FOV_H) is the field of view based on the horizontal (Horizontal) length of the image sensor, and the vertical field of view (FOV_V) is the field of view based on the vertical (Vertical) length of the image sensor. As a result, changes in the focus imaging position due to temperature variations can be suppressed, and the camera can be provided as a vehicle-mounted camera with various aberrations effectively corrected.

The optical system applied to vehicle cameras may be typically designed based on the horizontal field of view (FOV) rather than the entire field of view, as it is intended to monitor road conditions. The optical system according to the present embodiment is designed with a certain margin around the inscribed circle of the image sensor. Optical performance can be ensured within the range that satisfies the horizontal FOV (FOV_H).

Since the embodiment is an optical system applied to a vehicle camera, even though it is designed using both plastic lenses and glass lenses, the first lens (101, 201, 301, 401) may be provided in glass material. This is because glass material has the advantages of being scratch-resistant and insensitive to external temperatures compared to plastic material. The first lens (101, 201, 301, 401) may be a glass mold lens made of glass material with an aspherical shape. A glass mold lens may be manufactured by placing an optical glass ingot inside a mold with an aspherical shape and undergoing heating and compression processes.

To more effectively prevent scratches caused by foreign objects disposed inside the vehicle, a glass lens may be used as the first lens (101, 201, 301, 401), and the object side surface of the first lens (101, 201, 301, 401) may have a gentle curved surface shape so that it does not come into contact with external structures. This may minimize the occurrence of scratches caused by contact with external structures. The field of view may be set to exceed 80 degrees and be less than 90 degrees, such as within the range of 80 to 85 degrees, for driver monitoring, front/rear vehicle filming, or lane detection and detection of sudden objects around the vehicle during vehicle operation.

Such horizontal field of view angles may be pre-set angles for advanced driver assistance systems (ADAS). The optical system (1000, 1100, 1200, 1300) according to the embodiment may further include a reflective member for changing the path of light.

The reflective members may be implemented as prisms that reflect incident light from the optical system (1000, 1100, 1200, 1300) toward the lenses.

The optical system according to the embodiment will now be described in detail.

The optical system according to the first embodiment of the invention will now be described.

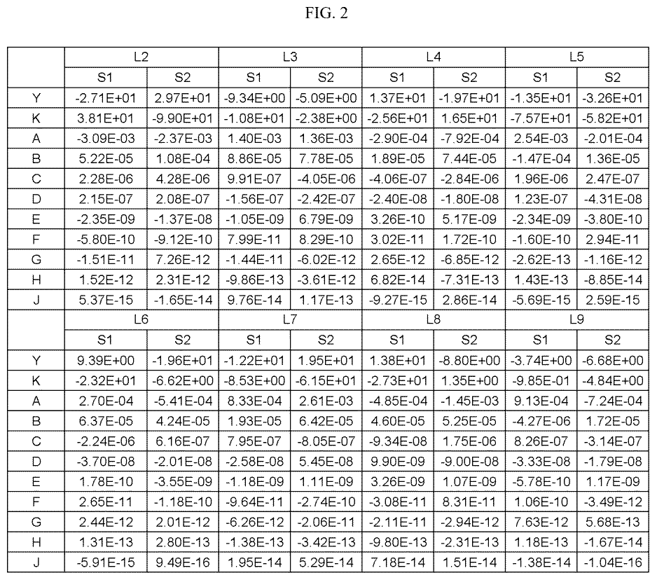

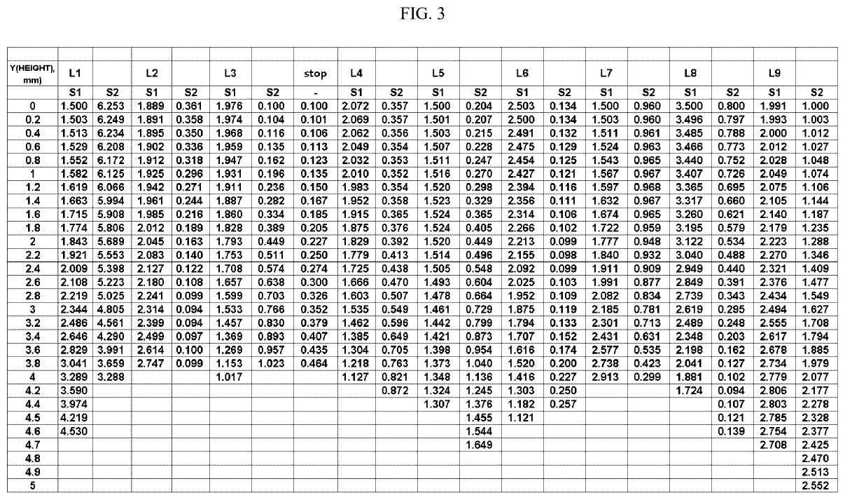

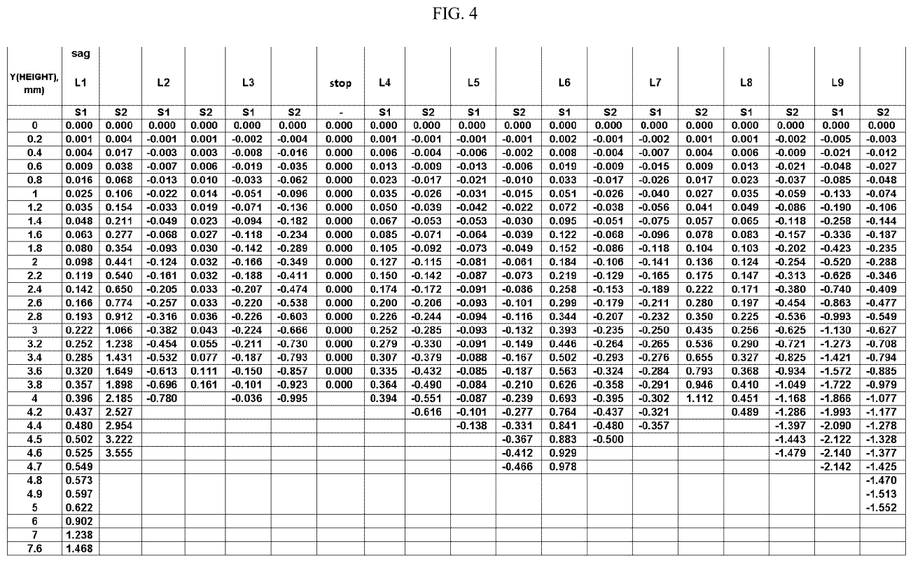

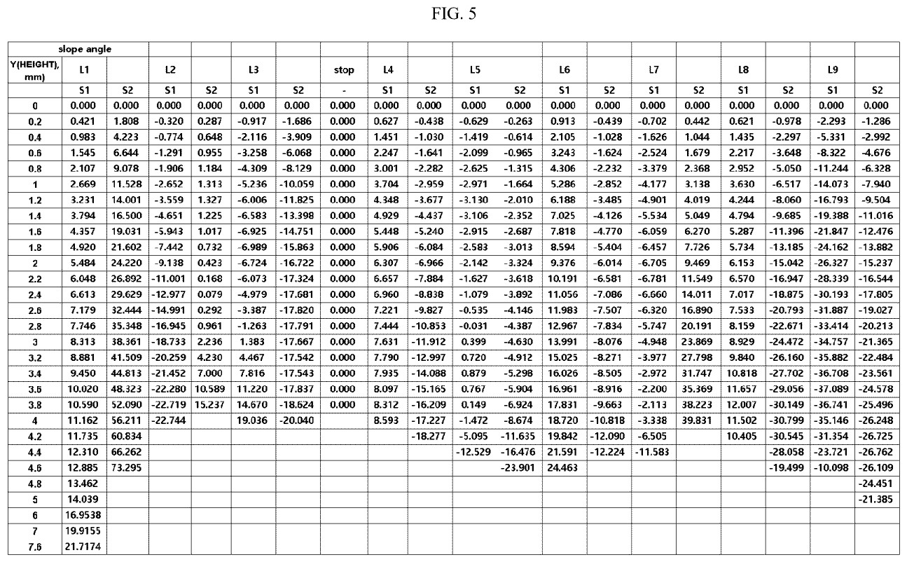

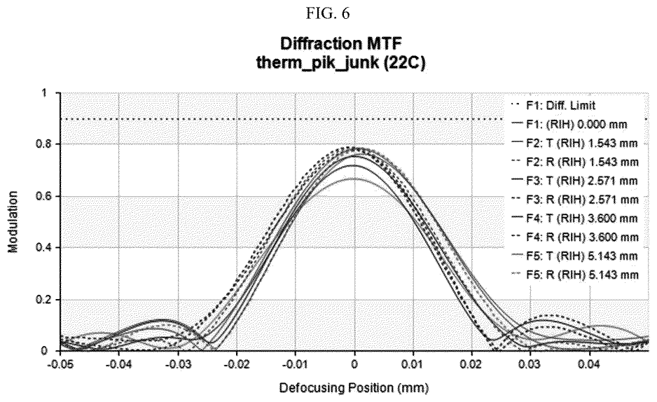

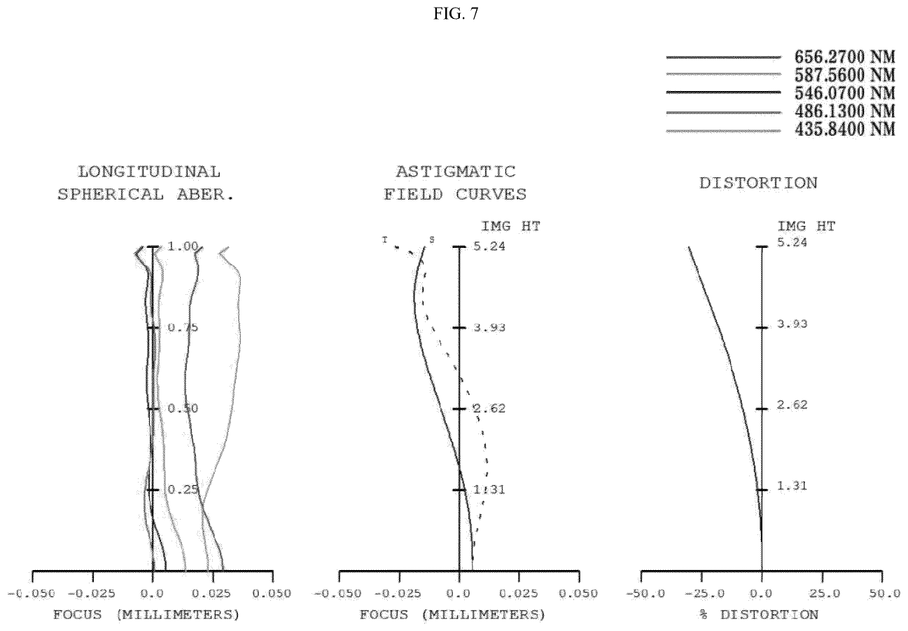

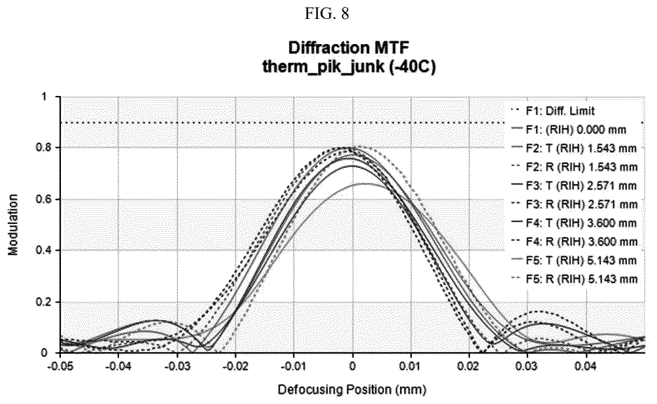

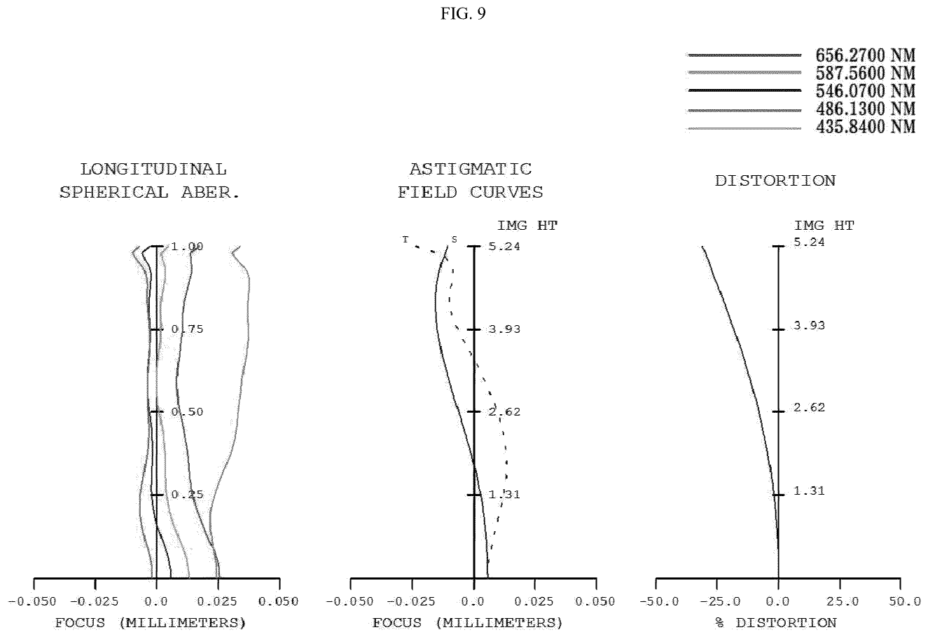

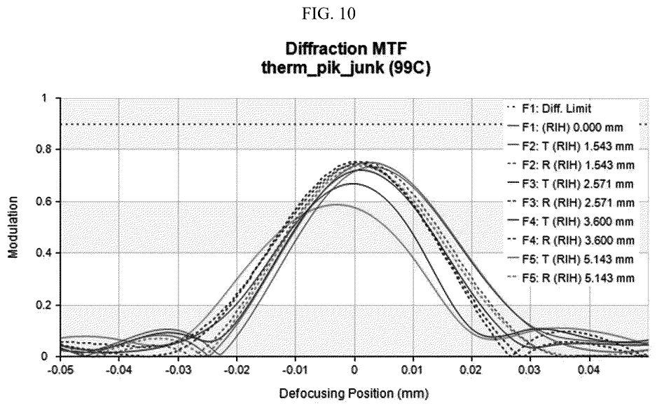

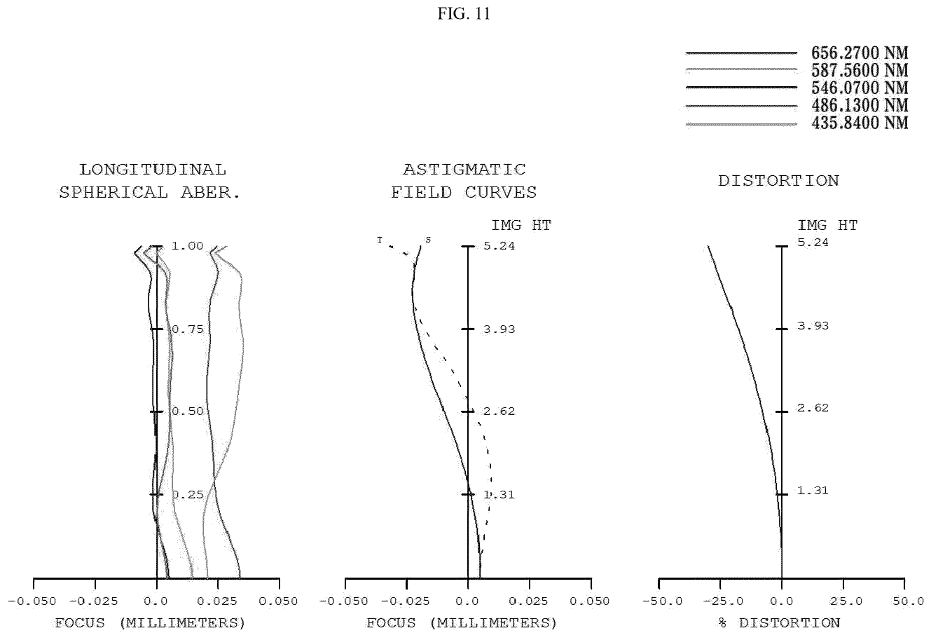

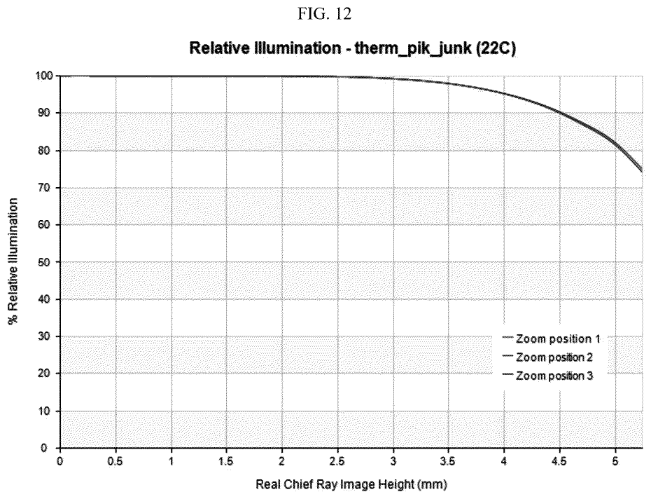

FIG. 1 is a side cross-sectional view of an optical system and a camera module having the same according to a first embodiment, FIG. 2 is a table showing the aspheric coefficients of the lenses in the optical system of FIG. 1, FIG. 3 is a table showing the thickness of each lens in the optical system of FIG. 1 and the gap (spacing) between adjacent lenses, FIG. 4 is a table showing the Sag values of the lens surfaces of the first to ninth lenses in the optical system of FIG. 1, FIG. 5 is a table showing the slope angle values of the lens surfaces of the first to ninth lenses in the optical system of FIG. 1, FIG. 6 is a graph showing the diffraction MTF (Modulation Transfer Function) data at room temperature for the optical system of FIG. 1, FIG. 7 is a graph showing the aberration characteristics data at room temperature for the optical system of FIG. 1, FIG. 8 is a graph showing the diffraction MTF data at low temperatures for the optical system shown in FIG. 1, FIG. 9 is a graph showing the aberration characteristics data at low temperatures for the optical system shown in FIG. 1, FIG. 10 is a graph showing the diffraction MTF data at high temperatures for the optical system shown in FIG. 1, FIG. 11 is a graph showing data on the aberration characteristics of the optical system in FIG. 1 at high temperatures, and FIG. 12 is a graph showing the peripheral light intensity ratio of the optical system in FIG. 1.

Referring to FIG. 1, the optical system (1000) may include a lens unit, which may include a first lens (101) to a ninth lens (109). The first to ninth lenses (101 to 109) may be sequentially disposed along the optical axis (OA) of the optical system (1000). Light corresponding to information of an object may pass through the first lens (101) to the ninth lens (109) and the filter (600) and enter the image sensor (500).

The first lens (101) may be disposed closest to the object side. The first lens (101) may be disposed farthest from the sensor side. The first lens (101) may have a negative (−) refractive power along the optical axis (OA). The first lens (101) may include a plastic material or a glass material, for example, it may be made of glass. The first lens (101) made of glass material can reduce changes in the central position and curvature radius due to temperature changes caused by the surrounding environment, and can protect the incident side of the optical system (1000).

Based on the optical axis, an object side first surface (S1) of the first lens (101) may be convex, and a sensor side second surface (S2) may be concave. The first lens (101) may have a convex meniscus shape on the object side. The first lens (101) may be made of glass material and may have a spherical surface. At least one or both of the first surface (S1) and the second surface (S2) may be provided without any critical points from the optical axis (OA) to the end of the effective area.

Due to the refractive characteristics of the first lens (101), the second lens (102) may be further spaced apart from the first lens (101). That is, the center-to-center distance between the first and second lenses (101, 102) may be the largest within the lens unit. The first lens (101) may have the greatest influence in the optical system (1000).

The Abbe number (v1) of the first lens (101) may satisfy the condition v1>70 or v1>75. Since the refractive index (v1) of the first lens (101) is the largest within the lens unit, the first lens (101) may exhibit minimal dispersion and low chromatic aberration.

The second lens (102) may be disposed second from the object side. The second lens (102) may be disposed eighth from the sensor side. The second lens (102) may be disposed between the first lens (101) and the third lens (103). The second lens (102) may have a negative (−) refractive power along the optical axis (OA). The second lens (102) may include a plastic or glass material. For example, the second lens (102) may be provided in a plastic material.

Based on the optical axis (OA), an object-side third surface (S3) of the second lens (102) may be concave, and a sensor-side fourth surface (S4) may be concave. The second lens (102) may have a concave shape on both sides. The second lens (102) may be made of plastic material and may be aspherical. At least one or both of the third surface (S3) and the fourth surface (S4) may be non-spherical. The aspherical coefficients of the third and fourth surfaces (S3, S4) may be provided as S1 and S2 of L2 in FIG. 2. At least one or both of the third surface (S3) and the fourth surface (S4) may be provided without a critical point from the optical axis (OA) to the end of the effective area.

The third lens (103) may be disposed as the third lens from the object side. The third lens (103) may be disposed as the seventh lens from the sensor side. The third lens (103) may be disposed between the second lens (102) and the fourth lens (104). The third lens (103) may have a positive (+) refractive power on the optical axis (OA). The third lens (103) may include a plastic or glass material. For example, the third lens (103) may be provided in a plastic material.

Based on the optical axis, the object-side fifth surface (S5) of the third lens (103) may be concave, and the sensor-side sixth surface (S6) may be convex. The third lens (103) may have a convex meniscus shape on the sensor side. The third lens (103) may have a concave meniscus shape on the object side. The third lens (103) may be made of plastic material and may be aspherical. At least one or both of the fifth surface (S5) and the sixth surface (S6) may be aspherical. The asphericity coefficients of the fifth and sixth surfaces (S5, S6) may be provided as S5 and S6 of L3 in FIG. 2.

The fifth surface (S5) of the third lens (103) may include a critical point extending to the end of the effective area along the optical axis (OA). If the fifth surface (S5) has a critical point, it may be located within the range of 65% to 75%, preferably 70% to 72.5%, of the effective radius (r31) from the optical axis (OA). The critical point of the fifth surface (S5) may be located within a range of 2.6 mm to 3 mm, preferably 2.8 mm to 2.9 mm, from the optical axis (OA). The sixth surface (S6) of the third lens (103) may be provided without a critical point from the optical axis (OA) to the end of the effective area.

The aperture (stop) may be disposed around the sensor side sixth surface (S6) of the third lens (103). The aperture (stop) may be disposed around the object side seventh surface (S7) of the fourth lens (104). The aperture can reduce TTL within the field of view range and enable miniaturization of the optical system. As a result, it is possible to prevent a decrease in the weight-based yield (yield by weight) of the optical system and improve production efficiency. Additionally, the optical system can be miniaturized by reducing TTL within a horizontal field of view (FOV_H) of 80 to 90 degrees.

The fourth lens (104) may be disposed as the fourth lens from the object side. The fourth lens (104) may be disposed as the sixth lens from the sensor side. The fourth lens (104) may be disposed between the third lens (103) and the fifth lens (105). The fourth lens (104) may have a positive (+) or negative (−) refractive power relative to the optical axis (OA). The fourth lens (104) may have a positive (+) refractive power. The fourth lens (104) may include a plastic or glass material. For example, the fourth lens (104) may be provided in a glass material.

Based on the optical axis, the object-side seventh surface (S7) of the fourth lens (104) may be convex, and the sensor-side eighth surface (S8) may be convex. The fourth lens (104) may have a shape where both surfaces are convex. The fourth lens (104) may be made of glass material and may be spherical. The fourth lens (104) may be made of glass material and may be aspherical. At least one or both of the seventh surface (S7) and the eighth surface (S8) may be aspherical. The asphericity coefficient of the seventh and eighth surfaces (S7, S8) may be provided by S1 and S2 of L4 in FIG. 2. At least one or both of the seventh surface (S7) and the eighth surface (S8) may be provided without a critical point from the optical axis (OA) to the end of the effective area.

The fifth lens (105) may be disposed fifth from the object side. The fifth lens (105) may be disposed fifth from the sensor side. The fifth lens (105) may be disposed between the fourth lens (104) and the sixth lens (106). The fifth lens (105) may have a positive (+) or negative (−) refractive power on the optical axis (OA). The fifth lens (105) may have a negative (−) refractive power. The fifth lens (105) may include a plastic or glass material. For example, the fifth lens (105) may be provided in a plastic material.

With respect to the optical axis (OA), the fifth lens (105) may have a concave object side ninth surface (S9) and a convex sensor side tenth surface (S10). The fifth lens (105) may have a convex meniscus shape on the sensor side. The fifth lens (105) may have a concave meniscus shape on the object side. The fifth lens (105) may be made of plastic material and may be aspherical. At least one or both of the ninth surface (S9) and the tenth surface (S10) may be aspherical. The asphericity coefficient of the ninth and tenth surfaces (S9, S10) may be provided as S1 and S2 of L5 in FIG. 2.

The ninth surface (S9) of the fifth lens (105) may include a critical point extending from the optical axis (OA) to the end of the effective area. If the ninth surface (S9) has a critical point, it may be located within the range of 60% to 70%, preferably 63% to 65%, of the effective radius (r51) from the optical axis (OA). The critical point of the ninth surface (S9) may be located within a range of 2.5 mm to 3 mm from the optical axis (OA), preferably within a range of 2.8 mm to 2.9 mm. The tenth surface (S10) of the fifth lens (105) may be provided without a critical point from the optical axis (OA) to the end of the effective area.

The sixth lens (106) may be disposed sixth from the object side. The sixth lens (106) may be disposed fourth from the sensor side. The sixth lens (106) may be disposed between the fifth lens (105) and the seventh lens (107). The sixth lens (106) may have a positive (+) or negative (−) refractive power relative to the optical axis (OA). The sixth lens (106) may have a positive (+) refractive power. The sixth lens (106) may include a plastic or glass material. For example, the sixth lens (106) may be provided in a plastic material. With respect to the optical axis (OA), the sixth lens (106) may have a convex object side eleventh surface (S11) and a convex sensor side twelfth surface (S12). The sixth lens (106) may have a shape with both surfaces being convex. The sixth lens (106) may be made of plastic material and may be aspherical. At least one or both of the eleventh surface (S11) and the twelfth surface (S12) may be aspherical. The asphericity coefficient of the eleventh and twelfth surfaces (S11, S12) may be provided as S1 and S2 of L6 in FIG. 2. At least one or both of the 11th surface (S11) and the 12th surface (S12) may be provided without a critical point from the optical axis (OA) to the end of the effective area.

The seventh lens (107) may be disposed as the seventh lens from the object side. The seventh lens (107) may be disposed as the third lens from the sensor side. The seventh lens (107) may be disposed between the sixth lens (106) and the eighth lens (108). The 7th lens (107) may have a positive (+) or negative (−) refractive power relative to the optical axis (OA). The 7th lens (107) may have a negative (−) refractive power. The 7th lens (107) may include a plastic or glass material. For example, the 7th lens (107) may be provided in a plastic material.

With respect to the optical axis (OA), the seventh lens (107) may have a concave object side thirteenth surface (S13) and a concave sensor side fourteenth surface (S14). The seventh lens (107) may have a concave shape on both sides. The seventh lens (107) may be made of plastic material and may be aspherical. At least one or both of the 13th surface (S13) and the 14th surface (S14) may be aspherical. The asphericity coefficient of the 13th and 14th surfaces (S13, S14) may be provided as S1 and S2 of L7 in FIG. 2. At least one or both of the 13th surface (S13) and the 14th surface (S14) may be provided without a critical point from the optical axis (OA) to the end of the effective area.

The eighth lens (108) may be disposed eighth from the object side. The eighth lens (108) may be disposed second from the sensor side. The eighth lens (108) may be disposed between the sixth lens (106) and the ninth lens (109). The 8th lens (108) may have a positive (+) or negative (−) refractive power relative to the optical axis (OA). The 8th lens (108) may have a positive (+) refractive power. The 8th lens (108) may include a plastic or glass material. For example, the 8th lens (108) may be provided in a plastic material.

With respect to the optical axis (OA), the eighth lens (108) may have a convex object side fifteenth surface (S15) and a convex sensor side sixteenth surface (S16). The eighth lens (108) may have a shape with both surfaces being convex. The eighth lens (108) may be made of plastic material and may be aspherical. At least one or both of the fifteenth surface (S15) and the sixteenth surface (S16) may be aspherical. The asphericity coefficient of the fifteenth and sixteenth surfaces (S15, S16) may be provided as S1 and S2 of L8 in FIG. 2. At least one or both of the 15th surface (S15) and the 16th surface (S16) may be provided without a critical point from the optical axis (OA) to the end of the effective area.

The 9th lens (109) may be disposed furthest from the object side. The 9th lens (109) may be disposed closest to the image sensor (500). The ninth lens (109) may have a positive (+) or negative (−) refractive power relative to the optical axis (OA). The ninth lens (109) may have a negative (−) refractive power. The ninth lens (109) may include a plastic or glass material. For example, the ninth lens (109) may be provided in a plastic material.

With respect to the optical axis (OA), the ninth lens (109) may have a concave object side seventeenth surface (S17) and a convex sensor side eighteenth surface (S18). The ninth lens (109) may have a convex meniscus shape on the sensor side. The ninth lens (109) may have a concave meniscus shape on the object side. At least one or both of the 17th surface (S17) and the 18th surface (S18) may be aspherical. The asphericity coefficients of the 17th and 18th surfaces (S17, S18) may be provided as S17 and S18 of L9 in FIG. 2. At least one or both of the 17th surface (S17) and the 18th surface (S18) may be provided without a critical point from the optical axis (OA) to the end of the effective area.

The ninth lens (109) may be a plastic lens closest to the image sensor (500). Furthermore, by arranging two or more plastic lenses adjacent to the image sensor (500), it is possible to improve aberrations such as spherical aberration and chromatic aberration caused by the lens surface having an aspherical shape, and to control the resolution. Furthermore, by arranging a plastic lens as the lens adjacent to the image sensor (500), it is possible to be less sensitive to assembly tolerances compared to glass lenses. In other words, being less sensitive to assembly tolerances means that, even if the assembly differs slightly from the design during assembly, it may not significantly affect optical performance. Furthermore, by providing the two lenses (108, 109) adjacent to the image sensor (500) in a plastic material, the optical performance can be improved by the aspherical lens surfaces, for example, by improving aberration characteristics and preventing resolution degradation.

TABLE 1

| | | | | | | Semi | Focal |
|---|---|---|---|---|---|---|---|
| Lens | Surface | Radius | Thickness | nd | vd | Aperture | length |
| 1 | S1 | 20.404 | 1.500 | 1.4985 | 81.6072 | 7.671 | −12.8430 |
| | S2 | 4.754 | 6.253 | | | 4.603 | |
| 2 | S3 | −27.091 | 1.889 | 1.5706 | 37.5647 | 4.048 | −24.5213 |
| | S4 | 29.670 | 0.361 | | | 3.999 | |
| 3 | S5 | −9.342 | 1.976 | 1.5371 | 55.7074 | 4.022 | 17.8965 |
| | S6 | −5.088 | 0.100 | | | 4.033 | |
| | STOP | — | 0.100 | | | 3.790 | |
| 4 | S7 | 13.678 | 2.072 | 1.7727 | 49.2893 | 4.100 | 10.7329 |
| | S8 | −19.677 | 0.357 | | | 4.336 | |
| 5 | S9 | −13.540 | 1.500 | 1.5371 | 55.7074 | 4.464 | −44.2962 |
| | S10 | −32.640 | 0.204 | | | 4.728 | |
| 6 | S11 | 9.388 | 2.503 | 1.5371 | 55.7074 | 4.733 | 12.1852 |
| | S12 | −19.597 | 0.134 | | | 4.559 | |
| 7 | S13 | −12.226 | 1.500 | 1.6679 | 20.3792 | 4.461 | −11.0419 |
| | S14 | 19.500 | 0.960 | | | 4.162 | |
| 8 | S15 | 13.805 | 3.500 | 1.5371 | 55.7074 | 4.292 | 10.5772 |
| | S16 | −8.798 | 0.800 | | | 4.684 | |
| 9 | S17 | −3.745 | 1.991 | 1.6679 | 20.3792 | 4.748 | −17.5370 |
| | S18 | −6.676 | 1.000 | | | 5.112 | |
| Cover | | infinity | 0.900 | | | | |
| | | | 0.400 | | | | |
| Image | | infinity | 0.000 | | | | |

Table 1 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the first embodiment of the present invention. Here, the units for curvature radius and thickness or distance may be mm.

TABLE 2

| items | values | items | values |
|---|---|---|---|
| F | 6.2300 | F-number | 1.6400 |
| ET1 | 3.5650 | FOV_H | 83.0 |
| ET2 | 2.9077 | EPD | 3.7988 |
| ET3 | 1.0139 | BFL | 2.3000 |
| ET4 | 1.0007 | TD | 27.7000 |
| ET5 | 1.1862 | ImgH | 5.1450 |
| ET6 | 1.0130 | SD | 15.6207 |
| ET7 | 3.0707 | TTL | 30.0000 |
| ET8 | 1.5149 | GLca_Aver | 10.355 |
| ET9 | 2.5621 | PLca_Aver | 8.864 |
| ΣIndex | 14.3260 | CT_max | 3.5000 |
| ΣAbbe | 432.0492 | CT_min | 1.5000 |
| ΣCT | 18.4307 | CT_Aver | 2.0479 |
| ΣCG | 9.2693 | F_LG1 | −34.997 |
| CA_max | 15.342 | F_LG2 | 10.617 |
| CA_min | 7.579 | | |
| CA_Aver | 9.110 | | |

Table 2 shows the values for the items in the mathematical equations described above in the optical system (1000) of the embodiment. The optical system (1000) relates to the total track length (TTL) (mm), back focal length (BFL), effective focal length (F) (mm), image height (ImgH) (mm), effective aperture (CA) (mm), thickness (mm), TTL (mm), the optical axis distance TD (mm) from the first surface (S1) to the 18th surface (S18), the sum of refractive indices, the sum of Abbe numbers, the sum of thicknesses (mm), the sum of the gaps (intervals) between adjacent lenses, the effective aperture characteristics, the sum of refractive indices of glass lenses, the sum of refractive indices of plastic materials, the field of view (FOV_H) (degrees), edge thickness (ET), F-number, etc.

The center thickness of the first to ninth lenses (101 to 109) is indicated as CT1 to CT9, the edge thickness at the end of the effective area of each lens is indicated as ET1 to ET9, the center gap between adjacent lenses is indicated as CG1 to CG8, and the edge-to-edge distance between the edges of each lens is denoted as EG1 to EG8. BFL (Back focal length) is the optical axis distance from the image sensor (500) to the center of the last lens. TTL is the optical axis distance from the center of the first surface (S1) of the first lens (101) to the image surface of the image sensor (500).

As shown in FIG. 2, the lens surfaces of the second, third, fourth, fifth, sixth, seventh, eighth, and ninth lenses (102, 103, 104, 105, 106, 107, 108, 109) among the lenses of the lens unit in the first embodiment may include aspherical surfaces having a 30th-order asphericity coefficient. For example, the second, third, fourth, fifth, sixth, seventh, eighth, and ninth lenses (102, 103, 104, 105, 106, 107, 108, 109) may include lens surfaces having a 30th-order aspheric coefficient. As described above, aspherical surfaces with a 30th-order asphericity coefficient (a non-zero numerical value) can significantly alter the aspheric shape in the peripheral region, thereby effectively correcting the optical performance in the peripheral region of the field of view (FOV).

The thickness (T1-T9) of the first to ninth lenses (101-109) and the gap (G1-G8) between adjacent lenses may be set. As shown in FIG. 3, the thickness (T1-T9) of each lens in the Y-axis direction can be represented at intervals of 0.1 mm or 0.2 mm or more, and the gap (G1-G8) between each lens can be represented at intervals of 0.1 mm or 0.2 mm or more.

When comparing the absolute values of the curvature radii of each lens, the curvature radius of the 10th surface (S10) of the 5th lens (105) on the optical axis (OA) may be the largest among the lenses, and the curvature radius of the 17th surface (S17) of the 9th lens (109) may be the smallest among the lenses. The difference between the maximum and minimum curvature radii may be 9 times or more, for example, within the range of 9 to 11 times.

Since the effective diameter of a plastic lens is smaller than that of a glass lens, the lens disposed on the object side of a plastic lens may have a stronger refractive power to refract light through the plastic lens. Additionally, to increase the refractive power, the curvature radius of the lens surface may be smaller.

The lens surface facing the aperture (STOP) may be formed gently. The absolute value of the curvature radius of the lens surface facing the aperture (STOP) may be 10 or more. The curvature radius of the object side surface 7th surface (S7)) of the fourth lens (104) adjacent to the aperture (STOP) may satisfy the range of 10 or more and 20 or less. The lens adjacent to the aperture (STOP) affects the optical performance of the entire optical system, so the tilt caused by assembly tolerances must be minimized.

The absolute value of the curvature radius of the first surface (S1) of the first lens (101) may be greater than the absolute value of the curvature radius of the second surface (S2). The absolute value of the curvature radius of the third surface (S3) of the second lens (102) may be less than the absolute value of the curvature radius of the fourth surface (S4). The absolute value of the curvature radius of the fifth surface (S5) of the third lens (103) may be greater than the absolute value of the curvature radius of the sixth surface (S6). The absolute value of the curvature radius of the seventh surface (S7) of the fourth lens (104) may be smaller than the absolute value of the curvature radius of the eighth surface (S8). The absolute value of the curvature radius of the ninth surface (S9) of the fifth lens (105) may be smaller than the absolute value of the curvature radius of the tenth surface (S10). The absolute value of the curvature radius of the eleventh surface (S11) of the sixth lens (106) may be smaller than the absolute value of the curvature radius of the twelfth surface (S12). The absolute value of the curvature radius of the 13th surface (S13) of the 7th lens (107) may be smaller than the absolute value of the curvature radius of the 14th surface (S14). The absolute value of the curvature radius of the 15th surface (S15) of the 8th lens (108) may be greater than the absolute value of the curvature radius of the 16th surface (S16). The absolute value of the curvature radius of the 17th surface (S17) of the 9th lens (109) may be smaller than the absolute value of the curvature radius of the 18th surface (S18).

The ratio of the curvature radii of each lens may satisfy the following conditions.

4<L1R1/L1R2|<5 Condition 1:

0.5<|L2R1/L2R2|<1 Condition 2:

1.5<|L3R1/L3R2|<2 Condition 3:

0.5<L4R1/L4R2<1 Condition 4:

0.1<|L5R1/L5R2|<0.5 Condition 5:

0.5<|L6R1/L6R2|<1 Condition 6:

1.3<|L7R1/L7R2|<1.7 Condition 7:

0.3<L8R1/L8R2<0.7 Condition 8:

0.5<L9R1/L9R2<1 Condition 9:

When describing the center thickness (CT) of the lenses based on the optical axis, the center thickness (CT8) of the eighth lens (108) is the maximum among the lenses, and the center thickness (CT1, CT5, CT7) of at least one of the first lens (101), the fifth lens (105) and the seventh lens (107) is the minimum among the lenses. The difference between the maximum and minimum center thicknesses of the lenses may be within the range of 2 mm or more and 2.5 mm or less.

The center thickness of each lens may satisfy any one of the following conditions.

CT2,CT3,CT4,CT6,CT8,CT9>CT1=CT5=CT7 Condition 1:

CT3,CT4,CT6,CT8,CT9>CT2>CT1,CT5,CT7 Condition 2:

CT4,CT6,CT8,CT9>CT3>CT1,CT2,CT5,CT7 Condition 3:

CT6,CT8>CT4>CT1,CT2,CT3,CT5,CT7,CT9 Condition 4:

CT8>CT6>CT1,CT2,CT3,CT4,CT5,CT7,CT9 Condition 5:

CT8>CT1,CT2,CT3,CT4,CT5,CT6,CT7,CT9 Condition 6:

CT4,CT6,CT8>CT9>CT1,CT2,CT3,CT5,CT7 Condition 7:

The center gap (CG) between the lenses is explained as follows: the center gap (CG1) between the first lens (101) and the second lens (102) is the maximum, while the center gap (CG6) between the sixth and seventh lenses (106, 107) may be the minimum. The difference between the maximum and minimum center gaps among the spaced-out lenses may be 5 mm or more, for example, within the range of 5 mm to 7 mm.

The center gap between each lens may satisfy the following conditions.

CG1>CG2,CG3,CG4,CG5,CG6,CG7,CG8 Condition 1:

CG1,CG7,CG8>CG2>CG3,CG4,CG5,CG6 Condition 2:

CG1,CG2,CG4,CG5,CG7,CG8>CG3>CG6 Condition 3:

CG1,CG2,CG7,CG8>CG4>CG3,CG5,CG6 Condition 4:

CG1,CG2,CG4,CG7,CG8>CG5>CG3,CG6 Condition 5:

CG1,CG2,CG3,CG4,CG5,CG7,CG8>CG6 Condition 6:

CG1>CG7>CG2,CG3,CG4,CG5,CG6,CG8 Condition 7:

CG1,CG7>CG8>CG2,CG3,CG4,CG5,CG6 Condition 8:

Regarding the effective diameter, a lens with the maximum effective diameter may be a lens made of glass material. The lens with the maximum effective diameter may be the first lens (101). Here, the effective diameter is an average of the effective diameter on the object side and the effective diameter on the sensor side of each lens. The lens surface with the maximum effective diameter may be the first surface (S1) of the first lens (101). The lens with the minimum effective diameter may be the second lens (102). The lens surface with the minimum effective diameter may be the fourth surface (S4) of the second lens (102). The effective diameter of a lens made of plastic material may be smaller than that of a lens made of glass material. A lens made of plastic material may be disposed adjacent to the image sensor.

The effective diameter of each lens may satisfy any one of the following conditions.

CA_L1,CA_L2,CA_L3,CA_L4,CA_L5,CA_L6,CA_L7,CA_L8>CA_L9 Condition 1:

CA_L1,CA_L3,CA_L4,CA_L5,CA_L6,CA_L7,CA_L8,CA_L9>CA_L2 Condition 2:

CA_L1,CA_L4,CA_L5,CA_L6,CA_L7,CA_L8,CA_L9>CA_L3>CA_L2 Condition 3:

CA_L1,CA_L5,CA_L6,CA_L7,CA_L8,CA_L9>CA_L4>CA_L2,CA_L3 Condition 4:

CA_L1,CA_L6,CA_L9>CA_L5>CA_L2,CA_L3,CA_L4,CA_L7,CA_L8 Condition 5:

CA_L1,CA_L9>CA_L6>CA_L2,CA_L3,CA_L4,CA_L5,CA_L7,CA_L8 Condition 6:

CA_L1,CA_L5,CA_L6,CA_L8,CA_L9>CA_L7>CA_L2,CA_L3,CA_L4 Condition 7:

CA_L1,CA_L5,CA_L6,CA_L9>CA_L8>CA_L2,CA_L3,CA_L4,CA_L7 Condition 8:

CA_L1>CA_L9>CA_L2,CA_L3,CA_L4,CA_L5,CA_L6,CA_L7,CA_L8 Condition 9:

Regarding the refractive index, the refractive index of the fourth lens (104) may be the highest among the lenses, exceeding 1.7, for example, 1.72. The refractive index of the lens disposed on the sensor side of the aperture (STOP) may be the highest among the lenses. The refractive index of the first lens (101) may be the lowest among the lenses, less than 1.55, for example, less than 1.5. The difference between the maximum and minimum refractive indices may be 0.2 or more. By providing a low refractive index lens made of glass material closest to the object and a high refractive index lens made of glass material adjacent to the aperture (STOP), the incident efficiency can be increased, and the refractive power between the glass material and plastic material lenses can be adjusted to guide the light to the image sensor (500).

The refractive index of each lens may satisfy any one of the following conditions.

n2,n3,n4,n5,n6,n7,n8,n9>n1 Condition 1:

n4,n7,n9>n2>n1,n3,n5,n6,n8 Condition 2:

n2,n4,n7,n9>n3=n5=n6=n8>n1 Condition 3:

n4>n1,n2,n3,n5,n6,n7,n8,n9 Condition 4:

n4>n7=n9>n1,n2,n3,n5,n6,n8 Condition 5:

When comparing the Abbe numbers, the Abbe number of the first lens (101) is the largest among the lenses and may be 70 or higher. The Abbe number of at least one of the seventh lens (107) and the ninth lens (109) may be the smallest among the lenses and may be 25 or lower. The difference between the maximum refractive index and the minimum Abbe number may be 50 or higher. By maximizing the Abbe number of the first lens (101) disposed closest to the object side of the optical system (1000), color dispersion and chromatic aberration can be minimized. By providing the smallest Abbe number for the ninth lens (109) closest to the image sensor (500), the color dispersion of light passing between glass and plastic lenses can be controlled, and the color dispersion between glass and plastic lenses can be increased to guide the light to the image sensor (500).

The Abbe number of each lens may satisfy any one of the following conditions.

v1>v2,v3,v4,v5,v6,v7,v8,v9 Condition 1:

v1,v3,v4,v5,v6,v8>v2>v7,v9 Condition 2:

v1>v3=v5=v6=v8>v2,v4,v7,v9 Condition 3:

v1,v3,v5,v6,v8>v4>v2,v7,v9 Condition 4:

v1,v2,v3,v4,v5,v6,v8>v7=v9 Condition 5:

The focal lengths (F1, F2, F5, F7, F9) of lenses 1, 2, 5, 7, and 9 (101, 102, 105, 107, 109) may have a negative (−) sign. Lenses 1, 2, 5, 7, and 9 (101, 102, 105, 107, 109) may have negative (−) refractive power. The focal lengths (F3, F4, F6, F8) of lenses 3, 4, 6, and 8 (103, 104, 106, 108) may have positive (+) signs. The third, fourth, sixth, and eighth lenses (103, 104, 106, 108) may have positive (+) refractive power. The third lens (103) with positive (+) refractive power may be disposed on the sensor side of the first lens (101) and second lens (102) with negative (−) refractive power. This allows light incident from the object side to move away from the optical axis direction and then converge back toward the optical axis direction, thereby forming a stable optical path.

Additionally, the adjacent lenses, i.e., the sixth lens (106) and seventh lens (107), and the eighth lens (108) and ninth lens (109), may satisfy the following conditions.

Refractive index of a lens with positive refractive power<Refractive index of a lens with negative refractive power Condition 1:

Dispersion value of a lens with positive refractive power>Dispersion value of a lens with negative refractive power Condition 2:

Here, among the plastic lenses, the sixth lens (106) has positive refractive power, and the seventh lens (107) has negative refractive power. According to conditions 1 and 2, the refractive index of the sixth lens (106) may be smaller than that of the seventh lens (107), the dispersion value of the sixth lens (106) may be greater than that of the seventh lens (107). Chromatic aberration occurring in plastic lenses can be corrected using plastic lenses. Additionally, when the sixth lens (106) and the seventh lens (107), which are consecutively disposed plastic lenses, satisfy a refractive index difference of 0.1 or more and 0.15 or less, and an Abbe number difference of 20 or more and 50 or less, the chromatic aberration occurring in the plastic lenses can be compensated by the plastic lenses.

Furthermore, among the plastic lenses, the eighth lens (108) has a positive refractive power, and the ninth lens (109) has a negative refractive power, such that according to conditions 1 and 2, the refractive index of the eighth lens (108) may be smaller than that of the ninth lens (109), and the dispersion value of the eighth lens (108) may be larger than that of the ninth lens (109). Chromatic aberration occurring in the plastic lenses can be corrected by the plastic lenses. Additionally, when the eighth lens (108) and the ninth lens (109), which are consecutively disposed plastic lenses, satisfy the conditions of a refractive index difference of 0.1 or more and 0.15 or less, and an Abbe number difference of 20 or more and 50 or less, the chromatic aberration occurring in the plastic lenses can be compensated for using the plastic lenses.

The shapes of the surfaces facing each other in two lenses with the effect of a composite lens may be similar. The difference in the absolute values of the curvature radii of the surfaces facing each other in two lenses with the effect of a composite lens may satisfy the range of 2 or more and 10 or less. The signs of the curvature radii of the surfaces facing each other in two lenses with the effect of a composite lens may be opposite. The product of the signs of the curvature radii of the opposing surfaces of two lenses with the effect of a composite lens may be negative (−).

An optical system exhibits chromatic aberration, which is corrected using a composite lens or two lenses arranged in series. As the temperature changes from low to high, the lenses repeatedly contract and expand. Lenses made of the same material have the same change in lens characteristics due to temperature changes, so correcting chromatic aberration between lenses of the same material is effective even when the temperature changes. Therefore, in the first embodiment of the present invention, the sixth lens (106) and the seventh lens (107), and the eighth lens (108) and the ninth lens (109) can be used to correct chromatic aberration occurring in plastic lenses.

From the optical axis to the effective diameter area, the maximum distance between the two lenses with the largest Abbe number difference among the two adjacent lenses may be smaller than the maximum distance between other adjacent lenses. Here, the distance refers to the distance between the two lenses from the optical axis to the effective diameter area. The two lenses with the largest Abbe number difference among the two adjacent lenses may be the sixth lens (106) and the seventh lens (107). The maximum value of the distance from the optical axis to the effective diameter area in a direction perpendicular to the optical axis, between the sensor side surface 12th surface (S12) of the sixth lens (106) and the object side surface 13th surface (S13) of the seventh lens (107), may be smaller than the maximum value of the distance between any two adjacent lenses. This allows the distance between two lenses made of difficult-to-bond plastic materials to be designed to be small, maximizing the Abbe number difference, thereby achieving the effect of reducing chromatic aberration to the same level as that of bonded lenses even in an unbonded state.

When comparing focal lengths as absolute values, the focal length of the fifth lens (105) is the longest among the lenses and can be 40 or more and 50 or less. The focal length of the eighth lens (108) is the smallest among the lenses, and the absolute value of the focal length of the eighth lens (108) may be 10 or more and 11 or less. The absolute value of the focal length of each lens may satisfy any one of the following conditions.

|f2|,|f3|,|f5|,|f9|>|f1|>|f4|,|f6|,|f7|,|f8| Condition 1:

|f5|>|f2|>|f1|,|f3|,|f4|,|f6|,|f7|,|f8|,|f9| Condition 2:

|f2|,|f5|>|f3|>|f1|,|f4|,|f6|,|f7|,|f8|,|f9| Condition 3:

|f1|,|f2|,|f3|,|f5|,|f6|,|f7|,|f9|>|f4|>|f8| Condition 4:

|f5|>|f1|,|f2|,|f3|,|f4|,|f6|,|f7|,|f8|,|f9| Condition 5:

|f1|,|f2|,|f3|,|f5|,|f9|>|f6|>|f4|,|f7|,|f8| Condition 6:

|f1|,|f2|,|f3|,|f5|,|f6|,|f9|>|f7|>|f4|,|f8| Condition 7:

|f1|,|f2|,|f3|,|f4|,|f5|,|f6|,|f7|,|f9|>|f8| Condition 8:

|f2|,|f3|,|f5|>|f9|>|f1|,|f4|,|f6|,|f7|,|f8| Condition 9:

The thickness (T1) of the first lens (101) may be within a range of 2.1 times to 2.5 times the difference between the maximum thickness and the minimum thickness, and the center thickness (CT1) may be the minimum, while the edge thickness (ET1) may be the maximum. The thickness (T2) of the second lens (102) may range from 1.5 times to 2 times the minimum thickness. The second lens (102) may have the minimum central thickness (CT2) and the maximum edge thickness (ET2). The thickness (T3) of the third lens (103) may be maximum at the center and minimum at the edge, with the maximum thickness being within the range of 1.5 to 2 times the minimum thickness. The thickness (T4) of the fourth lens (104) may be maximum at the center and minimum at the edge, with the maximum thickness being within the range of 2 to 2.5 times the minimum thickness. The thickness (T5) of the fifth lens (105) may be maximum at the center and minimum at the edge, with the maximum thickness being within the range of 1.1 to 1.5 times the minimum thickness. The thickness (T6) of the sixth lens (106) may be maximum at the center and minimum at the edge, with the maximum thickness ranging from 2 to 2.5 times the minimum thickness. The thickness (T7) of the seventh lens (107) may be minimum at the center and maximum at the edge, with the maximum thickness ranging from 2 to 2.5 times the minimum thickness. The thickness (T8) of the eighth lens (108) may be maximum at the center and minimum at the edge, with the maximum thickness ranging from 2 to 2.5 times the minimum thickness. The thickness (T9) of the ninth lens (109) may be minimum at the center and maximum at the edge, with the maximum thickness ranging from 1.1 to 1.5 times the minimum thickness.

The thickness of each lens may satisfy any one of the following conditions.

0.1<CT1/ET1<0.5,2<ET1/CT1<2.5 Condition 1:

0.5<CT2/ET2<1,1.5<ET2/CT2<2 Condition 2:

1.5<CT3/ET3<2,0.3<ET3/CT3<0.7 Condition 3:

2<CT4/ET4<2.5,0.1<ET4/CT4<0.5 Condition 4:

1<CT5/ET5<1.5,0.5<ET5/CT5<1 Condition 5:

2<CT6/ET6<2.5,0.1<ET6/CT6<0.5 Condition 6:

0.1<CT7/ET7<0.5,2<ET7/CT7<2.5 Condition 7:

2<CT8/ET8<2.5,0.1<ET8/CT8<0.5 Condition 8:

0.5<CT8/ET8<1,1<ET8/CT8<1.5 Condition 8:

0.5<CT9/ET9<1,1<ET9/CT9<1.5 Condition 9:

1<ΣCT/ΣET<1.2,0.5<ΣET/ΣCT<1 Condition 10:

Among the gaps (G1-G7) between the lenses, the first gap (G1) between the first and second lenses (101, 102) may have a maximum at the center and a minimum at the edge. The second gap (G2) between the second and third lenses (102, 103) may have a maximum at the center and a minimum at the edge. The third gap (G3) between the third and fourth lenses (103, 104) may have the maximum value at the edge and the minimum value at the center. The fourth gap (G4) between the fourth and fifth lenses (104, 105) may have the minimum value at the center and the maximum value at the edge. The fifth gap (G5) between the fifth and sixth lenses (105, 106) may have a minimum center and a maximum edge. The sixth gap (G6) between the sixth and seventh lenses (106, 107) may have a maximum center and a minimum edge. The seventh gap (G7) between the seventh and eighth lenses (107, 108) may have a maximum center and a minimum edge. The eighth gap (G8) between the eighth and ninth lenses (108, 109) may have a maximum center and a minimum edge.

FIGS. 6, 8, and 10 are graphs showing the diffraction MTF (modulation transfer function) at room temperature, low temperature, and high temperature in the optical system of FIG. 1, respectively. These graphs represent the modulation (luminance ratio) as a function of spatial frequency.

As shown in FIGS. 6, 8, and 10, in the first embodiment of the invention, the deviation of the MTF between room temperature and low or high temperatures is less than 10%, i.e., 7% or less. FIGS. 7, 9, and 11 are graphs showing the aberration characteristics at room temperature, low temperature, and high temperature in the optical system of FIG. 1.

The aberration graphs in FIGS. 7, 9, and 11 show the measured values of spherical aberration (Longitudinal Spherical Aberration), astigmatic field curves (Astigmatic Field Curves), and distortion (Distortion) from left to right. In FIGS. 7, 9, and 11, the X-axis represents the focal length (mm) and distortion percentage, while the Y-axis denotes the image height. Additionally, the graph for spherical aberration corresponds to light in the wavelength bands of approximately 435 nm, 486 nm, 546 nm, 587 nm, and 656 nm, while the graphs for astigmatic field curves and distortion correspond to light in the wavelength band of approximately 546 nm. In the aberration diagrams of FIGS. 7, 9, and 11, the closer the curves at room temperature, low temperature, and high temperature are to the Y-axis, the better the aberration correction function is interpreted to be. The optical system (1000) according to the first embodiment shows that the measured values are adjacent to the Y-axis in almost all regions. In other words, the optical system (1000) according to the first embodiment has improved resolution and can achieve good optical performance not only in the central part of the field of view (FOV) but also in the peripheral regions. Here, low temperature may refer to −20 °C or below, for example, −20 °C to −40 °C, room temperature may refer to 22 °C±5 °C or 18 °C to 27 °C, and high temperature may refer to 85 °C or above, for example, 85 °C to 105 °C. As a result, as shown in FIGS. 7, 9, and 11, it can be seen that the reduction in brightness modulation from low temperature to high temperature is less than 10%, for example, 5% or less, or remain virtually unchanged.

Table 3 compares the changes in optical characteristics such as EFL, BFL, F-number (F #), TTL, and field of view (FOV_D) in the optical system according to the first embodiment at room temperature, low temperature, and high temperature. It can be seen that the change rate of optical characteristics at low temperature is 5% or less, for example, 3% or less, compared to room temperature. It can be observed that the change rate of optical characteristics at low temperatures relative to room temperature is 5% or less, for example, 3% or less.

TABLE 3

| | | | | Low | High |
|---|---|---|---|---|---|
| | Room | Low | High | temperature/ | temperature/ |
| | temper- | temper- | temper- | room | Room |
| | ature | ature | ature | temperature | temperature |
| EFL(F) | 6.23 | 6.20 | 6.27 | 99.51% | 100.64% |
| BFL | 2.30 | 2.30 | 2.30 | 100.00% | 100.00% |
| F# | 1.64 | 1.63 | 1.65 | 99.39% | 100.60% |
| TTL | 30.00 | 29.93 | 30.09 | 99.76% | 100.3% |
| FOV_D | 99.13 | 99.72 | 98.40 | 100.59% | 99.26% |

Therefore, as shown in Table 3, the changes in optical characteristics due to temperature changes from low to high temperatures, such as the change rate of the effective focal length (EFL), TTL, BFL, F number, and field of view (FOV_D), are 10% or less, i.e., 5% or less, for example, within the range of 0 to 5%. This design allows for temperature compensation for plastic lenses, even when using one or more plastic lenses, thereby preventing a decrease in the reliability of optical characteristics.

The optical system disclosed in the first embodiment effectively controls aberration characteristics such as chromatic aberration and distortion aberration, and achieves good optical performance not only in the central part but also in the peripheral part of the field of view (FOV).

The optical system according to the second embodiment of the invention will now be described.

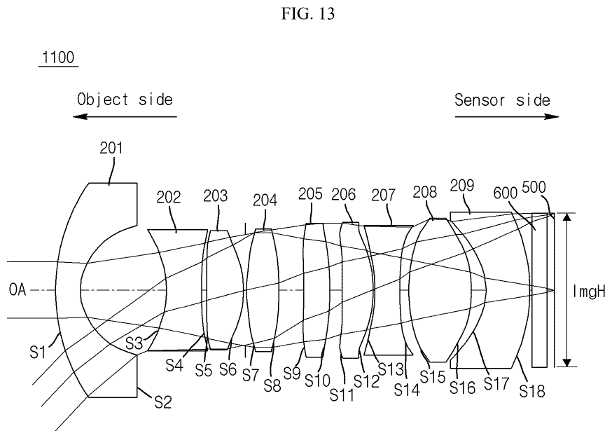

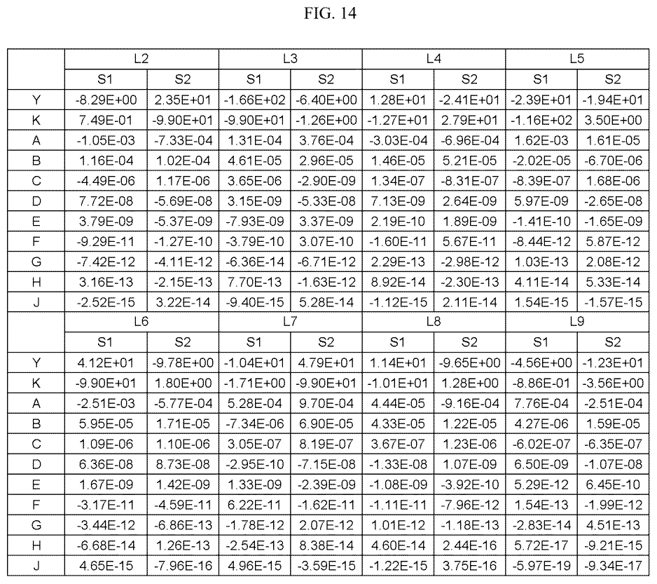

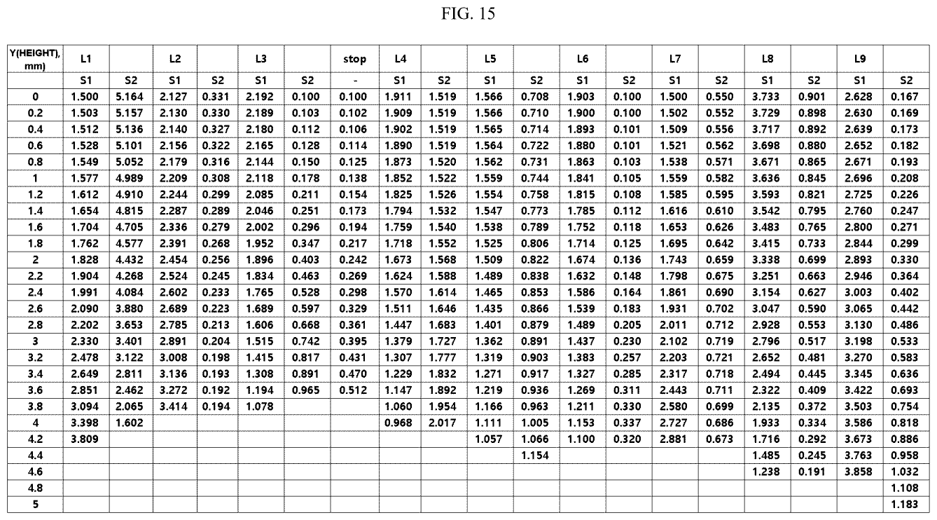

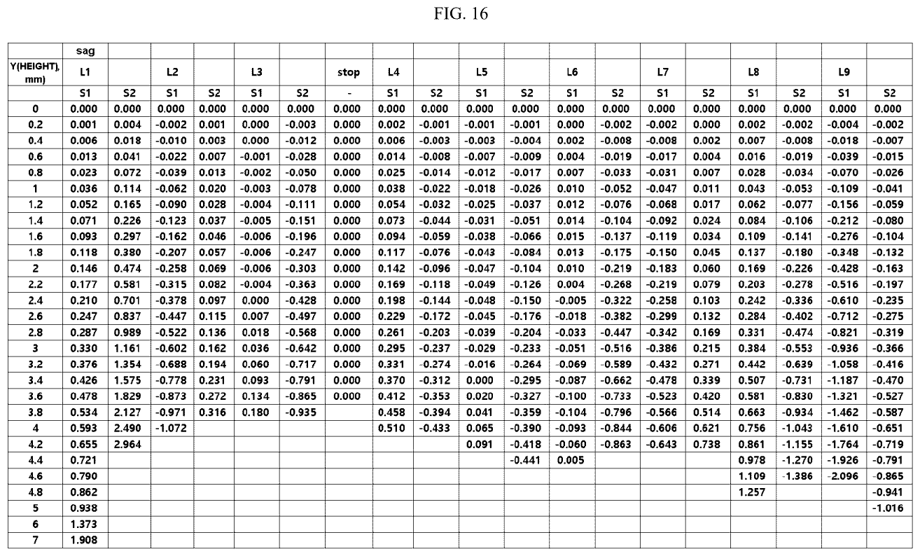

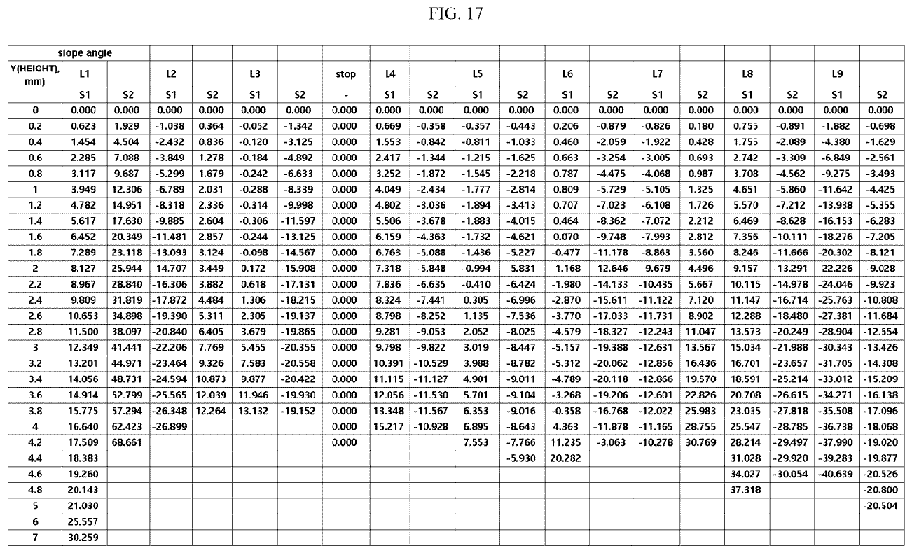

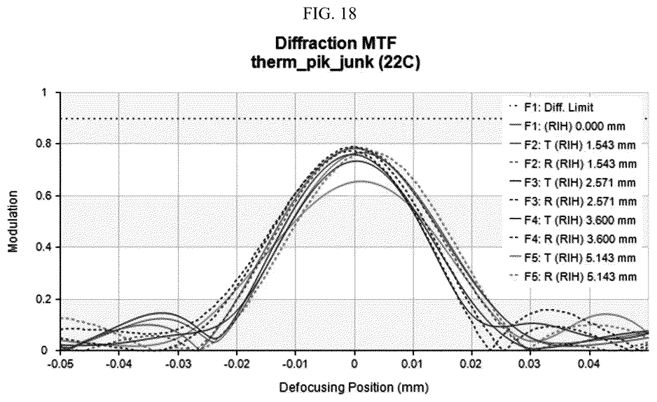

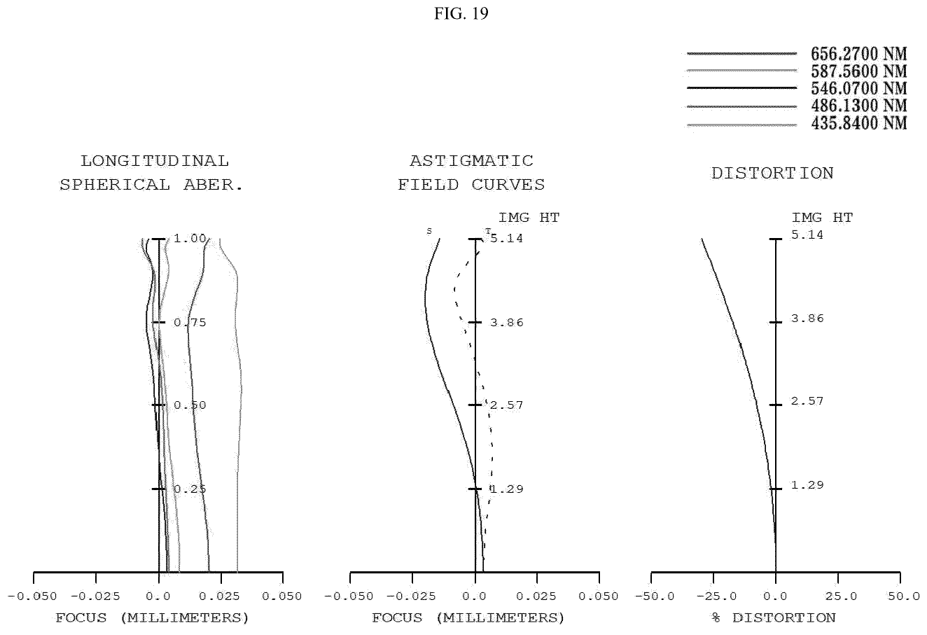

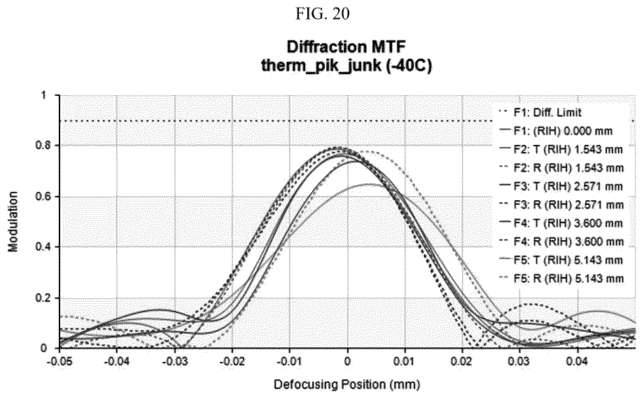

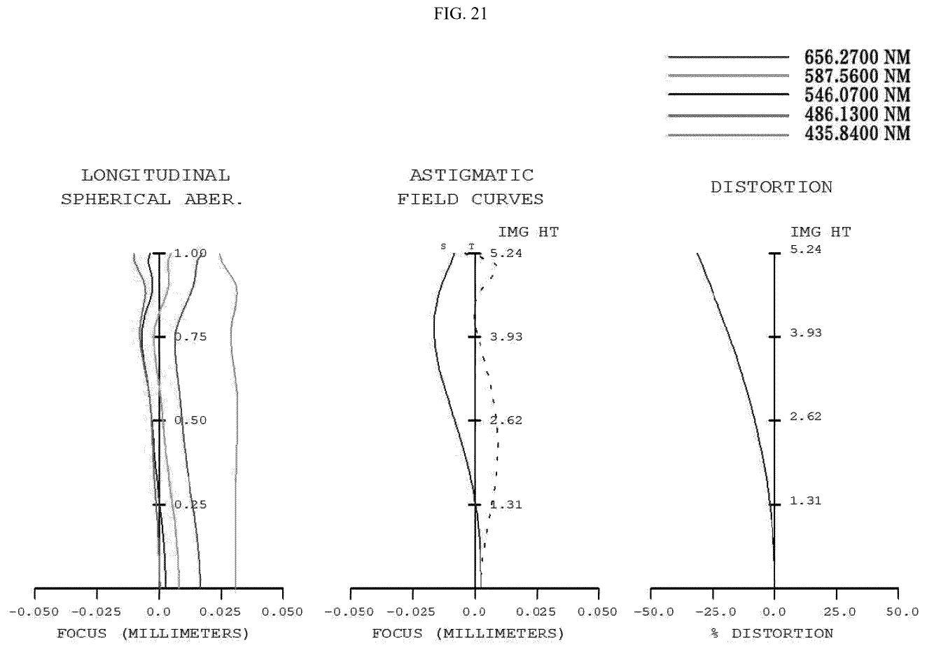

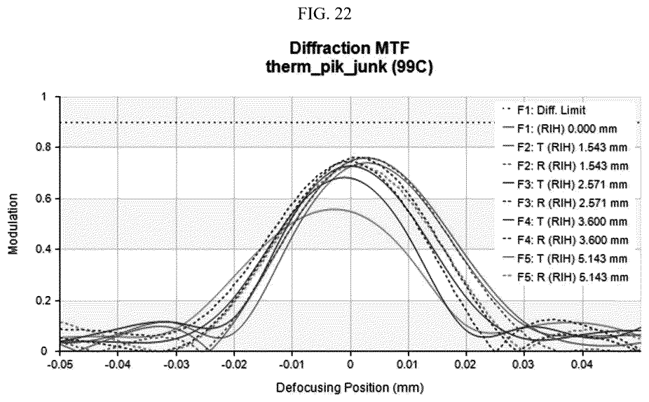

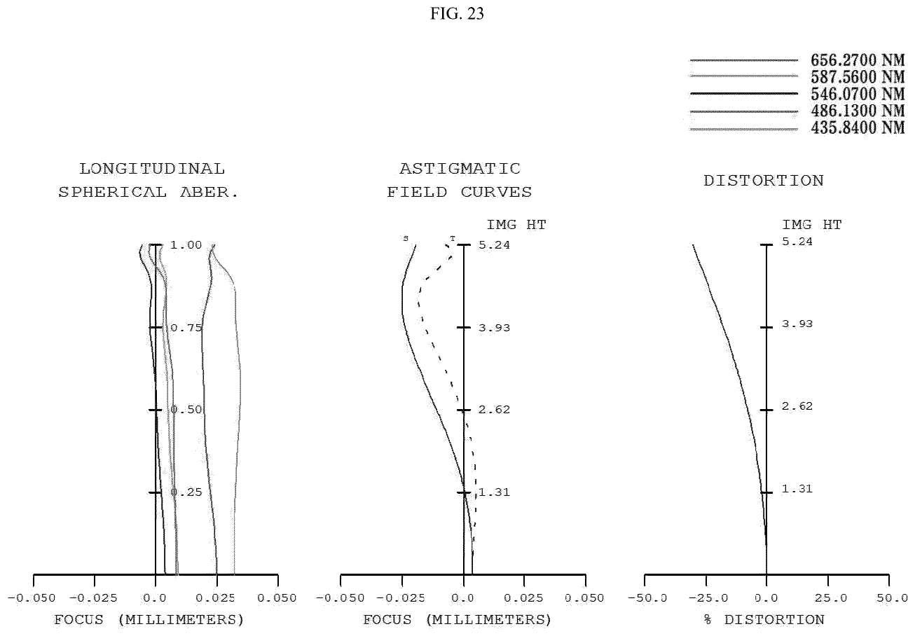

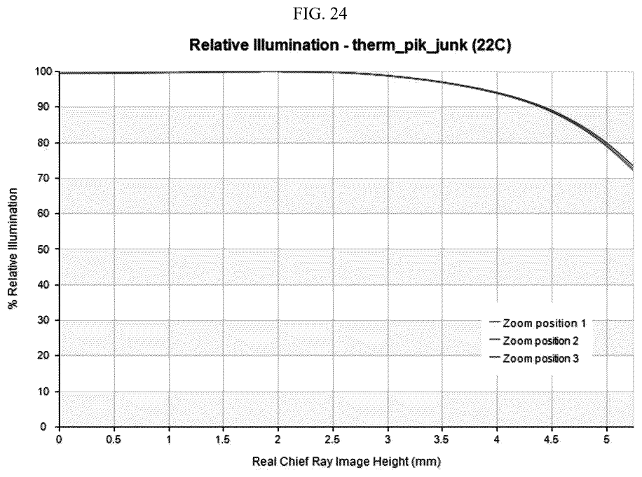

FIG. 13 is a side cross-sectional view of the optical system and a camera module having the same according to a second embodiment, FIG. 14 is a table showing the aspheric coefficients of the lenses in the optical system of FIG. 13, FIG. 15 is a table showing the thickness of each lens and the gap (spacing) between adjacent lenses in the optical system of FIG. 13, FIG. 16 is a table showing the sag values of the lens surfaces of the first to ninth lenses in the optical system of FIG. 13, FIG. 17 is a table showing the slope angles of the lens surfaces of the first to ninth lenses in the optical system of FIG. 13, FIG. 18 is a graph showing data on the diffraction MTF (Modulation Transfer Function) at room temperature for the optical system of FIG. 13, FIG. 19 is a graph showing the aberration characteristics data of the optical system shown in FIG. 13 at room temperature, FIG. 20 is a graph showing the diffraction MTF data of the optical system shown in FIG. 13 at low temperature, FIG. 21 is a graph showing data on the aberration characteristics of the optical system in FIG. 13 at low temperatures, FIG. 22 is a graph showing data on the diffraction MTF of the optical system in FIG. 13 at high temperatures, FIG. 23 is a graph showing data on the aberration characteristics of the optical system in FIG. 13 at high temperature, and FIG. 24 is a graph showing the peripheral light intensity ratio of the optical system shown in FIG. 13.

Referring to FIG. 13, the optical system (1100) includes a lens unit, which may include a first lens (201) to a ninth lens (209). The first to ninth lenses (201 to 209) may be sequentially arranged along the optical axis (OA) of the optical system (1100). Light corresponding to information of an object may pass through the first lens (201) to the ninth lens (209) and the filter (600) and be incident on the image sensor (500).

The first lens (201) may be disposed closest to the object side. The first lens (201) may be disposed farthest from the sensor side. The first lens (201) may have a negative refractive power along the optical axis (OA). The first lens (201) may include a plastic material or a glass material, for example, it may be made of glass. The first lens (201) made of glass material can reduce changes in the center position and curvature radius due to temperature changes caused by the surrounding environment, and can protect the incident side of the optical system (1100).

Based on the optical axis, the object side first surface (S1) of the first lens (201) may be convex, and the sensor side second surface (S2) may be concave. The first lens (201) may have a convex meniscus shape on the object side. The first lens (201) may be made of glass and may have a spherical surface. At least one or both of the first surface (S1) and the second surface (S2) may be provided without any critical points from the optical axis (OA) to the end of the effective area.

Due to the refractive characteristics of the first lens (201), the second lens (202) may be further spaced apart from the first lens (201). That is, the center gap between the first and second lenses (201, 202) may be the largest within the lens unit. The first lens (201) may have the greatest influence in the optical system (1100).

The Abbe number (v1) of the first lens (201) may satisfy the condition v1>70 or v1>75. Since the refractive index (v1) of the first lens (201) is the largest within the lens unit, the first lens (201) may exhibit minimal dispersion and reduced chromatic aberration.

The second lens (202) may be disposed second from the object side. The second lens (202) may be disposed eighth from the sensor side. The second lens (202) may be disposed between the first lens (201) and the third lens (203). The second lens (202) may have a negative (−) refractive power along the optical axis (OA). The second lens (202) may include a plastic or glass material. For example, the second lens (202) may be provided in a plastic material.

Based on the optical axis (OA), the object-side third surface (S3) of the second lens (202) may be concave, and the sensor-side fourth surface (S4) may be concave. The second lens (202) may have a concave shape on both sides. The second lens (202) may be made of plastic material and may be aspherical. At least one or both of the third surface (S3) and the fourth surface (S4) may be aspherical. The aspherical coefficients of the third and fourth surfaces (S3, S4) may be provided as S1 and S2 of L2 in FIG. 14. At least one or both of the third surface (S3) and the fourth surface (S4) may be provided without a critical point from the optical axis (OA) to the end of the effective area.

The third lens (203) may be disposed third from the object side. The third lens (203) may be disposed seventh from the sensor side. The third lens (203) may be placed between the second lens (202) and the fourth lens (204). The third lens (203) may have a positive (+) refractive power on the optical axis (OA). The third lens (203) may include a plastic or glass material. For example, the third lens (203) may be provided in a plastic material.

Based on the optical axis, the object-side fifth surface (S5) of the third lens (203) may be concave, and the sensor-side sixth surface (S6) may be convex. The third lens (203) may have a convex meniscus shape toward the sensor side. The third lens (203) may have a concave meniscus shape toward the object side. The third lens (203) may be made of plastic material and may be aspherical. At least one or both of the fifth surface (S5) and the sixth surface (S6) may be aspherical. The asphericity coefficient of the fifth and sixth surfaces (S5, S6) may be provided as S5 and S6 of L3 in FIG. 14.

The fifth surface (S5) of the third lens (203) may include a critical point extending from the optical axis (OA) to the end of the effective area. If the fifth surface (S5) has a critical point, it may be located within a range of 40% to 50%, preferably 45% to 48%, of the effective radius (r31) from the optical axis (OA). The critical point of the fifth surface (S5) may be located within a range of 1.5 mm to 2 mm, preferably 1.7 mm to 1.9 mm, from the optical axis (OA). The sixth surface (S6) of the third lens (203) may be provided without a critical point from the optical axis (OA) to the end of the effective area.

The aperture (Stop) may be disposed around the periphery of the sensor-side sixth surface (S6) of the third lens (203). The aperture (Stop) may be disposed around the periphery of the object-side seventh surface (S7) of the fourth lens (204). The aperture can reduce the TTL within the field of view and enable the miniaturization of the optical system. As a result, it is possible to prevent a decrease in the weight-based yield (yield by weight) of the optical system and improve production efficiency. Additionally, the optical system can be miniaturized by reducing the TTL within a horizontal field of view (FOV_H) of 80 to 90 degrees.

The fourth lens (204) may be disposed fourth from the object side. The fourth lens (204) may be disposed sixth from the sensor side. The fourth lens (204) may be disposed between the third lens (203) and the fifth lens (205). The fourth lens (204) may have a positive (+) or negative (−) refractive power along the optical axis (OA). The fourth lens (204) may have a positive (+) refractive power. The fourth lens (204) may include a plastic or glass material. For example, the fourth lens (204) may be provided in a glass material.

Based on the optical axis, the object-side seventh surface (S7) of the fourth lens (204) may be convex, and the sensor-side eighth surface (S8) may be convex. The fourth lens (204) may have a shape where both surfaces are convex. The fourth lens (204) may be made of glass material and may be aspherical. The fourth lens (204) may be made of glass material and may be aspherical. At least one or both of the seventh surface (S7) and the eighth surface (S8) may be aspherical. The asphericity coefficients of the seventh and eighth surfaces (S7, S8) may be provided as S1 and S2 of L4 in FIG. 14. At least one or both of the seventh surface (S7) and the eighth surface (S8) may be provided without a critical point from the optical axis (OA) to the end of the effective area.

The fifth lens (205) may be disposed as the fifth lens from the object side. The fifth lens (205) may be disposed as the fifth lens from the sensor side. The fifth lens (205) may be disposed between the fourth lens (204) and the sixth lens (206). The fifth lens (205) may have a positive (+) or negative (−) refractive power relative to the optical axis (OA). The fifth lens (205) may have a positive (+) refractive power. The fifth lens (205) may include a plastic or glass material. For example, the fifth lens (205) may be provided in a plastic material.

With respect to the optical axis (OA), the fifth lens (205) may have an object side concave ninth surface (S9) and a sensor side convex tenth surface (S10). The fifth lens (205) may have a convex meniscus shape on the sensor side. The fifth lens (205) may have a concave meniscus shape on the object side. The fifth lens (205) may be made of plastic material and may be aspherical. At least one or both of the ninth surface (S9) and the tenth surface (S10) may be aspherical. The asphericity coefficient of the ninth and tenth surfaces (S9, S10) may be provided as S1 and S2 of L5 in FIG. 14.

The ninth surface (S9) of the fifth lens (205) may include a critical point extending from the optical axis (OA) to the end of the effective area. If the ninth surface (S9) has a critical point, it may be located within a range of 48% to 55%, preferably 50% to 54%, of the effective radius (r51) from the optical axis (OA). The critical point of the ninth surface (S9) may be located within a range of 2 mm to 2.5 mm, preferably 2.3 mm to 2.4 mm, from the optical axis (OA). The tenth surface (S10) of the fifth lens (205) may be provided without a critical point from the optical axis (OA) to the end of the effective area.

The sixth lens (206) may be disposed as the sixth lens from the object side. The sixth lens (206) may be disposed as the fourth lens from the sensor side. The sixth lens (206) may be disposed between the fifth lens (205) and the seventh lens (207). The sixth lens (206) may have a positive (+) or negative (−) refractive power relative to the optical axis (OA). The sixth lens (206) may have a positive (+) refractive power. The sixth lens (206) may include a plastic or glass material. For example, the sixth lens (206) may be provided in a plastic material.

With respect to the optical axis (OA), the sixth lens (206) may have a convex object side 11th surface (S11) and a convex sensor side 12th surface (S12). The sixth lens (206) may have a shape with both surfaces being convex. The sixth lens (206) may be made of plastic material and may be aspherical. At least one or both of the eleventh surface (S11) and the twelfth surface (S12) may be aspherical. The asphericity coefficient of the eleventh and twelfth surfaces (S11, S12) may be provided as S1 and S2 of L6 in FIG. 14. At least one or both of the 11th surface (S11) and the 12th surface (S12) may be provided without a critical point from the optical axis (OA) to the end of the effective area.

The seventh lens (207) may be disposed seventh from the object side. The seventh lens (207) may be disposed third from the sensor side. The seventh lens (207) may be disposed between the sixth lens (206) and the eighth lens (208). The 7th lens (207) may have a positive (+) or negative (−) refractive power relative to the optical axis (OA). The 7th lens (207) may have a negative (−) refractive power. The 7th lens (207) may include a plastic or glass material. For example, the 7th lens (207) may be provided in a plastic material.

With respect to the optical axis (OA), the seventh lens (207) may have a concave object side 13th surface (S13) and a concave sensor side 14th surface (S14). The seventh lens (207) may have a concave shape on both surfaces. The seventh lens (207) may be made of plastic material and may be aspherical. At least one or both of the 13th surface (S13) and the 14th surface (S14) may be aspherical. The asphericity coefficient of the 13th and 14th surfaces (S13, S14) may be provided as S1 and S2 of L7 in FIG. 14. At least one or both of the 13th surface (S13) and the 14th surface (S14) may be provided without a critical point from the optical axis (OA) to the end of the effective area.

The eighth lens (208) may be disposed eighth from the object side. The eighth lens (208) may be disposed second from the sensor side. The eighth lens (208) may be disposed between the sixth lens (206) and the ninth lens (209). The 8th lens (208) may have a positive (+) or negative (−) refractive power relative to the optical axis (OA). The 8th lens (208) may have a positive (+) refractive power. The 8th lens (208) may include a plastic or glass material. For example, the 8th lens (208) may be provided in a plastic material.

With respect to the optical axis (OA), the eighth lens (208) may have a convex object side 15th surface (S15) and a convex sensor side 16th surface (S16). The eighth lens (208) may have a shape with both surfaces being convex. The eighth lens (208) may be made of plastic material and may be aspherical. At least one or both of the fifteenth surface (S15) and the sixteenth surface (S16) may be aspherical. The asphericity coefficient of the fifteenth and sixteenth surfaces (S15, S16) may be provided as S1 and S2 of L8 in FIG. 14. At least one or both of the 15th surface (S15) and the 16th surface (S16) may be provided without a critical point from the optical axis (OA) to the end of the effective area.

The ninth lens (209) may be disposed farthest from the object. The ninth lens (209) may be disposed closest to the image sensor (500). The ninth lens (209) may have a positive (+) or negative (−) refractive power on the optical axis (OA). The ninth lens (209) may have a negative (−) refractive power. The ninth lens (209) may include a plastic or glass material. For example, the ninth lens (209) may be provided in a plastic material.

With respect to the optical axis (OA), the ninth lens (209) may have a concave object side 17th surface (S17) and a convex sensor side 18th surface (S18). The ninth lens (209) may have a convex meniscus shape on the sensor side. The ninth lens (209) may have a concave meniscus shape on the object side. At least one or both of the 17th surface (S17) and the 18th surface (S18) may be aspherical. The asphericity coefficients of the 17th and 18th surfaces (S17, S18) may be provided as S17 and S18 of L9 in FIG. 14. At least one or both of the 17th surface (S17) and the 18th surface (S18) may be provided without a critical point from the optical axis (OA) to the end of the effective area.

The 9th lens (209) may be the plastic lens closest to the image sensor (500). Additionally, by arranging two or more plastic lenses adjacent to the image sensor (500), aberrations such as spherical aberration and chromatic aberration can be improved, and resolution can be controlled. Furthermore, by arranging a plastic lens adjacent to the image sensor (500), the assembly tolerance may be made insensitive compared to glass lenses. In other words, being insensitive to assembly tolerance means that even if the assembly differs slightly from the design during assembly, it may not significantly affect optical performance. Furthermore, by providing the two lenses (208, 209) adjacent to the image sensor (500) in a plastic material, the optical performance can be improved through the use of aspherical lens surfaces, for example, by improving aberration characteristics and preventing resolution degradation.

TABLE 4

| | | | | | | Semi | Focal |
|---|---|---|---|---|---|---|---|
| Lens | Surface | Radius | Thickness | nd | vd | Aperture | length |
| 1 | S1 | 13.794 | 1.500 | 1.4985 | 81.6072 | 7.164 | −13.9587 |
| | S2 | 4.458 | 5.164 | | | 4.337 | |
| 2 | S3 | −8.288 | 2.127 | 1.5706 | 37.5647 | 4.067 | −10.4864 |
| | S4 | 23.524 | 0.331 | | | 3.941 | |
| 3 | S5 | −165.780 | 2.192 | 1.5371 | 55.7074 | 3.953 | 12.3352 |
| | S6 | −6.400 | 0.100 | | | 3.920 | |
| | STOP | — | 0.100 | | | 3.722 | |
| 4 | S7 | 12.831 | 1.911 | 1.7727 | 49.2893 | 4.100 | 11.0840 |
| | S8 | −24.087 | 1.519 | | | 4.034 | |
| 5 | S9 | −23.947 | 1.566 | 1.5371 | 55.7074 | 4.400 | 170.7020 |
| | S10 | −19.422 | 0.708 | | | 4.453 | |
| 6 | S11 | 41.208 | 1.903 | 1.5371 | 55.7074 | 4.501 | 14.9131 |
| | S12 | −9.782 | 0.100 | | | 4.344 | |
| 7 | S13 | −10.396 | 1.500 | 1.6679 | 20.3792 | 4.304 | −12.6572 |
| | S14 | 47.867 | 0.550 | | | 4.274 | |
| 8 | S15 | 11.374 | 3.733 | 1.5371 | 55.7074 | 4.804 | 10.3636 |
| | S16 | −9.651 | 0.901 | | | 4.767 | |
| 9 | S17 | −4.563 | 2.628 | 1.6679 | 20.3792 | 4.658 | −12.5616 |
| | S18 | −12.310 | 0.167 | | | 5.203 | |
| Cover | | infinity | 0.900 | | | | |
| | | | 0.400 | | | | |
| Image | | infinity | 0.000 | | | | |

Table 4 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the second embodiment of the present invention. Here, the units for curvature radius and thickness or distance may be mm.

TABLE 5

| items | values | items | values |
|---|---|---|---|
| F | 6.2300 | F-number | 1.6400 |
| ET1 | 2.9191 | FOV_H | 83.0 |
| ET2 | 3.5780 | EPD | 3.7988 |
| ET3 | 1.0025 | BFL | 1.4670 |
| ET4 | 0.9738 | TD | 28.5330 |
| ET5 | 1.0000 | ImgH | 5.1450 |
| ET6 | 1.0000 | SD | 17.1188 |
| ET7 | 2.9425 | TTL | 30.0000 |
| ET8 | 1.0000 | GLca_Aver | 9.818 |
| ET9 | 3.6862 | PLca_Aver | 8.798 |
| ΣIndex | 14.3260 | CT_max | 3.7325 |
| ΣAbbe | 432.0492 | CT_min | 1.5000 |
| ΣCT | 19.0599 | CT_Aver | 2.1178 |
| ΣCG | 9.4731 | F_LG1 | −21.915 |
| CA_max | 14.329 | F_LG2 | 9.577 |
| CA_min | 7.443 | | |
| CA_Aver | 8.942 | | |

Table 5 shows the values for the items in the mathematical equations described above in the optical system (1100) of the embodiment. The optical system (1100) may refer to the total track length (TTL) (mm), back focal length (BFL), effective focal length (F) (mm), image height (ImgH) (mm), effective aperture (CA) (mm), thickness (mm), TTL (mm), the optical axis distance TD (mm) from the first surface (S1) to the sixteenth surface (S16), the sum of refractive indices, the sum of Abbe numbers, the sum of thicknesses (mm), the sum of distances between adjacent lenses, the effective aperture characteristics, the sum of refractive indices of glass lenses, the sum of refractive indices of plastic materials, the field of view (FOV_H) (degrees), edge thickness (ET), F-number, etc.

The center thickness of the first to ninth lenses (201 to 209) may be indicated as CT1 to CT9, the edge thickness at the end of the effective area of each lens may be indicated as ET1 to ET9, the center gap between adjacent lenses may be indicated as CG1 to CG8, and the edge-to-edge distance between the edges of each lens may be denoted as EG1 to EG8. BFL (Back focal length) is the optical axis distance from the image sensor (500) to the center of the last lens. TTL is the optical axis distance from the center of the first surface (S1) of the first lens (201) to the image surface of the image sensor (500).

As shown in FIG. 13, in the second embodiment, the lens surfaces of the second, third, fourth, fifth, sixth, seventh, eighth, and ninth lenses (202, 203, 204, 205, 206, 207, 208, 209) among the lenses of the lens unit may include aspherical surfaces having a 30th-order asphericity coefficient. For example, the second, third, fourth, fifth, sixth, seventh, eighth, and ninth lenses (202, 203, 204, 205, 206, 207, 208, 209) may include lens surfaces having a 30th-order aspheric coefficient. As described above, aspherical surfaces with a 30th-order asphericity coefficient (a non-zero numerical value) can significantly alter the aspheric shape in the peripheral region, thereby effectively correcting the optical performance in the peripheral region of the field of view (FOV). The thickness (T1-T9) of the first to ninth lenses (201-209) and the gap (G1-G8) between adjacent lenses can be set. As shown in FIG. 3, the thickness (T1-T9) of each lens in the Y-axis direction may be indicated at intervals of 0.1 or 0.2 mm or more, and the gap (G1-G8) between each lens may be indicated at intervals of 0.1 mm or 0.2 mm or more. When comparing the absolute values of the curvature radii of each lens, the curvature radius of the fifth surface (S5) of the third lens (203) relative to the optical axis (OA) may be the largest among the lenses, and the curvature radius of the second surface (S2) of the first lens (201) may be the smallest among the lenses. The difference between the maximum curvature radius and the minimum curvature radius may be 30 times or more, for example, within the range of 30 to 50 times. Since the effective diameter of a plastic lens is smaller than that of a glass lens, the lens disposed on the object side of a plastic lens may have a stronger refractive power to refract light through the plastic lens. Additionally, to increase the refractive power, the curvature radius of the lens surface may be smaller.

The lens surface facing the aperture (STOP) may be formed gently. The absolute value of the curvature radius of the lens surface facing the aperture (STOP) may be 10 or more. The curvature radius of the object side surface 7th surface (S7)) of the fourth lens (204) adjacent to the aperture (STOP) may satisfy the range of 10 or more and 20 or less. The lens adjacent to the aperture (STOP) affects the optical performance of the entire optical system, so the tilt caused by assembly tolerances must be minimized.

The absolute value of the curvature radius of the first surface (S1) of the first lens (201) may be greater than the absolute value of the curvature radius of the second surface (S2). The absolute value of the curvature radius of the third surface (S3) of the second lens (202) may be less than the absolute value of the curvature radius of the fourth surface (S4). The absolute value of the curvature radius of the fifth surface (S5) of the third lens (203) may be greater than the absolute value of the curvature radius of the sixth surface (S6). The absolute value of the curvature radius of the seventh surface (S7) of the fourth lens (204) may be smaller than the absolute value of the curvature radius of the eighth surface (S8). The absolute value of the curvature radius of the ninth surface (S9) of the fifth lens (205) may be smaller than the absolute value of the curvature radius of the tenth surface (S10). The absolute value of the curvature radius of the eleventh surface (S11) of the sixth lens (206) may be smaller than the absolute value of the curvature radius of the twelfth surface (S12). The absolute value of the curvature radius of the 13th surface (S13) of the 7th lens (207) may be smaller than the absolute value of the curvature radius of the 14th surface (S14). The absolute value of the curvature radius of the 15th surface (S15) of the 8th lens (208) may be greater than the absolute value of the curvature radius of the 16th surface (S16). The absolute value of the curvature radius of the 17th surface (S17) of the 9th lens (209) may be smaller than the absolute value of the curvature radius of the 18th surface (S18).

The ratio of the curvature radii of each lens may satisfy the following conditions.

3<L1R1/L1R2|<4 Condition 1:

0.1<|L2R1/L2R2|<0.5 Condition 2:

20<|L3R1/L3R2|<30 Condition 3:

0.5<|L4R1/L4R2|<1 Condition 4:

1<|L5R1/L5R2|<1.5 Condition 5:

4<|L6R1/L6R2|<4.5 Condition 6:

0.1<|L7R1/L7R2|<0.5 Condition 7:

1<|L8R1/L8R2|<1.5 Condition 8:

0.1<L9R1/L9R2<0.5 Condition 9:

When describing the center thickness (CT) of the lens based on the optical axis, the center thickness (CT8) of the eighth lens (208) may be the maximum among the lenses, and the center thickness (CT1, CT7) of at least one of the first lens (201) and the seventh lens (207) may be the minimum among the lenses. The difference between the maximum and minimum center thicknesses of the lenses may be within the range of 2 mm or more and 2.5 mm or less.

The center thickness of each lens may satisfy any one of the following conditions.

CT2,CT3,CT4,CT5,CT6,CT8,CT9>CT1=CT7 Condition 1:

CT3,CT8,CT9>CT2>CT1,CT4,CT5,CT5,CT7 Condition 2:

CT8,CT9>CT3>CT1,CT2,CT4,CT5,CT6,CT7 Condition 3:

CT2,CT3,CT8,CT9>CT4>CT1,CT5,CT6,CT7 Condition 4:

CT2,CT3,CT4,CT6,CT8,CT9>CT5>CT1,CT7 Condition 5:

CT2,CT3,CT4,CT8,CT9>CT6>CT1,CT5,CT7 Condition 6:

CT8>CT1,CT2,CT3,CT4,CT5,CT6,CT7,CT9 Condition 7:

CT8>CT9>CT1,CT2,CT3,CT4,CT5,CT6,CT7 Condition 9:

The center gap (CG) between the lenses is explained as follows: the center gap (CG1) between the first lens (201) and the second lens (202) may be the maximum, and the center gap (CG6) between the sixth and seventh lenses (206, 207) may be the minimum. The difference between the maximum and minimum center gaps among the spaced-out lenses may be 5 mm or more, for example, within the range of 5 mm to 7 mm.

The center gap between each lens may satisfy the following conditions.

CG1>CG2,CG3,CG4,CG5,CG6,CG7,CG8 Condition 1:

CG1,CG4,CG5,CG7,CG8>CG2>CG3,CG6 Condition 2:

CG1,CG2,CG4,CG5,CG7,CG8>CG3>CG6 Condition 3:

CG1>CG4>CG2,CG3,CG5,CG6,CG7,CG8 Condition 4:

CG1,CG4,CG8>CG5>CG2,CG3,CG6,CG7 Condition 5:

CG1,CG2,CG3,CG4,CG5,CG7,CG8>CG6 Condition 6:

CG1,CG4,CG5,CG8>CG7>CG2,CG3,CG6 Condition 7:

CG1,CG4>CG8>CG2,CG3,CG5,CG6,CG7 Condition 8:

Regarding the effective diameter, a lens with the maximum effective diameter may be a lens made of glass material. The lens with the maximum effective diameter may be the first lens (201). Here, the effective diameter is an average of the effective diameter on the object side surface and the effective diameter on the sensor side surface of each lens. The lens surface with the maximum effective diameter may be the first surface (S1) of the first lens (201). The lens with the minimum effective diameter may be the third lens (203). The lens surface with the minimum effective diameter may be the sixth surface (S6) of the third lens (203). The effective diameter of a lens made of plastic material may be smaller than that of a lens made of glass material. A lens made of plastic material may be disposed adjacent to the image sensor.

The effective diameter of each lens may satisfy any one of the following conditions.

CA_L1,CA_L2,CA_L3,CA_L4,CA_L5,CA_L6,CA_L7,CA_L8>CA_L9 Condition 1:

CA_L1,CA_L3,CA_L4,CA_L5,CA_L6,CA_L7,CA_L8,CA_L9>CA_L2 Condition 2:

CA_L1,CA_L4,CA_L5,CA_L6,CA_L7,CA_L8,CA_L9>CA_L3>CA_L2 Condition 3:

CA_L1,CA_L5,CA_L6,CA_L7,CA_L8,CA_L9>CA_L4>CA_L2,CA_L3 Condition 4:

CA_L1,CA_L6,CA_L9>CA_L5>CA_L2,CA_L3,CA_L4,CA_L7,CA_L8 Condition 5:

CA_L1,CA_L5,CA_L8,CA_L9>CA_L6>CA_L2,CA_L3,CA_L4,CA_L7 Condition 6:

CA_L1,CA_L5,CA_L6,CA_L8,CA_L9>CA_L7>CA_L2,CA_L3,CA_L4 Condition 7:

CA_L1,CA_L9>CA_L8>CA_L2,CA_L3,CA_L4,CA_L5,CA_L6,CA_L7 Condition 8:

CA_L1>CA_L9>CA_L2,CA_L3,CA_L4,CA_L5,CA_L6,CA_L7,CA_L8 Condition 9:

Regarding the refractive index, the refractive index of the fourth lens (204) may be the highest among the lenses, exceeding 1.7, for example, 1.72. The refractive index of the lens disposed on the sensor side of the aperture (STOP) may be the highest among the lenses. The refractive index of the first lens (201) may be the lowest among the lenses, less than 1.55, for example, less than 1.5. The difference between the maximum and minimum refractive indices may be 0.2 or more. By providing a low refractive index lens made of glass material closest to the object and a high refractive index lens made of glass material adjacent to the aperture (STOP), the incident efficiency can be increased, and the refractive power between the glass material and plastic material lenses can be adjusted to guide the light to the image sensor (500).

Each lens's refractive index may satisfy any one of the following conditions.

n2,n3,n4,n5,n6,n7,n8,n9>n1 Condition 1:

n4,n7,n9>n2>n1,n3,n5,n6,n8 Condition 2:

n2,n4,n7,n9>n3=n5=n6=n8>n1 Condition 3:

n4>n1,n2,n3,n5,n6,n7,n8,n9 Condition 4:

n4>n7=n9>n1,n2,n3,n5,n6,n8 Condition 5:

When comparing the Abbe numbers, the Abbe number of the first lens (201) may be the largest among the lenses and may be 70 or higher. The Abbe number of at least one of the seventh lens (207) and the ninth lens (209) may be the smallest among the lenses and may be 25 or lower. The difference between the maximum refractive index and the minimum Abbe number may be 50 or higher. By maximizing the Abbe number of the first lens (201) disposed closest to the object side of the optical system (1100), color dispersion and chromatic aberration can be minimized. By providing the smallest Abbe number for the ninth lens (209) closest to the image sensor (500), the colour dispersion of light passing through lenses made of glass and plastic materials can be controlled, and the color dispersion between lenses made of glass and plastic materials can be increased to guide the light to the image sensor (500).

The Abbe number of each lens may satisfy any one of the following conditions.

v1>v2,v3,v4,v5,v6,v7,v8,v9 Condition 1:

v1,v3,v4,v5,v6,v8>v2>v7,v9 Condition 2:

v1>v3=v5=v6=v8>v2,v4,v7,v9 Condition 3:

v1,v3,v5,v6,v8>v4>v2,v7,v9 Condition 4:

v1,v2,v3,v4,v5,v6,v8>v7=v9 Condition 5:

The focal lengths (F1, F2, F7, F9) of lenses 1, 2, 7, and 9 (201, 202, 207, 209) may have a negative (−) sign. Lenses 1, 2, 7, and 9 (201, 202, 207, 209) may have negative (−) refractive power. The focal lengths (F3, F4, F5, F6, F8) of lenses 3, 4, 5, 6, and 8 (203, 204, 205, 206, 208) may have a positive (+) sign. The third, fourth, fifth, sixth, and eighth lenses (203, 204, 205, 206, 208) may have positive (+) refractive power. The third lens (203) with positive (+) refractive power may be disposed on the sensor side of the first lens (201) and second lens (202) with negative (−) refractive power. This allows light incident from the object side to move away from the optical axis direction and then converge back toward the optical axis direction, thereby forming a stable optical path.

Additionally, the adjacent lenses, namely the sixth lens (206), seventh lens (207), eighth lens (208), and ninth lens (209), may satisfy the following conditions.

Refractive index of a lens with positive refractive power<Refractive index of a lens with negative refractive power Condition 1:

Dispersion value of a lens with positive refractive power>Dispersion value of a lens with negative refractive power Condition 2:

Here, among the plastic lenses, the sixth lens (206) has positive refractive power, and the seventh lens (207) has negative refractive power. According to conditions 1 and 2, the refractive index of the sixth lens (206) is smaller than that of the seventh lens (207), and the dispersion value of the sixth lens (206) is greater than that of the seventh lens (207). Chromatic aberration occurring in plastic lenses can be corrected using plastic lenses. Additionally, when the sixth lens (206) and the seventh lens (207), which are consecutively disposed plastic lenses, satisfy a refractive index difference of 0.1 or more and 0.15 or less, and an Abbe number difference of 20 or more and 50 or less, the chromatic aberration occurring in the plastic lenses can be compensated by the plastic lenses.

Furthermore, among the plastic lenses, the eighth lens (208) has a positive refractive power, and the ninth lens (209) has a negative refractive power, such that according to conditions 1 and 2, the refractive index of the eighth lens (208) is smaller than that of the ninth lens (209), and the dispersion value of the eighth lens (208) is larger than that of the ninth lens (209). Chromatic aberration occurring in the plastic lenses can be corrected by the plastic lenses. Additionally, when the eighth lens (208) and the ninth lens (209), which are consecutively disposed plastic lenses, satisfy the conditions of a refractive index difference of 0.1 or more and 0.15 or less, and an Abbe number difference of 20 or more and 50 or less, the chromatic aberration occurring in the plastic lenses can be compensated for using the plastic lenses.

The shapes of the surfaces facing each other in two lenses with the effect of a composite lens may be similar. The difference in the absolute values of the curvature radii of the surfaces facing each other in two lenses with the effect of a composite lens may satisfy the range of 2 or more and 10 or less. The signs of the curvature radii of the surfaces facing each other in two lenses with the effect of a composite lens may be opposite. The product of the signs of the curvature radii of the opposing surfaces of two lenses with the effect of a composite lens may be negative (−).

An optical system exhibits chromatic aberration, which is corrected using a composite lens or two lenses disposed in series. As the temperature changes from low to high, the lenses repeatedly contract and expand. Lenses made of the same material have the same degree of change in lens characteristics due to temperature changes, so correcting chromatic aberration between lenses of the same material is effective even when the temperature changes. Therefore, in the second embodiment of the present invention, the sixth lens (206) and the seventh lens (207), and the eighth lens (208) and the ninth lens (209) can be used to correct chromatic aberration occurring in plastic lenses.

From the optical axis to the effective diameter area, the maximum distance between the two lenses with the largest Abbe number difference among the two adjacent lenses may be smaller than the maximum distance between other adjacent lenses. Here, the distance refers to the distance between the two lenses from the optical axis to the effective diameter area. The two lenses with the largest Abbe number difference among the two adjacent lenses may be the sixth lens (206) and the seventh lens (207). The maximum value of the distance from the optical axis to the effective diameter area in a direction perpendicular to the optical axis, between the sensor side surface 12th surface (S12) of the sixth lens (206) and the object side surface 13th surface (S13) of the seventh lens (207), may be smaller than the maximum value of the distance between any two adjacent lenses. This allows the distance between two lenses made of difficult-to-bond plastic materials to be designed to be small, maximizing the Abbe number difference, thereby achieving the effect of reducing chromatic aberration to the same level as that of bonded lenses even when the lenses are not bonded.

When comparing focal lengths as absolute values, the focal length of the fifth lens (205) may be the longest among the lenses and may be 40 or more and 50 or less. The focal length of the eighth lens (208) may be the smallest among the lenses, and the absolute value of the focal length of the eighth lens (208) may be 10 or more and 11 or less.

The absolute value of the focal length of each lens may satisfy any one of the following conditions.

|f5|,|f6|>|f1|>|f2|,|f3|,|f4|,|f7|,|f8|,|f9| Condition 1:

|f1|,|f3|,|f4|,|f5|,|f6|,|f7|,|f9|>|f2|>|f8| Condition 2:

|f1|,|f5|,|f6|,|f7|,|f9|>|f3|>|f2|,|f4|,|f8| Condition 3:

|f1|,|f3|,|f5|,|f6|,|f7|,|f9|>|f4|>|f2|,|f8| Condition 4:

|f5|>|f1|,|f2|,|f3|,|f4|,|f6|,|f7|,|f8|,|f9| Condition 5:

|f5|>|f6|>|f1|,|f2|,|f3|,|f4|,|f7|,|f8|,|f9| Condition 6:

|f1|,|f5|,|f6|>|f7|>|f2|,|f3|,|f4|,|f8|,|f9| Condition 7:

|f1|,|f2|,|f3|,|f4|,|f5|,|f6|,|f7|,|f9|>|f8| Condition 8:

|f1|,|f5|,|f6|,|f7|>|f9|>|f2|,|f3|,|f4|,|f8| Condition 9:

The thickness (T1) of the first lens (201) may be within a range where the difference between the maximum thickness and the minimum thickness is two times or more, for example, 2.1 times to 2.5 times, and the center thickness (CT1) may be the minimum, and the edge thickness (ET1) may be the maximum. The thickness (T2) of the second lens (202) may range from 1.5 times to 2 times the minimum thickness. The second lens (202) may have the minimum center thickness (CT2) and the maximum edge thickness (ET2). The thickness (T3) of the third lens (203) may be maximum at the center and minimum at the edge, with the maximum thickness being within the range of 1.5 to 2 times the minimum thickness. The thickness (T4) of the fourth lens (204) may be maximum at the center and minimum at the edge, with the maximum thickness being within the range of 2 to 2.5 times the minimum thickness. The thickness (T5) of the fifth lens (205) may be maximum at the center and minimum at the edge, with the maximum thickness being within the range of 1.1 to 1.5 times the minimum thickness. The thickness (T6) of the sixth lens (206) may be maximum at the center and minimum at the edge, with the maximum thickness being within the range of 2 to 2.5 times the minimum thickness. The thickness (T7) of the seventh lens (207) may be minimum at the center and maximum at the edge, with the maximum thickness ranging from 2 to 2.5 times the minimum thickness. The thickness (T8) of the eighth lens (208) may be maximum at the center and minimum at the edge, with the maximum thickness ranging from 2 to 2.5 times the minimum thickness. The thickness (T9) of the ninth lens (209) may be minimum at the center and maximum at the edge, with the maximum thickness ranging from 1.1 times to 1.5 times the minimum thickness.

The thickness of each lens may satisfy any one of the following conditions.

0.5<CT1/ET1<1,1.5<ET1/CT1<2 Condition 1:

0.5<CT2/ET2<1,1.5<ET2/CT2<2 Condition 2:

2<CT3/ET3<2.5,0.1<ET3/CT3<0.5 Condition 3:

1.5<CT4/ET4<2,0.5<ET4/CT4<1 Condition 4:

1.5<CT5/ET5<2,0.5<ET5/CT5<1 Condition 5:

1.5<CT6/ET6<2,0.5<ET6/CT6<1 Condition 6:

0.3<CT7/ET7<0.7,1.5<ET7/CT7<2 Condition 7:

3.5<CT8/ET8<4,0.1<ET8/CT8<0.5 Condition 8:

0.5<CT8/ET8<1,1<ET8/CT8<1.5 Condition 8:

0.5<CT9/ET9<1,1<ET9/CT9<1.5 Condition 9:

<ΣCT/ΣET<1.2,0.5<ΣET/ΣCT<1 Condition 10:

Among the gaps (G1-G7) between the lenses, the first gap (G1) between the first and second lenses (201, 202) may have a maximum at the center and a minimum at the edge. The second gap (G2) between the second and third lenses (202, 203) may have a maximum at the center and a minimum at the edge. The third gap (G3) between the third and fourth lenses (203, 204) may have the maximum value at the edge and the minimum value at the center. The fourth gap (G4) between the fourth and fifth lenses (204, 205) may have the minimum value at the center and the maximum value at the edge. The fifth gap (G5) between the fifth and sixth lenses (205, 206) may have a minimum center and a maximum edge. The sixth gap (G6) between the sixth and seventh lenses (206, 207) may have a maximum center and a minimum edge. The seventh gap (G7) between the seventh and eighth lenses (207, 208) may have the center portion at its maximum and the edge portion at its minimum. The eighth gap (G8) between the eighth and ninth lenses (208, 209) may have the center portion at its maximum and the edge portion at its minimum.

FIGS. 18, 20, and 22 are graphs showing the diffraction MTF (modulation transfer function) at room temperature, low temperature, and high temperature in the optical system of FIG. 13, respectively. These graphs represent the modulation (luminance ratio) as a function of spatial frequency. As shown in FIGS. 18, 20, and 22, in the second embodiment of the invention, the deviation of the MTF between room temperature and low or high temperatures may be less than 10%, i.e., 7% or less. FIGS. 19, 21, and 23 are graphs showing the aberration characteristics at room temperature, low temperature, and high temperature in the optical system of FIG. 13. The aberration graphs in FIGS. 19, 21, and 23 show the measured values of spherical aberration (Longitudinal Spherical Aberration), astigmatic field curves (Astigmatic Field Curves), and distortion (Distortion) from left to right. In FIGS. 19, 21, and 23, the X-axis represents the focal length (mm) and distortion (%), while the Y-axis denotes the image height (height). Additionally, the graph for spherical aberration corresponds to light in the wavelength bands of approximately 435 nm, 486 nm, 546 nm, 587 nm, and 656 nm, while the graphs for astigmatic field curves and distortion correspond to light in the wavelength band of approximately 546 nm.

In the aberration diagrams of FIGS. 19, 21, and 23, the closer each curve approaches the Y-axis at room temperature, low temperature, and high temperature, the better the aberration correction function is interpreted to be. The optical system (1100) according to the second embodiment shows that the measured values are adjacent to the Y-axis in almost all areas. In other words, the optical system (1100) according to the second embodiment has improved resolution and can achieve good optical performance not only in the central part of the field of view (FOV) but also in the peripheral areas. Here, low temperature may refer to −20 °C or lower, for example, −20 °C to −40 °C, room temperature may refer to 22 °C±5 °C or 18 °C to 27 °C, and high temperature may refer to 85 °C or higher, for example, 85 °C to 205 °C.

As a result, as shown in FIGS. 19, 21, and 23, the reduction in brightness modulation from low temperature to high temperature is less than 10%, for example, 5% or less, or remains almost unchanged. Table 6 compares changes in optical characteristics such as EFL, BFL, F-number (F #), TTL, and field of view (FOV_D) at room temperature, low temperature, and high temperature.

It can be seen that the change rate of optical characteristics at low temperature compared to room temperature is 5% or less, for example, 3% or less.

TABLE 6

| | | | | low | high |
|---|---|---|---|---|---|
| | Room | low | high | temperature/ | temperature/ |
| | temper- | temper- | temper- | Room | Room |
| | ature | ature | ature | temperature | temperature |
| EFL(F) | 6.23 | 6.19 | 6.28 | 99.35% | 100.80% |
| BFL | 1.47 | 1.47 | 1.47 | 100.00% | 100.00% |
| F# | 1.64 | 1.63 | 1.65 | 99.39% | 100.60% |
| TTL | 30.00 | 29.92 | 30.09 | 99.73% | 100.3% |
| FOV_D | 199.27 | 99.97 | 98.41 | 100.70% | 99.13% |

Therefore, as shown in Table 6, the changes in optical characteristics due to temperature changes from low to high temperatures, such as the rate of change in effective focal length (EFL), TTL, BFL, F number, and field of view (FOV_D), are 10% or less, i.e., 5% or less, for example, within the range of 0 to 5%. This design allows for temperature compensation of the plastic lens, even when using one or more plastic lenses, thereby preventing a decrease in the reliability of optical characteristics.

The optical system disclosed in the second embodiment can effectively control aberration characteristics such as chromatic aberration and distortion aberration, and achieve good optical performance not only in the central part but also in the peripheral part of the field of view (FOV).

The optical system according to the third embodiment of the invention will now be described.

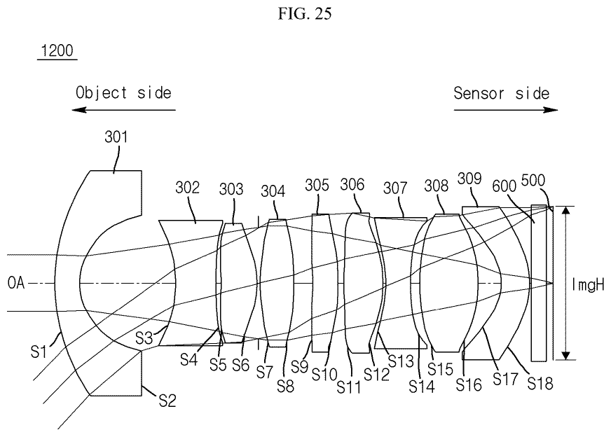

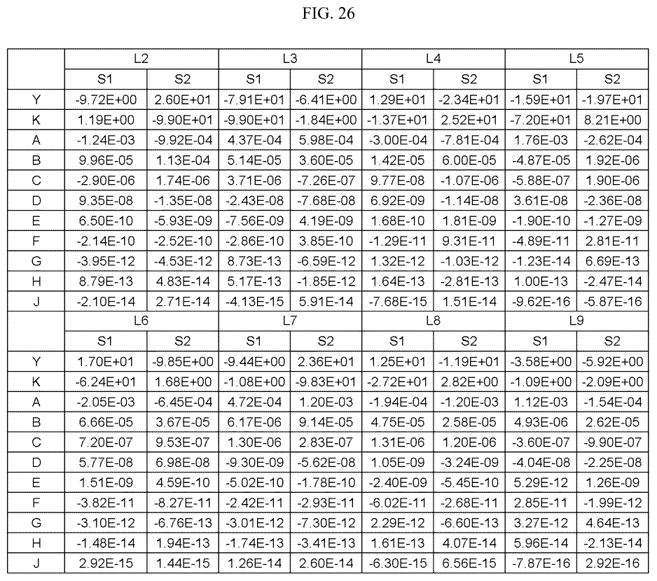

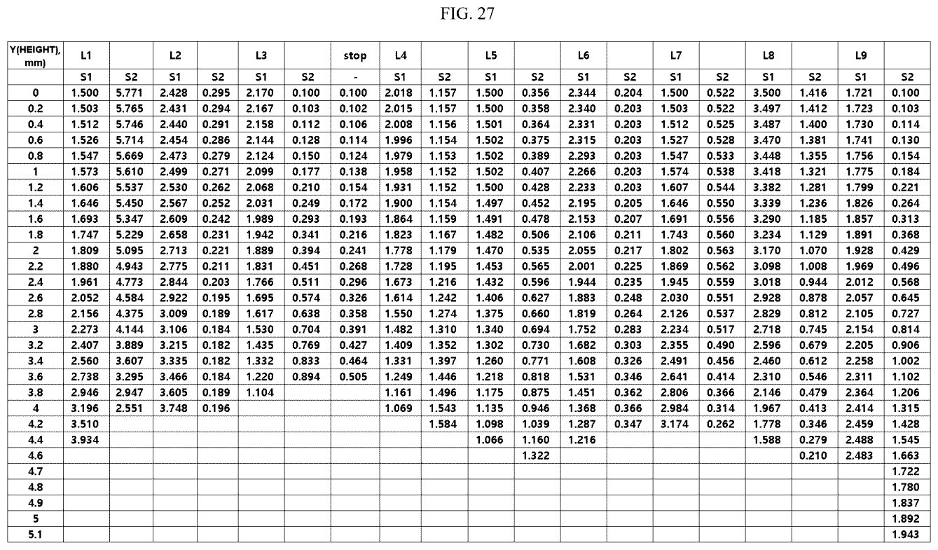

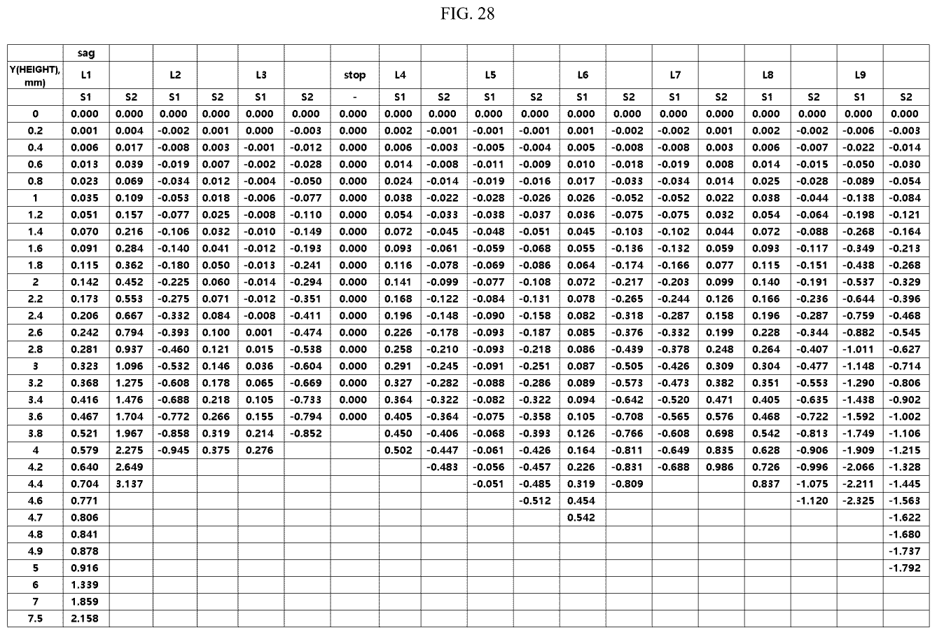

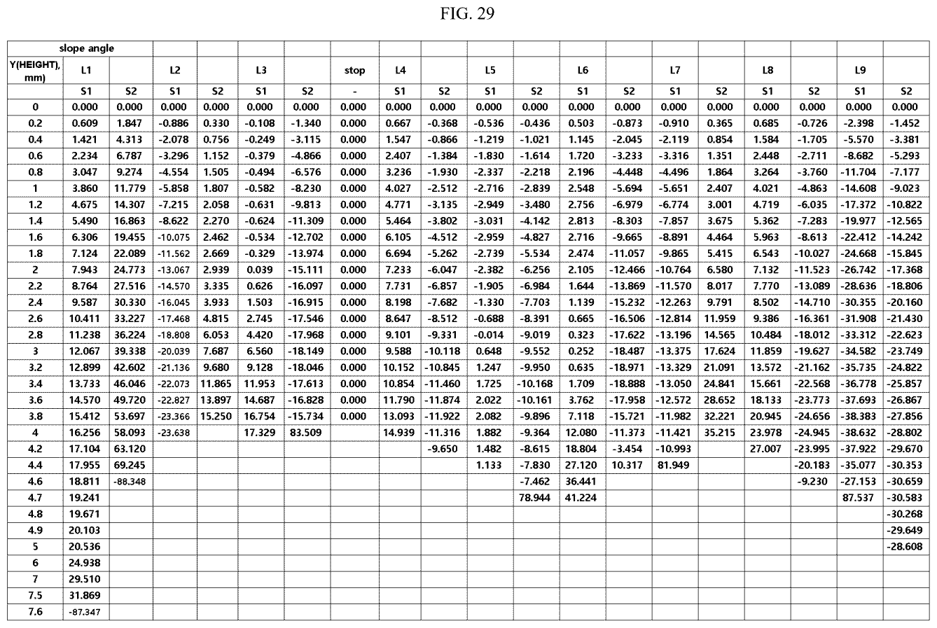

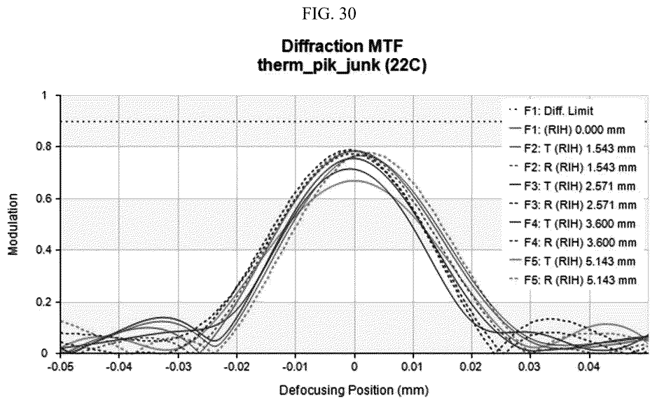

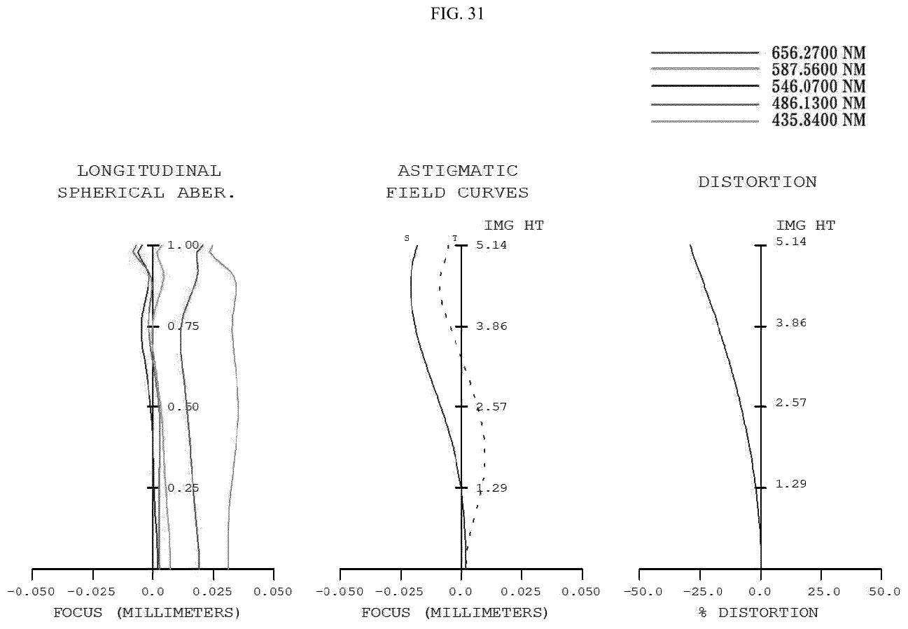

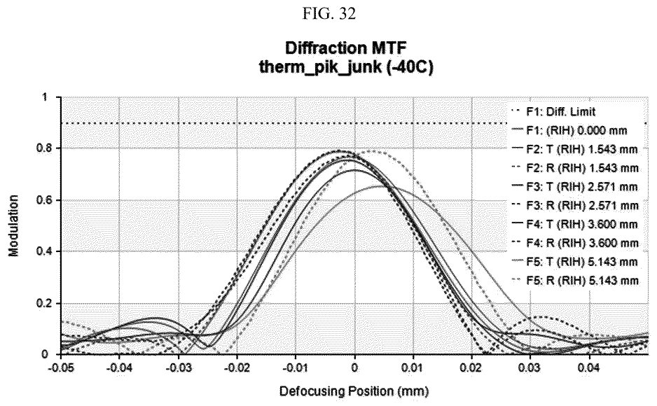

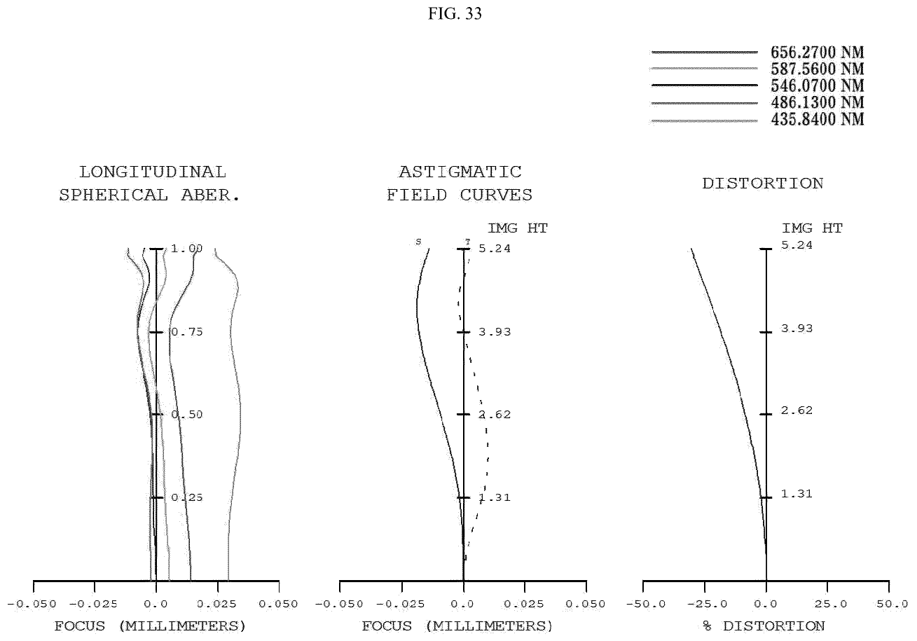

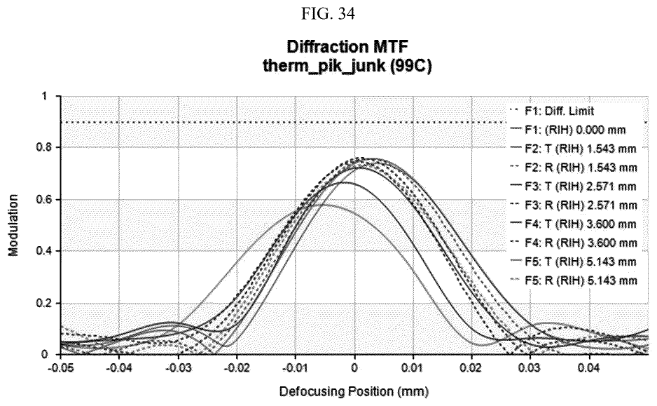

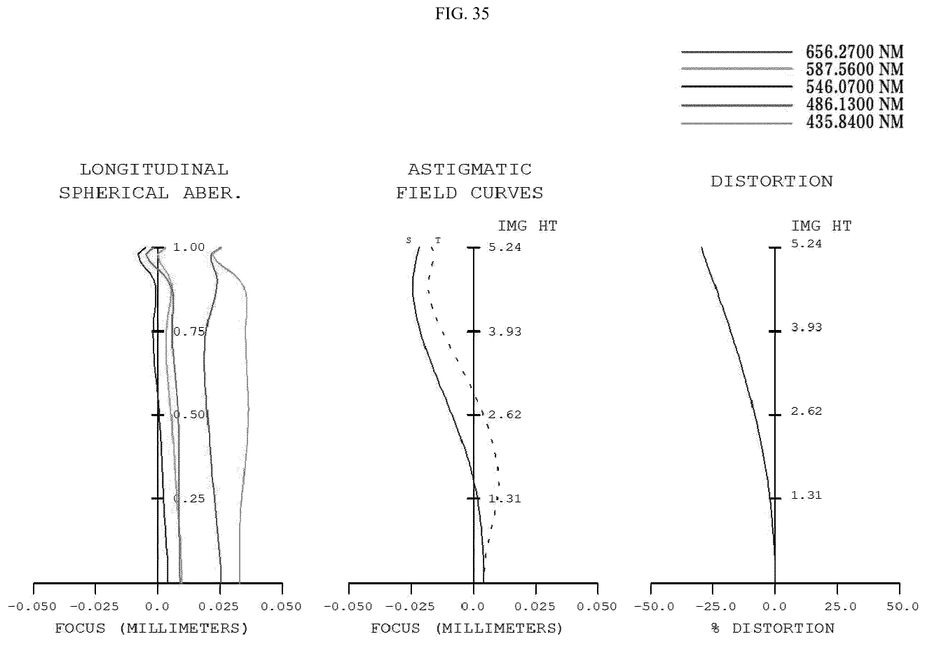

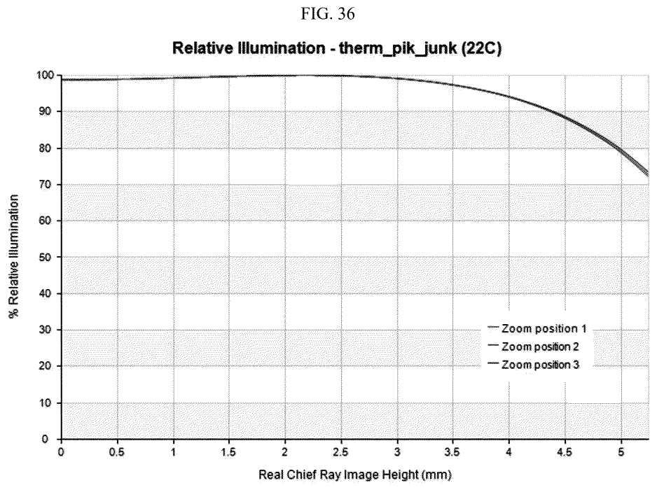

FIG. 25 is a side cross-sectional view of the optical system and a camera module having the same according to a third embodiment, FIG. 26 is a table showing the aspheric coefficients of the lenses in the optical system shown in FIG. 25, FIG. 27 is a table showing the thickness of each lens and the gap (spacing) between adjacent lenses in the optical system of FIG. 25, FIG. 28 is a table showing the sag values of the lens surfaces of the first to ninth lenses in the optical system of FIG. 25, FIG. 29 is a table showing the slope angles of the lens surfaces of the first to ninth lenses in the optical system of FIG. 25, FIG. 30 is a graph showing the data for the diffraction MTF at room temperature of the optical system of FIG. 25, FIG. 31 is a graph showing data on the aberration characteristics of the optical system in FIG. 25 at room temperature, FIG. 32 is a graph showing data on the diffraction MTF (Modulation Transfer Function) of the optical system in FIG. 25 at low temperatures, FIG. 33 is a graph showing data on the aberration characteristics of the optical system in FIG. 25 at low temperatures, FIG. 34 is a graph showing the diffraction MTF data of the optical system shown in FIG. 25 at high temperatures, FIG. 35 is a graph showing the aberration characteristics data of the optical system shown in FIG. 25 at high temperatures, and FIG. 36 is a graph showing the peripheral light intensity ratio of the optical system shown in FIG. 25.

Referring to FIG. 25, the optical system (1200) may include a lens unit, which may include a first lens (301) to a ninth lens (309). The first to ninth lenses (301 to 309) may be disposed sequentially along the optical axis (OA) of the optical system (1200). Light corresponding to information of an object may pass through the first lens (301) to the ninth lens (309) and the filter (600) and enter the image sensor (500).

The first lens (301) may be disposed closest to the object side. The first lens (301) may be disposed farthest from the sensor side. The first lens (301) may have a negative (−) refractive power along the optical axis (OA). The first lens (301) may include a plastic material or a glass material, for example, it may be made of glass. The first lens (301) made of glass material can reduce changes in the center position and curvature radius due to temperature changes caused by the surrounding environment, and can protect the incident side of the optical system (1200).

Based on the optical axis, the object side first surface (S1) of the first lens (301) may be convex, and the sensor side second surface (S2) may be concave. The first lens (301) may have a convex meniscus shape on the object side. The first lens (301) may be made of glass and may have a spherical surface. At least one or both of the first surface (S1) and the second surface (S2) may be provided without any critical points from the optical axis (OA) to the end of the effective area.

Due to the refractive characteristics of the first lens (301), the second lens (302) may be further spaced apart from the first lens (301). That is, the center gap between the first and second lenses (301, 302) may be the largest within the lens unit. The first lens (301) may have the greatest influence in the optical system (1200).

The Abbe number (v1) of the first lens (301) may satisfy the condition v1>70 or v1>75. Since the refractive index (v1) of the first lens (301) is the largest within the lens unit, the first lens (301) may exhibit minimal dispersion and reduced chromatic aberration.

The second lens (302) may be disposed second from the object side. The second lens (302) may be disposed eighth from the sensor side. The second lens (302) may be disposed between the first lens (301) and the third lens (303). The second lens (302) may have a negative (−) refractive power on the optical axis (OA). The second lens (302) may include a plastic or glass material. For example, the second lens (302) may be provided in a plastic material.

Based on the optical axis (OA), the object-side third surface (S3) of the second lens (302) may be concave, and the sensor-side fourth surface (S4) may be concave. The second lens (302) may have a concave shape on both sides. The second lens (302) may be made of plastic material and may be aspherical. At least one or both of the third surface (S3) and the fourth surface (S4) may be aspherical. The aspherical coefficients of the third and fourth surfaces (S3, S4) may be provided as S1 and S2 of L2 in FIG. 26. At least one or both of the third surface (S3) and the fourth surface (S4) may be provided without a critical point from the optical axis (OA) to the end of the effective area.

The third lens (303) may be disposed third from the object side. The third lens (303) may be disposed seventh from the sensor side. The third lens (303) may be disposed between the second lens (302) and the fourth lens (304). The third lens (303) may have a positive (+) refractive power on the optical axis (OA). The third lens (303) may include a plastic or glass material. For example, the third lens (303) may be provided in a plastic material.

Based on the optical axis, the object-side fifth surface (S5) of the third lens (303) may be concave, and the sensor-side sixth surface (S6) may be convex. The third lens (303) may have a convex meniscus shape toward the sensor side. The third lens (303) may have a concave meniscus shape toward the object side. The third lens (303) may be made of plastic material and may be aspherical. At least one or both of the fifth surface (S5) and the sixth surface (S6) may be aspherical. The asphericity coefficients of the fifth and sixth surfaces (S5, S6) may be provided as S5 and S6 of L3 in FIG. 26.

The fifth surface (S5) of the third lens (303) may include a critical point extending from the optical axis (OA) to the end of the effective area. If the fifth surface (S5) has a critical point, it may be located within the range of 43% to 50% of the effective radius (r31) from the optical axis (OA), preferably within the range of 45% to 48.5%. The critical point of the fifth surface (S5) may be located within a range of 1.5 mm to 2.2 mm from the optical axis (OA), preferably within a range of 1.8 mm to 1.9 mm. The sixth surface (S6) of the third lens (303) may be provided without a critical point from the optical axis (OA) to the end of the effective area.

The aperture (Stop) may be disposed around the periphery of the sensor-side sixth surface (S6) of the third lens (303). The aperture (Stop) may be disposed around the periphery of the object-side seventh surface (S7) of the fourth lens (304). The aperture can reduce the TTL within the field of view and enable the miniaturization of the optical system. As a result, it is possible to prevent a decrease in the weight-based yield (yield by weight) of the optical system and improve production efficiency. Additionally, the optical system can be miniaturized by reducing the TTL within a horizontal field of view (FOV_H) of 80 to 90 degrees.

The fourth lens (304) may be disposed fourth from the object side. The fourth lens (304) may be disposed sixth from the sensor side. The fourth lens (304) may be disposed between the third lens (303) and the fifth lens (305). The fourth lens (304) may have a positive (+) or negative (−) refractive power along the optical axis (OA). The fourth lens (304) may have a positive (+) refractive power. The fourth lens (304) may include a plastic or glass material. For example, the fourth lens (304) may be provided in a glass material.

Based on the optical axis, the object-side seventh surface (S7) of the fourth lens (304) may be convex, and the sensor-side eighth surface (S8) may be convex. The fourth lens (304) may have a shape where both surfaces are convex. The fourth lens (304) may be made of glass material and may be aspherical. The fourth lens (304) may be made of glass material and may be aspherical. At least one or both of the seventh surface (S7) and the eighth surface (S8) may be aspherical. The asphericity coefficient of the seventh and eighth surfaces (S7, S8) may be provided as S1 and S2 of L4 in FIG. 26. At least one or both of the seventh surface (S7) and the eighth surface (S8) may be provided without a critical point from the optical axis (OA) to the end of the effective area.

The fifth lens (305) may be disposed fifth from the object side. The fifth lens (305) may be disposed fifth from the sensor side. The fifth lens (305) may be disposed between the fourth lens (304) and the sixth lens (306). The fifth lens (305) may have a positive (+) or negative (−) refractive power relative to the optical axis (OA). The fifth lens (305) may have a negative (−) refractive power. The fifth lens (305) may include a plastic or glass material. For example, the fifth lens (305) may be provided in a plastic material.

With respect to the optical axis (OA), the fifth lens (305) may have a concave object side ninth surface (S9) and a convex sensor side tenth surface (S10). The fifth lens (305) may have a convex meniscus shape on the sensor side. The fifth lens (305) may have a concave meniscus shape on the object side. The fifth lens (305) may be made of plastic material and may be aspherical. At least one or both of the ninth surface (S9) and the tenth surface (S10) may be aspherical. The asphericity coefficient of the ninth and tenth surfaces (S9, S10) may be provided as S1 and S2 of L5 in FIG. 26.

The ninth surface (S9) of the fifth lens (305) may include a critical point extending from the optical axis (OA) to the end of the effective area. If the ninth surface (S9) has a critical point, it may be located within the range of 60% to 70%, preferably 61% to 65%, of the effective radius (r51) from the optical axis (OA). The critical point of the ninth surface (S9) may be located within a range of 2.5 mm to 3 mm from the optical axis (OA), preferably within a range of 2.8 mm to 2.9 mm. The tenth surface (S10) of the fifth lens (305) may be provided without a critical point from the optical axis (OA) to the end of the effective area.

The sixth lens (306) may be disposed sixth from the object side. The sixth lens (306) may be disposed fourth from the sensor side. The sixth lens (306) may be disposed between the fifth lens (305) and the seventh lens (307). The sixth lens (306) may have a positive (+) or negative (−) refractive power relative to the optical axis (OA). The sixth lens (306) may have a positive (+) refractive power. The sixth lens (306) may include a plastic or glass material. For example, the sixth lens (306) may be provided in a plastic material.

With respect to the optical axis (OA), the sixth lens (306) may have a convex object side 11th surface (S11) and a convex sensor side 12th surface (S12). The sixth lens (306) may have a shape with both surfaces being convex. The sixth lens (306) may be made of plastic material and may be aspherical. At least one or both of the eleventh surface (S11) and the twelfth surface (S12) may be aspherical. The asphericity coefficient of the eleventh and twelfth surfaces (S11, S12) may be provided as S1 and S2 of L6 in FIG. 26. At least one or both of the 11th surface (S11) and the 12th surface (S12) may be provided without a critical point from the optical axis (OA) to the end of the effective area.

The seventh lens (307) may be disposed seventh from the object side. The seventh lens (307) may be disposed third from the sensor side. The seventh lens (307) may be disposed between the sixth lens (306) and the eighth lens (308). The 7th lens (307) may have a positive (+) or negative (−) refractive power along the optical axis (OA). The 7th lens (307) may have a negative (−) refractive power. The 7th lens (307) may include a plastic or glass material. For example, the 7th lens (307) may be provided in a plastic material.

With respect to the optical axis (OA), the seventh lens (307) may have a concave object side 13th surface (S13) and a concave sensor side 14th surface (S14). The seventh lens (307) may have a concave shape on both sides. The seventh lens (307) may be made of plastic material and may be aspherical. At least one or both of the 13th surface (S13) and the 14th surface (S14) may be aspherical. The asphericity coefficient of the 13th and 14th surfaces (S13, S14) may be provided as S1 and S2 of L7 in FIG. 26. At least one or both of the 13th surface (S13) and the 14th surface (S14) may be provided without a critical point from the optical axis (OA) to the end of the effective area.

The eighth lens (308) may be disposed eighth from the object side. The eighth lens (308) may be disposed second from the sensor side. The eighth lens (308) may be disposed between the sixth lens (306) and the ninth lens (309). The eighth lens (308) may have a positive (+) or negative (−) refractive power on the optical axis (OA). The eighth lens (308) may have a positive (+) refractive power. The eighth lens (308) may include a plastic or glass material. For example, the eighth lens (308) may be provided in a plastic material.

With respect to the optical axis (OA), the eighth lens (308) may have a convex object side 15th surface (S15) and a convex sensor side 16th surface (S16). The eighth lens (308) may have a shape with both surfaces being convex. The eighth lens (308) may be made of plastic material and may be aspherical. At least one or both of the 15th surface (S15) and 16th surface (S16) may be aspherical. The asphericity coefficient of the 15th and 16th surfaces (S15, S16) may be provided as S1 and S2 of L8 in FIG. 26. At least one or both of the 15th surface (S15) and the 16th surface (S16) may be provided without a critical point from the optical axis (OA) to the end of the effective area.

The ninth lens (309) may be disposed farthest from the object. The ninth lens (309) may be disposed closest to the image sensor (500). The ninth lens (309) may have a positive (+) or negative (−) refractive power on the optical axis (OA). The ninth lens (309) may have a negative (−) refractive power. The ninth lens (309) may include a plastic or glass material. For example, the ninth lens (309) may be provided in a plastic material.

With respect to the optical axis (OA), the ninth lens (309) may have a concave object side 17th surface (S17) and a convex sensor side 18th surface (S18). The ninth lens (309) may have a convex meniscus shape on the sensor side. The ninth lens (309) may have a concave meniscus shape on the object side. At least one or both of the 17th surface (S17) and the 18th surface (S18) may be aspherical. The asphericity coefficients of the 17th and 18th surfaces (S17, S18) may be provided as S17 and S18 of L9 in FIG. 26. At least one or both of the 17th surface (S17) and the 18th surface (S18) may be provided without a critical point from the optical axis (OA) to the end of the effective area.

The 9th lens (309) may be the plastic lens closest to the image sensor (500). Additionally, by arranging two or more plastic lenses adjacent to the image sensor (500), aberrations such as spherical aberration and chromatic aberration can be improved, and resolution can be controlled. Furthermore, by arranging a plastic lens adjacent to the image sensor (500), it is possible to be insensitive to assembly tolerances compared to glass lenses. In other words, being insensitive to assembly tolerances means that even if the assembly differs slightly from the design during assembly, it may not significantly affect optical performance. Furthermore, by providing the two lenses (308, 309) adjacent to the image sensor (500) in a plastic material, the optical performance can be improved by the aspherical lens surfaces, for example, by improving aberration characteristics and preventing resolution degradation.

TABLE 7

| | | | | | | Semi | Focal |
|---|---|---|---|---|---|---|---|
| Lens | Surface | Radius | Thickness | nd | vd | Aperture | length |
| 1 | S1 | 14.111 | 1.500 | 1.4985 | 81.6072 | 7.545 | −14.7080 |
| | S2 | 4.654 | 5.771 | | | 4.566 | |
| 2 | S3 | −9.718 | 2.428 | 1.5706 | 37.5647 | 4.191 | −12.0919 |
| | S4 | 25.951 | 0.295 | | | 4.010 | |
| 3 | S5 | −79.143 | 2.170 | 1.5371 | 55.7074 | 4.027 | 12.8523 |
| | S6 | −6.410 | 0.100 | | | 3.972 | |
| | STOP | — | 0.100 | | | 3.720 | |
| 4 | S7 | 12.875 | 2.018 | 1.7727 | 49.2893 | 4.100 | 11.0197 |
| | S8 | −23.428 | 1.157 | | | 4.246 | |
| 5 | S9 | −15.941 | 1.500 | 1.5371 | 55.7074 | 4.503 | −180.0840 |
| | S10 | −19.714 | 0.356 | | | 4.601 | |
| 6 | S11 | 16.987 | 2.344 | 1.5371 | 55.7074 | 4.708 | 11.9735 |
| | S12 | −9.850 | 0.204 | | | 4.443 | |
| 7 | S13 | −9.439 | 1.500 | 1.6679 | 20.3792 | 4.380 | −9.9095 |
| | S14 | 23.561 | 0.522 | | | 4.204 | |
| 8 | S15 | 12.515 | 3.500 | 1.5371 | 55.7074 | 4.477 | 11.9377 |
| | S16 | −11.863 | 1.416 | | | 4.608 | |
| 9 | S17 | −3.580 | 1.721 | 1.6679 | 20.3792 | 4.632 | −19.2674 |
| | S18 | −5.915 | 0.100 | | | 5.101 | |
| Cover | | infinity | 0.900 | | | | |
| | | | 0.400 | | | | |
| Image | | infinity | 0.000 | | | | |

Table 7 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the third embodiment of the present invention. Here, the units for curvature radius and thickness or distance may be mm.

TABLE 8

| items | values | items | values |
|---|---|---|---|
| F | 6.2300 | F-number | 1.6400 |
| ET1 | 3.0592 | FOV_H | 83.0 |
| ET2 | 3.8286 | EPD | 3.7988 |
| ET3 | 0.9957 | BFL | 1.4000 |
| ET4 | 0.9988 | TD | 28.6000 |
| ET5 | 1.0396 | ImgH | 5.1450 |
| ET6 | 1.0147 | SD | 16.3358 |
| ET7 | 3.1731 | TTL | 30.0000 |
| ET8 | 1.5174 | GLca_Aver | 10.228 |
| ET9 | 2.2070 | PLca_Aver | 8.837 |
| ΣIndex | 14.3260 | CT_max | 3.5000 |
| ΣAbbe | 432.0492 | CT_min | 1.5000 |
| ΣCT | 18.6802 | CT_Aver | 2.0756 |
| ΣCG | 9.9198 | F_LG1 | −29.939 |
| CA_max | 15.090 | F_LG2 | 10.161 |
| CA_min | 7.440 | | |
| CA_Aver | 9.056 | | |

Table 8 shows the values for the items in the mathematical equations described above in the optical system (1200) of the third embodiment, including the total track length (TTL) (mm), back focal length (BFL), effective focal length (F) (mm), image height (ImgH) (mm), effective diameter (CA) (mm), thickness (mm), TTL (mm), the optical axis distance TD (mm) from the first surface (S1) to the sixteenth surface (S16), the sum of refractive indices, the sum of Abbe numbers, the sum of thicknesses (mm), the sum of intervals between adjacent lenses, the effective diameter characteristics, the sum of refractive indices of glass lenses, the sum of refractive indices of plastic materials, the field of view (FOV_H) (degrees), edge thickness (ET), F-number, etc.

The center thickness of the first to ninth lenses (301 to 309) is denoted as CT1 to CT9, the edge thickness at the end of the effective area of each lens is denoted as ET1 to ET9, the center gap between adjacent lenses is denoted as CG1 to CG8, and the edge gap between the edges of each lens is denoted as EG1 to EG8. BFL (Back focal length) is the optical axis distance from the image sensor (500) to the center of the last lens. TTL is the optical axis distance from the center of the first surface (S1) of the first lens (301) to the image surface of the image sensor (500).

As shown in FIG. 26, the lens surfaces of the second, third, fourth, fifth, sixth, seventh, eighth, and ninth lenses (302, 303, 304, 305, 306, 307, 308, 309) in the lens unit of the third embodiment may include aspherical surfaces with a 30th-order asphericity coefficient. For example, the second, third, fourth, fifth, sixth, seventh, eighth, and ninth lenses (302, 303, 304, 305, 306, 307, 308, 309) may include lens surfaces with a 30th-order aspheric coefficient. As described above, aspherical surfaces with a 30th-order asphericity coefficient (a non-zero numerical value) can significantly alter the aspheric shape in the peripheral region, thereby effectively correcting the optical performance in the peripheral region of the field of view (FOV).

The thickness (T1-T9) of the first to ninth lenses (301-309) and the gap (G1-G8) between adjacent lenses may be set. As shown in FIG. 3, the thickness (T1-T9) of each lens in the Y-axis direction may be displayed at gaps of 0.1 mm or 0.2 mm or more, and the gap (G1-G8) between each lens may be displayed at gaps of 0.1 mm or 0.2 mm or more. When comparing the absolute values of the curvature radii of each lens, the curvature radius of the fifth surface (S5) of the third lens (303) relative to the optical axis (OA) may be the largest among the lenses, and the curvature radius of the seventeenth surface (S17) of the ninth lens (309) may be the smallest among the lenses. The difference between the maximum and minimum curvature radii may be 20 times or more, for example, within the range of 20 to 30 times. Since the effective diameter of a plastic lens may be smaller than that of a glass lens, the lens disposed on the object side of a plastic lens may have a stronger refractive power to refract light through the plastic lens. Additionally, the curvature radius of the lens surface may be made smaller to increase the refractive power. The lens surface facing the aperture (STOP) may be formed with a gentle curvature. The absolute value of the curvature radius of the lens surface facing the aperture (STOP) may be 10 or greater. The curvature radius of the object side surface 7th surface (S7)) of the fourth lens (304) adjacent to the aperture (STOP) may satisfy the range of 10 or more and 20 or less. The lens adjacent to the aperture (STOP) affects the optical performance of the entire optical system, so the tilt caused by assembly tolerances must be minimized.

The absolute value of the curvature radius of the first surface (S1) of the first lens (301) may be greater than the absolute value of the curvature radius of the second surface (S2). The absolute value of the curvature radius of the third surface (S3) of the second lens (302) may be smaller than the absolute value of the curvature radius of the fourth surface (S4). The absolute value of the curvature radius of the fifth surface (S5) of the third lens (303) may be greater than the absolute value of the curvature radius of the sixth surface (S6). The absolute value of the curvature radius of the seventh surface (S7) of the fourth lens (304) may be less than the absolute value of the curvature radius of the eighth surface (S8). The absolute value of the curvature radius of the ninth surface (S9) of the fifth lens (305) may be smaller than the absolute value of the curvature radius of the tenth surface (S10). The absolute value of the curvature radius of the eleventh surface (S11) of the sixth lens (306) may be larger than the absolute value of the curvature radius of the twelfth surface (S12). The absolute value of the curvature radius of the 13th surface (S13) of the 7th lens (307) may be smaller than the absolute value of the curvature radius of the 14th surface (S14). The absolute value of the curvature radius of the 15th surface (S15) of the 8th lens (308) may be greater than the absolute value of the curvature radius of the 16th surface (S16). The absolute value of the curvature radius of the 17th surface (S17) of the 9th lens (309) may be smaller than the absolute value of the curvature radius of the 18th surface (S18).

The ratio of the curvature radii of each lens may satisfy the following conditions.

3<L1R1/L1R2|<4 Condition 1:

0.1<|L2R1/L2R2|<0.5 Condition 2:

10<|L3R1/L3R2|<15 Condition 3:

0.3<L4R1/L4R2<0.7 Condition 4:

0.5<|L5R1/L5R2|<1 Condition 5:

1.5<|L6R1/L6R2|<2 Condition 6:

0.1<|L7R1/L7R2|<0.5 Condition 7:

1<L8R1/L8R2<1.5 Condition 8:

0.5<L9R1/L9R2<1 Condition 9:

When describing the center thickness (CT) of the lenses based on the optical axis, the center thickness (CT8) of the eighth lens (308) may be the maximum among the lenses, and the center thickness (CT1, CT7) of at least one of the first lens (301) and the seventh lens (307) may be the minimum among the lenses. The difference between the maximum and minimum center thicknesses of the lenses may be within the range of 2 mm or more and 2.5 mm or less.

The center thickness of each lens may satisfy any one of the following conditions.

CT2,CT3,CT4,CT5,CT6,CT8,CT9>CT1=CT5=CT7 Condition 1:

CT8>CT2>CT1,CT3,CT4,CT5,CT6,CT7,CT9 Condition 2:

CT2,CT6,CT8>CT3>CT1,CT4,CT5,CT7,CT9 Condition 3:

CT2,CT3,CT6,CT8>CT4>CT1,CT5,CT7,CT9 Condition 4:

CT2,CT8>CT6>CT1,CT3,CT4,CT5,CT7,CT9 Condition 5:

CT8>CT1,CT2,CT3,CT4,CT5,CT6,CT7,CT9 Condition 6:

CT2,CT3,CT4,CT6,CT8>CT9>CT1,CT5,CT7 Condition 7:

The center gap (CG) between the lenses is explained as follows: the center gap (CG1) between the first lens (301) and the second lens (302) may be the maximum, while the center gap (CG3) between the third and fourth lenses (303, 304) may be the minimum. The difference between the maximum and minimum center gaps among the spaced-apart lenses may be 5 mm or more, for example, within the range of 5 mm to 7 mm.

The center gap between each lens may satisfy the following conditions.

CG1>CG2,CG3,CG4,CG5,CG6,CG7,CG8 Condition 1:

CG1,CG4,CG5,CG7,CG8>CG2>CG3,CG6 Condition 2:

CG1,CG2,CG4,CG5,CG6,CG7,CG8>CG3 Condition 3:

CG1,CG8>CG4>CG2,CG3,CG5,CG6,CG7 Condition 4:

CG1,CG4,CG7,CG8>CG5>CG2,CG3,CG6 Condition 5:

CG1,CG2,CG4,CG5,CG7,CG8>CG6>CG3 Condition 6:

CG1,CG4,CG8>CG7>CG2,CG3,CG5,CG6 Condition 7:

CG1>CG8>CG2,CG3,CG4,CG5,CG6,CG7 Condition 8:

Regarding the effective diameter, a lens with the maximum effective diameter may be a lens made of glass material. The lens with the maximum effective diameter may be the first lens (301). Here, the effective diameter is an average of the effective diameter on the object side surface and the effective diameter on the sensor side surface of each lens. The lens surface with the maximum effective diameter may be the first surface (S1) of the first lens (301). The lens with the minimum effective diameter may be the third lens (303). The lens surface with the minimum effective diameter may be the sixth surface (S6) of the third lens (303). The effective diameter of a plastic lens may be smaller than that of a glass lens. A plastic lens may be disposed adjacent to the image sensor.

The effective diameter of each lens may satisfy any one of the following conditions.

CA_L1>CA_L2,CA_L3,CA_L4,CA_L5,CA_L6,CA_L7,CA_L8,CA_L9 Condition 1:

CA_L1,CA_L3,CA_L4,CA_L5,CA_L6,CA_L7,CA_L8,CA_L9>CA_L2 Condition 2:

CA_L1,CA_L4,CA_L5,CA_L6,CA_L7,CA_L8,CA_L9>CA_L3>CA_L2 Condition 3:

CA_L1,CA_L5,CA_L6,CA_L7,CA_L8,CA_L9>CA_L4>CA_L2,CA_L3 Condition 4:

CA_L1,CA_L6,CA_L9>CA_L5>CA_L2,CA_L3,CA_L4,CA_L7,CA_L8 Condition 5:

CA_L1,CA_L9>CA_L6>CA_L2,CA_L3,CA_L4,CA_L5,CA_L7,CA_L8 Condition 6:

CA_L1,CA_L5,CA_L6,CA_L8,CA_L9>CA_L7>CA_L2,CA_L3,CA_L4 Condition 7:

CA_L1,CA_L5,CA_L6,CA_L9>CA_L8>CA_L2,CA_L3,CA_L4,CA_L7 Condition 8:

CA_L1>CA_L9>CA_L2,CA_L3,CA_L4,CA_L5,CA_L6,CA_L7,CA_L8 Condition 9:

Explaining the refractive index, the refractive index of the fourth lens (304) may be the highest among the lenses and may exceed 1.7, for example, 1.72. The refractive index of the lens disposed on the sensor side of the aperture (STOP) may be the highest among the lenses. The refractive index of the first lens (301) may be the lowest among the lenses, less than 1.55, for example, less than 1.5. The difference between the maximum and minimum refractive indices may be 0.2 or more. By providing a low refractive index lens made of glass material closest to the object and a high refractive index lens made of glass material adjacent to the aperture (STOP), the incident efficiency can be increased, and the refractive power between the glass material and plastic material lenses can be controlled to guide the light to the image sensor (500).

The refractive index of each lens may satisfy any one of the following conditions.

n2,n3,n4,n5,n6,n7,n8,n9>n1 Condition 1:

n4,n7,n9>n2>n1,n3,n5,n6,n8 Condition 2:

n2,n4,n7,n9>n3=n5=n6=n8>n1 Condition 3:

n4>n1,n2,n3,n5,n6,n7,n8,n9 Condition 4:

n4>n7=n9>n1,n2,n3,n5,n6,n8 Condition 5:

When comparing the Abbe numbers, the Abbe number of the first lens (301) may be the largest among the lenses and may be 70 or higher. At least one of the Abbe numbers of the seventh lens (307) and the ninth lens (309) may be the smallest among the lenses and may be 25 or lower. The difference between the maximum refractive index and the minimum Abbe number may be 50 or higher. By maximizing the Abbe number of the first lens (301) disposed closest to the object side of the optical system (1200), color dispersion and chromatic aberration can be minimized. By providing the smallest Abbe number for the ninth lens (309) closest to the image sensor (500), the color dispersion of light passing between glass and plastic lenses can be controlled, and the color dispersion between glass and plastic lenses can be increased to guide the light to the image sensor (500).

The Abbe number of each lens may satisfy any one of the following conditions.

v1>v2,v3,v4,v5,v6,v7,v8,v9 Condition 1:

v1,v3,v4,v5,v6,v8>v2>v7,v9 Condition 2:

v1>v3=v5=v6=v8>v2,v4,v7,v9 Condition 3:

v1,v3,v5,v6,v8>v4>v2,v7,v9 Condition 4:

v1,v2,v3,v4,v5,v6,v8>v7=v9 Condition 5:

The focal lengths (F1, F2, F5, F7, F9) of lenses 1, 2, 5, 7, and 9 (301, 302, 305, 307, 309) may have a negative (−) sign. Lenses 1, 2, 5, 7, and 9 (301, 302, 305, 307, 309) may have negative (−) refractive power. The focal lengths (F3, F4, F6, F8) of lenses 3, 4, 6, and 8 (303, 304, 306, 308) may have positive (+) signs. The third, fourth, sixth, and eighth lenses (303, 304, 306, 308) may have positive (+) refractive power. The third lens (303) with positive (+) refractive power may be disposed on the sensor side of the first lens (301) and second lens (302) with negative (−) refractive power. This allows light incident from the object side to diverge away from the optical axis direction and then converge back toward the optical axis direction, thereby forming a stable optical path.

Additionally, the adjacent lenses, i.e., the sixth lens (306), seventh lens (307), eighth lens (308), and ninth lens (309), may satisfy the following conditions.

Refractive index of a lens with positive refractive power<Refractive index of a lens with negative refractive power Condition 1:

Dispersion value of a lens with positive refractive power>Dispersion value of a lens with negative refractive power Condition 2:

Here, among the plastic lenses, the sixth lens (306) has positive refractive power, and the seventh lens (307) has negative refractive power. According to conditions 1 and 2, the refractive index of the sixth lens (306) may be smaller than that of the seventh lens (307), the dispersion value of the sixth lens (306) may be greater than that of the seventh lens (307). Chromatic aberration occurring in plastic lenses can be corrected using plastic lenses. Additionally, when the sixth lens (306) and the seventh lens (307), which are consecutively disposed plastic lenses, satisfy a refractive index difference of 0.1 or more and 0.15 or less, and an Abbe number difference of 20 or more and 50 or less, the chromatic aberration occurring in the plastic lenses can be compensated by the plastic lenses.

Furthermore, among the plastic lenses, the eighth lens (308) has a positive refractive power, and the ninth lens (309) has a negative refractive power, according to conditions 1 and 2, the refractive index of the eighth lens (308) may be smaller than that of the ninth lens (309), and the dispersion value of the eighth lens (308) may be larger than that of the ninth lens (309). Chromatic aberration occurring in the plastic lenses can be corrected by the plastic lenses. Additionally, when the eighth lens (308) and the ninth lens (309), which are consecutively disposed plastic lenses, satisfy the conditions of a refractive index difference of 0.1 or more and 0.15 or less, and an Abbe number difference of 20 or more and 50 or less, the chromatic aberration occurring in the plastic lenses can be compensated for using the plastic lenses.

The shapes of the surfaces facing each other in two lenses with the effect of a composite lens may be similar. The difference in the absolute values of the curvature radii of the surfaces facing each other in two lenses with the effect of a composite lens may satisfy the range of 2 or more and 10 or less. The signs of the curvature radii of the surfaces facing each other in two lenses with the effect of a composite lens may be opposite. The product of the signs of the curvature radii of the opposing surfaces of two lenses with the effect of a bonded lens may be negative (−).

An optical system exhibits chromatic aberration, which is corrected using a composite lens or two lenses disposed in series. As the temperature changes from low to high, the lenses repeatedly contract and expand. Lenses made of the same material have the same degree of change in lens characteristics due to temperature changes, so correcting chromatic aberration between lenses of the same material is effective even when the temperature changes. Therefore, in the third embodiment of the present invention, the sixth lens (306) and the seventh lens (307), the eighth lens (308) and the ninth lens (309) can be used to correct chromatic aberration occurring in plastic lenses.

From the optical axis to the effective diameter area, the maximum distance between the two lenses with the largest Abbe number difference among the two adjacent lenses may be smaller than the maximum distance between other adjacent pairs of lenses. Here, the distance may refer to the distance between the two lenses from the optical axis to the effective diameter area. The two lenses with the largest Abbe number difference among the two adjacent lenses may be the sixth lens (306) and the seventh lens (307). The maximum value of the distance from the optical axis to the effective diameter area in a direction perpendicular to the optical axis, between the sensor side surface 12th surface (S12) of the sixth lens (306) and the object side surface 13th surface (S13) of the seventh lens (307), may be smaller than the maximum value of the distance between any two adjacent lenses. This allows the distance between two lenses made of difficult-to-bond plastic materials to be designed to be small, maximizing the Abbe number difference, thereby achieving the effect of reducing chromatic aberration to the same level as that of bonded lenses even when the lenses are not bonded.

When comparing focal lengths as absolute values, the focal length of the fifth lens (305) may be the longest among the lenses and may be 40 or more and 50 or less. The focal length of the eighth lens (308) may be the shortest among the lenses, and the absolute value of the focal length of the eighth lens (308) may be 10 or more and 11 or less.

The absolute value of each lens's focal length may satisfy any one of the following conditions.

|f5|,|f9|>|f1|>|f2|,|f3|,|f4|,|f6|,|f7|,|f8| Condition 1:

|f1|,|f3|,|f5|,|f9|>|f2|>|f4|,|f6|,|f7|,|f8| Condition 2:

|f1|,|f5|,|f9|>|f3|>|f2|,|f4|,|f6|,|f7|,|f8| Condition 3:

|f1|,|f2|,|f3|,|f5|,|f6|,|f8|,|f9|>|f4|>|f7| Condition 4:

|f5|>|f1|,|f2|,|f3|,|f4|,|f6|,|f7|,|f8|,|f9| Condition 5:

|f1|,|f2|,|f3|,|f5|,|f9|>|f6|>|f4|,|f7|,|f8| Condition 6:

|f1|,|f2|,|f3|,|f4|,|f5|,|f6|,|f8|,|f9|>|f7| Condition 7:

|f1|,|f2|,|f3|,|f5|,|f6|,|f9|>|f8|>|f4|,|f7| Condition 8:

|f5|>|f9|>|f1|,|f2|,|f3|,|f4|,|f6|,|f7|,|f8| Condition 9:

The thickness (T1) of the first lens (301) may be within a range of 2 to 2.5 times the difference between the maximum thickness and the minimum thickness, and the center thickness (CT1) may be the minimum, while the edge thickness (ET1) may be the maximum. The thickness (T2) of the second lens (302) may have a maximum thickness within the range of 1.5 to 2 times the minimum thickness. The second lens (302) may have a minimum center thickness (CT2) and a maximum edge thickness (ET2). The thickness (T3) of the third lens (303) may be maximum at the center and minimum at the edge, with the maximum thickness being within the range of 2 to 2.5 times the minimum thickness. The thickness (T4) of the fourth lens (304) may be maximum at the center and minimum at the edge, with the maximum thickness being within the range of 2 to 2.5 times the minimum thickness. The thickness (T5) of the fifth lens (305) may be maximum at the center and minimum at the edges, with the maximum thickness ranging from 1.1 to 1.5 times the minimum thickness. The thickness (T6) of the sixth lens (306) may be maximum at the center and minimum at the edges, with the maximum thickness ranging from 2 to 2.5 times the minimum thickness. The thickness (T7) of the seventh lens (307) may be minimum at the center and maximum at the edge, with the maximum thickness ranging from 2 to 2.5 times the minimum thickness. The thickness (T8) of the eighth lens (308) may be maximum at the center and minimum at the edge, with the maximum thickness ranging from 2 to 2.5 times the minimum thickness. The thickness (T9) of the ninth lens (309) may be minimum at the center and maximum at the edge, with the maximum thickness being within the range of 1.1 to 1.5 times the minimum thickness.

The thickness of each lens may satisfy any one of the following conditions.

0.1<CT1/ET1<0.5,2<ET1/CT1<2.5 Condition 1:

0.5<CT2/ET2<1,1.5<ET2/CT2<2 Condition 2:

2<CT3/ET3<2.5,0.1<ET3/CT3<0.5 Condition 3:

2<CT4/ET4<2.5,0.1<ET4/CT4<0.5 Condition 4:

1.5<CT5/ET5<2,0.5<ET5/CT5<1 Condition 5:

2<CT6/ET6<2.5,0.1<ET6/CT6<0.5 Condition 6:

0.1<CT7/ET7<0.5,2<ET7/CT7<2.5 Condition 7:

2<CT8/ET8<2.5,0.1<ET8/CT8<0.5 Condition 8:

2<CT9/ET9<2.5,0.1<ET9/CT9<0.5 Condition 9:

1<ΣCT/ΣET<1.2,0.5<ΣET/ΣCT<1 Condition 10:

Among the gaps (G1-G7) between the lenses, the first gap (G1) between the first and second lenses (301, 302) may have a maximum value at the center and a minimum value at the edge. The second gap (G2) between the second and third lenses (302, 303) may have a maximum value at the center and a minimum value at the edge. The third gap (G3) between the third and fourth lenses (303, 304) may have the maximum value at the edge and the minimum value at the center. The fourth gap (G4) between the fourth and fifth lenses (304, 305) may have the minimum value at the center and the maximum value at the edge. The fifth gap (G5) between the fifth and sixth lenses (305, 306) may have the center portion at its minimum and the edge portion at its maximum. The sixth gap (G6) between the sixth and seventh lenses (306, 307) may have the center portion at its maximum and the edge portion at its minimum. The seventh gap (G7) between the seventh and eighth lenses (307, 308) may have a maximum center and a minimum edge. The eighth gap (G8) between the eighth and ninth lenses (308, 309) may have a maximum center and a minimum edge.

FIGS. 30, 32, and 34 are graphs showing the diffraction MTF (modulation transfer function) at room temperature, low temperature, and high temperature in the optical system of FIG. 25, which represent the modulation as a function of spatial frequency.

As shown in FIGS. 30, 32, and 34, in the third embodiment of the invention, the deviation of the MTF between room temperature and low or high temperatures is less than 10%, i.e., 7% or less. FIGS. 31, 33, and 35 are graphs showing the aberration characteristics at room temperature, low temperature, and high temperature in the optical system of FIG. 25.

The aberration graphs in FIGS. 31, 33, and 35 show the measured values of spherical aberration (Longitudinal Spherical Aberration), astigmatic field curves (Astigmatic Field Curves), and distortion (Distortion) from left to right. In FIGS. 31, 33, and 35, the X-axis represents the focal length (mm) and distortion (%) and the Y-axis represents the image height (height). Additionally, the graph for spherical aberration corresponds to light in the wavelength bands of approximately 435 nm, 486 nm, 546 nm, 587 nm, and 656 nm, while the graphs for astigmatic field curves and distortion correspond to light in the wavelength band of approximately 546 nm. In the aberration diagrams of FIGS. 31, 33, and 35, the closer the curves for each temperature (room temperature, low temperature, and high temperature) approach the Y-axis, the better the aberration correction performance is interpreted. The optical system (1200) according to the third embodiment shows that the measured values are adjacent to the Y-axis in almost all regions.

In other words, the optical system (1000) according to the third embodiment has improved resolution and can provide good optical performance not only in the center of the field of view (FOV) but also in the peripheral region. Here, low temperature may refer to −20 °C or lower, for example, −20 °C to −40 °C, room temperature may refer to 22 °C±5 °C or 18 °C to 27 °C, and high temperature may refer to 85 °C or higher, for example, 85 °C to 105 °C. As shown in FIGS. 31, 33, and 35, it can be seen that the reduction in brightness modulation from low temperature to high temperature is less than 10%, for example, 5% or less, or remains almost unchanged. Table 9 compares the changes in optical characteristics such as EFL, BFL, F-number (F #), TTL, and field of view (FOV_D) in the optical system according to the third embodiment. It can be seen that the change rate of optical characteristics at low temperatures relative to room temperature is 5% or less, for example, 3% or less.

TABLE 9

| | | | | low | high |
|---|---|---|---|---|---|
| | Room | low | high | temperature/ | temperature/ |
| | temper- | temper- | temper- | room | Room |
| | ature | ature | ature | temperature | temperature |
| EFL(F) | 6.23 | 6.19 | 6.28 | 99.35% | 100.80% |
| BFL | 1.40 | 1.40 | 1.40 | 100.00% | 100.00% |
| F# | 1.64 | 1.63 | 1.65 | 99.39% | 100.60% |
| TTL | 30.00 | 29.93 | 30.09 | 99.76% | 100.3% |
| FOV_D | 98.74 | 99.35 | 98.00 | 100.61% | 99.25% |

Therefore, as shown in Table 9, it can be seen that the changes in optical characteristics due to temperature changes from low to high temperatures, such as the change rate of the effective focal length (EFL), TTL, BFL, F number, and field of view (FOV_D), are 10% or less, i.e., 5% or less, for example, within the range of 0 to 5%. This design allows for temperature compensation of the plastic lens, even when using one or more plastic lenses, thereby preventing a decrease in the reliability of optical characteristics.

The optical system disclosed in the third embodiment effectively controls aberration characteristics such as chromatic aberration and distortion aberration, and achieves good optical performance not only in the central part but also in the peripheral part of the field of view (FOV).

The optical system according to the fourth embodiment of the invention will now be described.

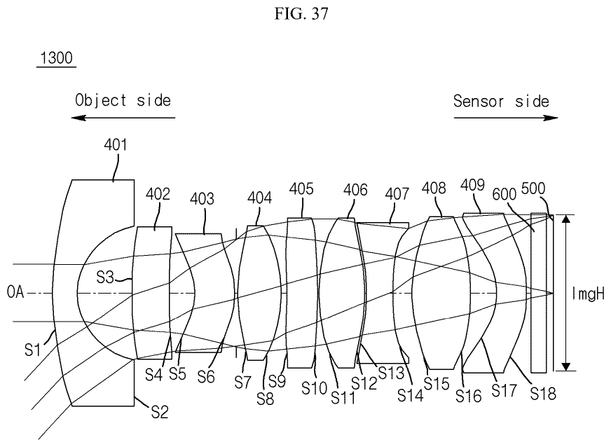

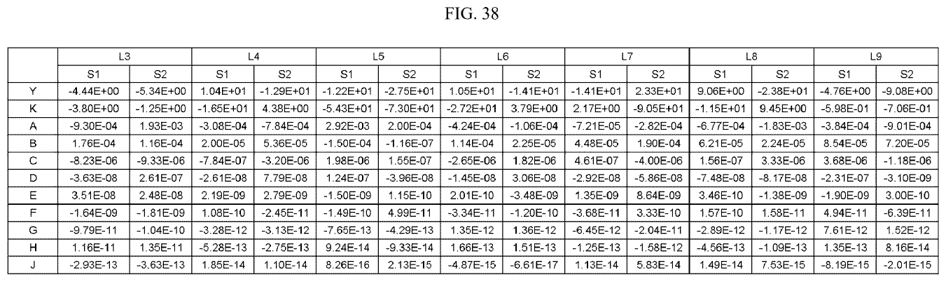

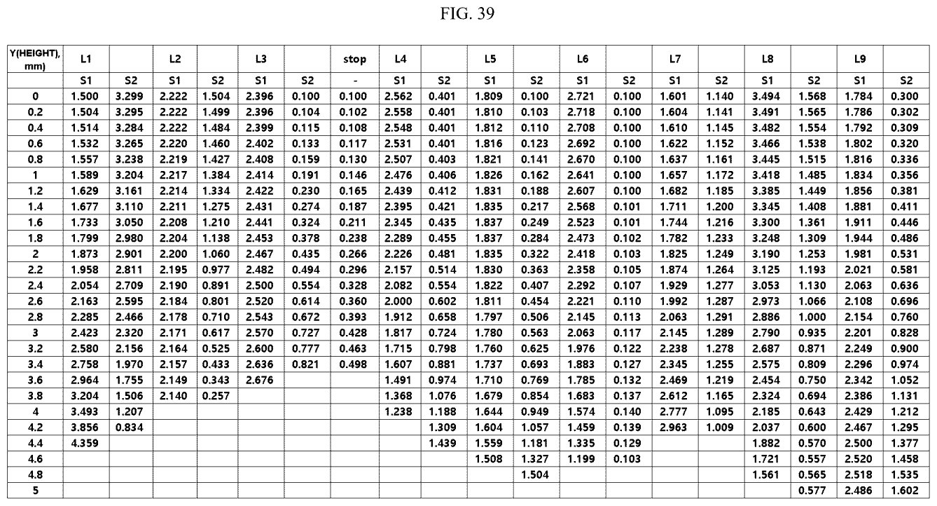

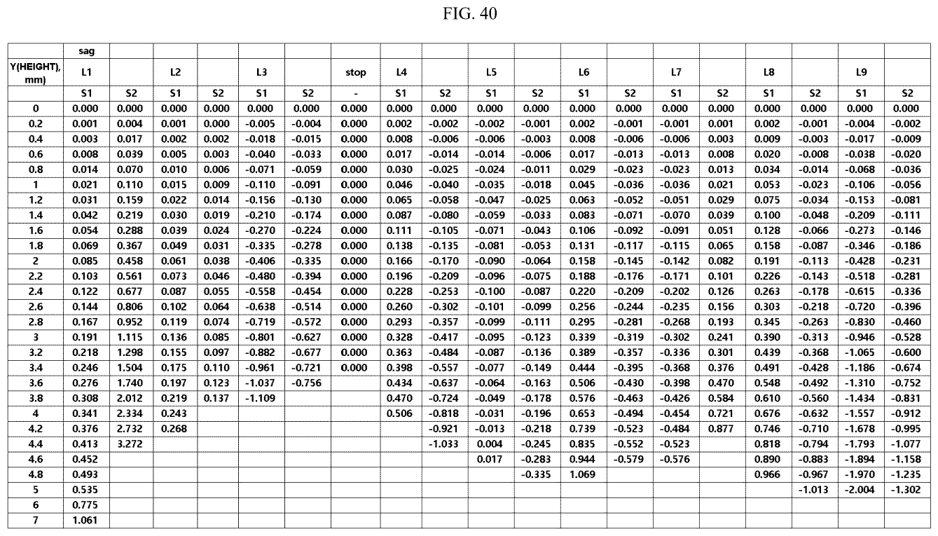

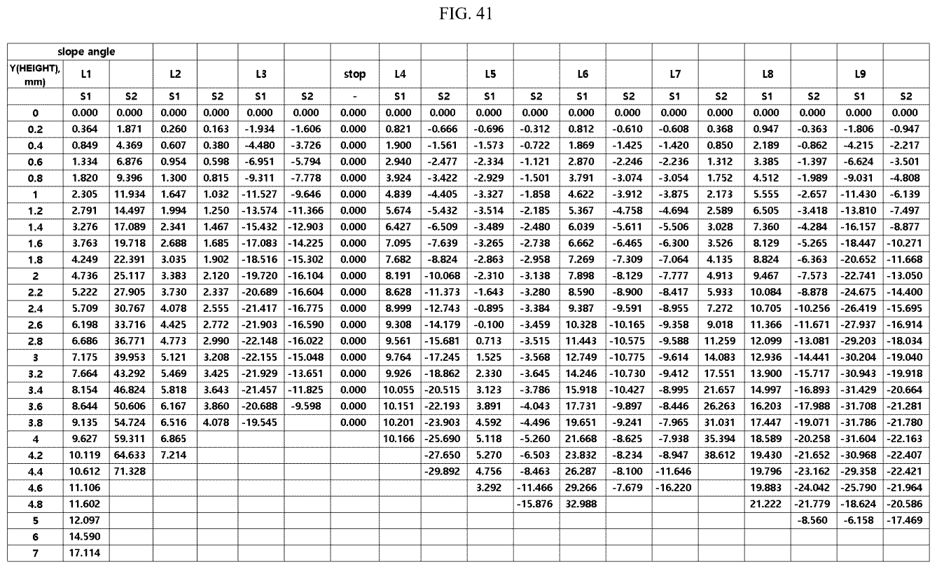

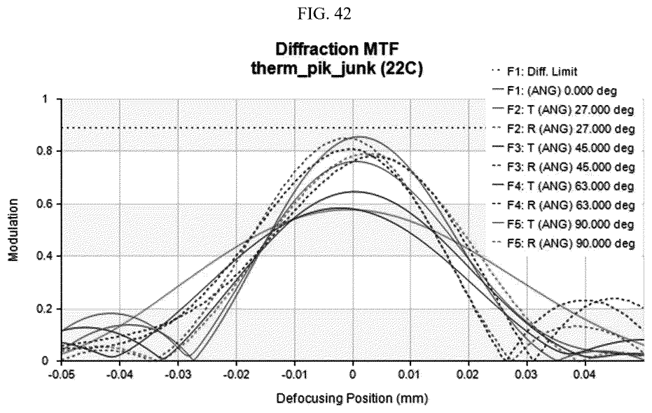

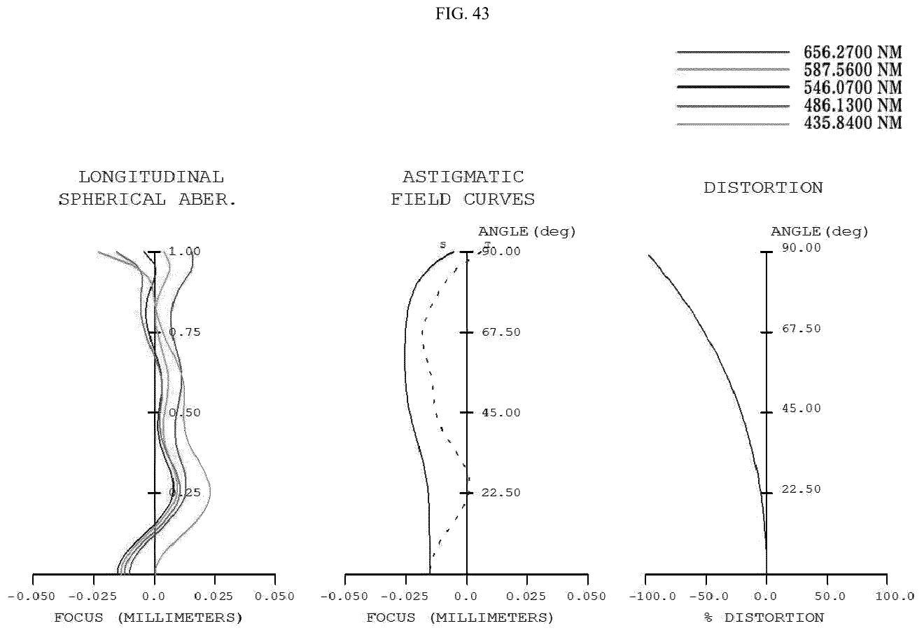

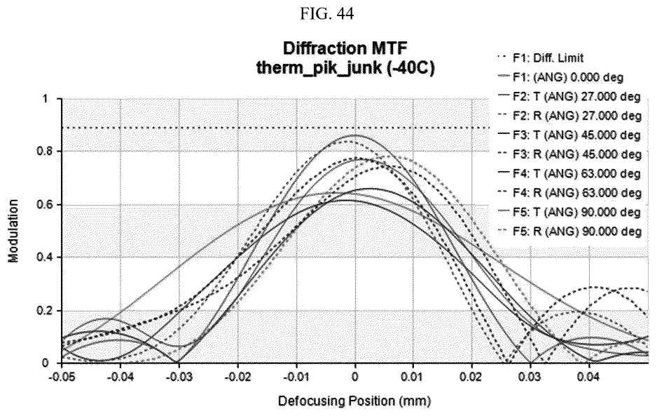

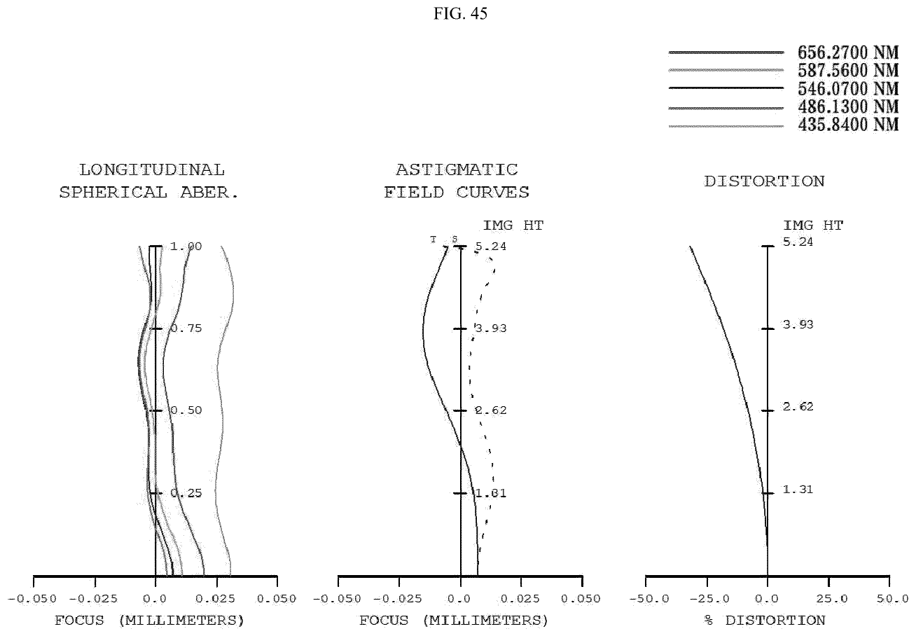

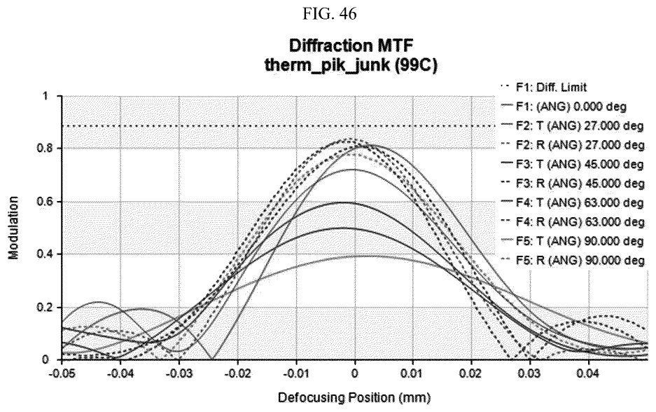

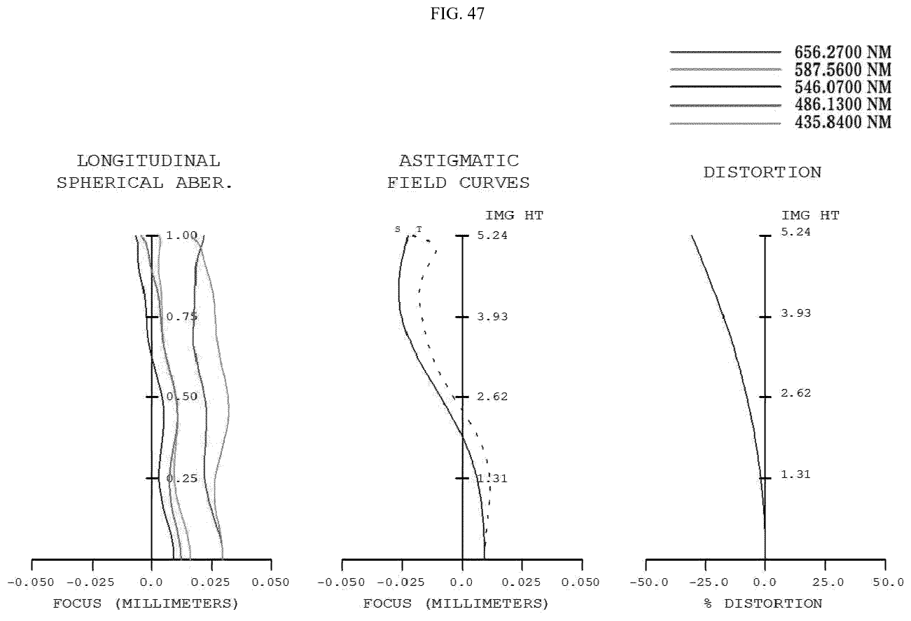

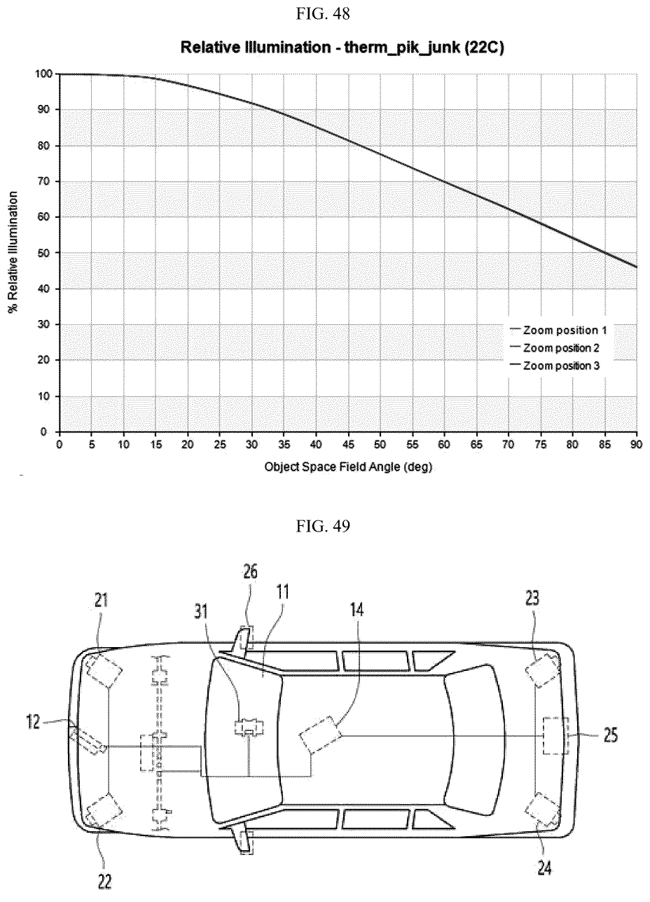

FIG. 37 is a cross-sectional view of the optical system and a camera module comprising the same according to a fourth embodiment, FIG. 38 is a table showing the aspheric coefficients of the lenses in the optical system of FIG. 37, FIG. 39 is a table showing the thickness of each lens and the gap (spacing) between adjacent lenses in the optical system of FIG. 37, FIG. 40 is a table showing the sag values of the lens surfaces of the first to ninth lenses in the optical system of FIG. 37, FIG. 41 is a table showing the slope angles of the lens surfaces of the first to ninth lenses in the optical system of FIG. 37, FIG. 42 is a graph showing data on the diffraction MTF (Modulation Transfer Function) at room temperature for the optical system of FIG. 37, FIG. 43 is a graph showing data on the aberration characteristics of the optical system in FIG. 37 at room temperature, FIG. 44 is a graph showing data on the diffraction MTF of the optical system in FIG. 37 at low temperatures, FIG. 45 is a graph showing data on the aberration characteristics of the optical system in FIG. 37 at low temperatures, FIG. 46 is a graph showing the diffraction MTF data at high temperatures for the optical system shown in FIG. 37, FIG. 47 is a graph showing the aberration characteristics data at high temperatures for the optical system shown in FIGS. 37, and FIG. 48 is a graph showing the peripheral light intensity ratio of the optical system shown in FIG. 37.

Referring to FIG. 37, the optical system (1300) may include a lens unit, which may include a first lens (401) to a ninth lens (409). The first to ninth lenses (401 to 409) may be disposed sequentially along the optical axis (OA) of the optical system (1300). Light corresponding to information of an object may pass through the first lens (401) to the ninth lens (409) and the filter (600) and enter the image sensor (500). The first lens (401) may be disposed closest to the object side. The first lens (401) may be disposed farthest from the sensor side. The first lens (401) may have a negative (−) refractive power along the optical axis (OA). The first lens (401) may include a plastic material or a glass material, for example, it may be made of glass. The first lens (401) made of glass material can reduce changes in the center position and curvature radius due to temperature changes caused by the surrounding environment, and can protect the incident side of the optical system (1300). Based on the optical axis, the object side first surface (S1) of the first lens (401) may be convex, and the sensor side second surface (S2) may be concave. The first lens (401) may have a convex meniscus shape on the object side. The first lens (401) may be made of glass and may have a spherical surface. At least one or both of the first surface (S1) and the second surface (S2) may be provided without any critical points from the optical axis (OA) to the end of the effective area. Due to the refractive characteristics of the first lens (401), the second lens (402) may be further spaced apart from the first lens (401). That is, the center gap between the first and second lenses (401, 402) may be the largest within the lens unit. The first lens (401) may have the greatest influence in the optical system (1300). The Abbe number (v1) of the first lens (401) may satisfy the condition v1>70 or v1>75. Since the refractive index (v1) of the first lens (401) is the largest within the lens unit, the first lens (401) may exhibit minimal dispersion and low chromatic aberration.

The second lens (402) may be disposed second from the object side. The second lens (402) may be disposed eighth from the sensor side. The second lens (402) may be disposed between the first lens (401) and the third lens (403). The second lens (402) may have a positive (+) refractive power on the optical axis (OA). The second lens (402) may include a plastic or glass material. For example, the second lens (402) may be provided in a glass material.

Based on the optical axis (OA), the object-side third surface (S3) of the second lens (402) may be convex, and the sensor-side fourth surface (S4) may be concave. The second lens (402) may have a convex meniscus shape on the object side. The second lens (402) may have a concave meniscus shape on the sensor side. The second lens (402) may be made of glass material and may be spherical. At least one or both of the third surface (S3) and the fourth surface (S4) may be provided without a critical point from the optical axis (OA) to the end of the effective area.

The third lens (403) may be disposed third from the object side. The third lens (403) may be disposed seventh from the sensor side. The third lens (403) may be disposed between the second lens (402) and the fourth lens (404). The third lens (403) may have a negative (−) refractive power on the optical axis (OA). The third lens (403) may include a plastic or glass material. For example, the third lens (403) may be provided in a plastic material.

Based on the optical axis, the object-side fifth surface (S5) of the third lens (403) may be concave, and the sensor-side sixth surface (S6) may be convex. The third lens (403) may have a convex meniscus shape toward the sensor side. The third lens (403) may have a concave meniscus shape toward the object side. The third lens (403) may be made of plastic material and may be aspherical. At least one or both of the fifth surface (S5) and the sixth surface (S6) may be aspherical. The asphericity coefficients of the fifth and sixth surfaces (S5, S6) may be provided as S5 and S6 of L3 in FIG. 38. At least one or both of the fifth surface (S5) and the sixth surface (S6) may be provided without a critical point from the optical axis (OA) to the end of the effective area.

The aperture (Stop) may be disposed around the sensor-side sixth surface (S6) of the third lens (403). The aperture (Stop) may be disposed around the object-side seventh surface (S7) of the fourth lens (404). The aperture can reduce the TTL within the field of view and enable the miniaturization of the optical system. As a result, this prevents a decrease in the weight-based yield (yield by weight) of the optical system and improves production efficiency. Additionally, the optical system can be miniaturized by reducing the TTL within a horizontal field of view (FOV_H) of 80 to 90 degrees.

The fourth lens (404) may be disposed fourth from the object side. The fourth lens (404) may be disposed sixth from the sensor side. The fourth lens (404) may be disposed between the third lens (403) and the fifth lens (405). The fourth lens (404) may have a positive (+) or negative (−) refractive power on the optical axis (OA). The fourth lens (404) may have a positive (+) refractive power. The fourth lens (404) may include a plastic or glass material. For example, the fourth lens (404) may be provided in a glass material.

Based on the optical axis, the object-side seventh surface (S7) of the fourth lens (404) may be convex, and the sensor-side eighth surface (S8) may be convex. The fourth lens (404) may have a shape where both surfaces are convex. The fourth lens (404) may be made of glass material and may be aspherical. The fourth lens (304) may be made of glass material and may be aspherical. At least one or both of the seventh surface (S7) and the eighth surface (S8) may be aspherical. The asphericity coefficients of the seventh and eighth surfaces (S7, S8) may be provided as S1 and S2 of L4 in FIG. 37. At least one or both of the seventh surface (S7) and the eighth surface (S8) may be provided without a critical point from the optical axis (OA) to the end of the effective area.

The fifth lens (405) may be disposed as the fifth lens from the object side. The fifth lens (405) may be disposed as the fifth lens from the sensor side. The fifth lens (405) may be disposed between the fourth lens (404) and the sixth lens (406). The fifth lens (405) may have a positive (+) or negative (−) refractive power relative to the optical axis (OA). The fifth lens (405) may have a negative (−) refractive power. The fifth lens (405) may include a plastic or glass material. For example, the fifth lens (405) may be provided in a plastic material.

With respect to the optical axis (OA), the fifth lens (405) may have a concave object side ninth surface (S9) and a convex sensor side tenth surface (S10). The fifth lens (405) may have a convex meniscus shape on the sensor side. The fifth lens (405) may have a concave meniscus shape on the object side. The fifth lens (405) may be made of plastic material and may be aspherical. At least one or both of the ninth surface (S9) and the tenth surface (S10) may be aspherical. The asphericity coefficient of the ninth and tenth surfaces (S9, S10) may be provided as S1 and S2 of L5 in FIG. 38.

The ninth surface (S9) of the fifth lens (405) may include a critical point extending from the optical axis (OA) to the end of the effective area. If the ninth surface (S9) has a critical point, it may be located within the range of 50% to 60%, preferably 54% to 58%, of the effective radius (r51) from the optical axis (OA). The critical point of the ninth surface (S9) may be located within a range of 2.5 mm to 3 mm from the optical axis (OA), preferably within a range of 2.6 mm to 2.7 mm. The tenth surface (S10) of the fifth lens (405) may be provided without a critical point from the optical axis (OA) to the end of the effective area.

The sixth lens (406) may be disposed as the sixth lens from the object side. The sixth lens (406) may be disposed as the fourth lens from the sensor side. The sixth lens (406) may be disposed between the fifth lens (405) and the seventh lens (407). The sixth lens (406) may have a positive (+) or negative (−) refractive power relative to the optical axis (OA). The sixth lens (406) may have a positive (+) refractive power. The sixth lens (406) may include a plastic or glass material. For example, the sixth lens (406) may be provided in a plastic material.

With respect to the optical axis (OA), the sixth lens (406) may have a convex object side 11th surface (S11) and a convex sensor side 12th surface (S12). The sixth lens (406) may have a shape with both surfaces being convex. The sixth lens (406) may be made of plastic material and may be aspherical. At least one or both of the eleventh surface (S11) and twelfth surface (S12) may be aspherical. The asphericity coefficient of the eleventh and twelfth surfaces (S11, S12) may be provided as S1 and S2 of L6 in FIG. 38. At least one or both of the 11th surface (S11) and the 12th surface (S12) may be provided without a critical point from the optical axis (OA) to the end of the effective area.

The seventh lens (407) may be disposed seventh from the object side. The seventh lens (407) may be disposed third from the sensor side. The seventh lens (407) may be disposed between the sixth lens (406) and the eighth lens (408). The 7th lens (407) may have a positive (+) or negative (−) refractive power relative to the optical axis (OA). The 7th lens (407) may have a negative (−) refractive power. The 7th lens (407) may include a plastic or glass material. For example, the 7th lens (407) may be provided in a plastic material.

With respect to the optical axis (OA), the seventh lens (407) may have a concave object side 13th surface (S13) and a concave sensor side 14th surface (S14). The seventh lens (407) may have a concave shape on both sides. The seventh lens (407) may be made of plastic material and may be aspherical. At least one or both of the 13th surface (S13) and the 14th surface (S14) may be aspherical. The asphericity coefficient of the 13th and 14th surfaces (S13, S14) may be provided as S1 and S2 of L7 in FIG. 38. At least one or both of the 13th surface (S13) and the 14th surface (S14) may be provided without a critical point from the optical axis (OA) to the end of the effective area.

The eighth lens (408) may be disposed eighth from the object side. The eighth lens (408) may be disposed second from the sensor side. The eighth lens (408) may be disposed between the sixth lens (406) and the ninth lens (409). The 8th lens (408) may have a positive (+) or negative (−) refractive power along the optical axis (OA). The 8th lens (408) may have a positive (+) refractive power. The 8th lens (408) may include a plastic or glass material. For example, the 8th lens (408) may be provided in a plastic material.

With respect to the optical axis (OA), the eighth lens (408) may have a convex object side 15th surface (S15) and a convex sensor side 16th surface (S16). The eighth lens (408) may have a shape with both surfaces being convex. The eighth lens (408) may be made of plastic material and may be aspherical. At least one or both of the 15th surface (S15) and the 16th surface (S16) may be aspherical. The asphericity coefficient of the 15th and 16th surfaces (S15, S16) may be provided as S1 and S2 of L8 in FIG. 38. At least one or both of the 15th surface (S15) and the 16th surface (S16) may be provided without a critical point from the optical axis (OA) to the end of the effective area.

The ninth lens (409) may be disposed farthest from the object. The ninth lens (409) may be disposed closest to the image sensor (500). The ninth lens (409) may have a positive (+) or negative (−) refractive power on the optical axis (OA). The ninth lens (409) may have a negative (−) refractive power. The ninth lens (409) may include a plastic or glass material. For example, the ninth lens (409) may be provided in a plastic material.

With respect to the optical axis (OA), the ninth lens (409) may have a concave object side 17th surface (S17) and a convex sensor side 18th surface (S18). The ninth lens (409) may have a convex meniscus shape on the sensor side. The ninth lens (409) may have a concave meniscus shape on the object side. At least one or both of the 17th surface (S17) and the 18th surface (S18) may be aspherical. The asphericity coefficients of the 17th and 18th surfaces (S17, S18) may be provided as S17 and S18 of L9 in FIG. 38. At least one or both of the 17th surface (S17) and the 18th surface (S18) may be provided without a critical point from the optical axis (OA) to the end of the effective area.

The 9th lens (409) may be the plastic lens closest to the image sensor (500). Additionally, by arranging two or more plastic lenses adjacent to the image sensor (500), aberrations such as spherical aberration and chromatic aberration can be improved, and resolution can be controlled. Furthermore, by arranging a plastic lens adjacent to the image sensor (500), it is possible to be insensitive to assembly tolerances compared to glass lenses. In other words, being insensitive to assembly tolerances means that even if the assembly differs slightly from the design during assembly, it may not significantly affect optical performance. Furthermore, by providing the two lenses (408, 409) adjacent to the image sensor (500) in a plastic material, the optical performance can be improved by the aspherical lens surfaces, for example, by improving aberration characteristics and preventing resolution degradation.

TABLE 10

| | | | | | | Semi | Focal |
|---|---|---|---|---|---|---|---|
| Lens | Surface | Radius | Thickness | nd | vd | Aperture | length |
| 1 | S1 | 23.620 | 1.500 | 1.4985 | 81.6072 | 7.459 | −11.7512 |
| | S2 | 4.594 | 3.299 | | | 4.429 | |
| 2 | S3 | 33.048 | 2.222 | 1.7617 | 27.5298 | 4.370 | 110.8500 |
| | S4 | 52.724 | 1.504 | | | 3.949 | |
| 3 | S5 | −4.437 | 2.396 | 1.5371 | 55.7074 | 3.882 | −642.6780 |
| | S6 | −5.343 | 0.100 | | | 3.705 | |
| | STOP | — | 0.100 | | | 3.521 | |
| 4 | S7 | 10.444 | 2.562 | 1.5948 | 66.9714 | 4.100 | 10.1267 |
| | S8 | −12.930 | 0.401 | | | 4.425 | |
| 5 | S9 | −12.244 | 1.809 | 1.5371 | 55.7074 | 4.728 | −42.8335 |
| | S10 | −27.527 | 0.100 | | | 4.906 | |
| 6 | S11 | 10.546 | 2.721 | 1.5371 | 55.7074 | 4.911 | 11.6840 |
| | S12 | −14.099 | 0.100 | | | 4.672 | |
| 7 | S13 | −14.136 | 1.601 | 1.6679 | 20.3792 | 4.621 | −12.9499 |
| | S14 | 23.295 | 1.140 | | | 4.268 | |
| 8 | S15 | 9.056 | 3.494 | 1.5371 | 55.7074 | 4.843 | 12.6859 |
| | S16 | −23.807 | 1.568 | | | 5.002 | |
| 9 | S17 | −4.758 | 1.784 | 1.6679 | 20.3792 | 5.108 | −17.9312 |
| | S18 | −9.080 | 0.300 | | | 5.230 | |
| Cover | | infinity | 0.900 | | | | |
| | | | 0.400 | | | | |
| Image | | infinity | 0.000 | | | | |

Table 10 shows the surface number (Surface), curvature radius (Radius), center thickness of each lens or distance between lens surfaces (Thickness), refractive index (Index, nd), Abbe number (Abbe, vd), effective radius (Semi Aperture), and focal length (Focal length) of the lens according to the fourth embodiment of the present invention. Here, the units for curvature radius and thickness or distance may be mm.

TABLE 11

| items | values | items | values |
|---|---|---|---|
| F | 6.2300 | F-number | 1.6400 |
| ET1 | 3.6674 | FOV_H | 83.0 |
| ET2 | 2.0797 | EPD | 3.7988 |
| ET3 | 2.7598 | BFL | 1.6000 |
| ET4 | 1.0142 | TD | 28.4000 |
| ET5 | 1.4223 | ImgH | 5.1450 |
| ET6 | 1.0011 | SD | 17.3797 |
| ET7 | 3.0968 | TTL | 30.0000 |
| ET8 | 1.5000 | GLca_Aver | 10.206 |
| ET9 | 2.4323 | PLca_Aver | 9.171 |
| ΣIndex | 14.3391 | CT_max | 3.4938 |
| ΣAbbe | 439.6964 | CT_min | 1.5000 |
| ΣCT | 20.0893 | CT_Aver | 2.2321 |
| ΣCG | 8.3107 | F_LG1 | −15.212 |
| CA_max | 14.919 | F_LG2 | 8.497 |
| CA_min | 7.043 | | |
| CA_Aver | 9.277 | | |

Table 11 shows the values of the items in the mathematical equations described above for the optical system (1300) of the embodiment. The optical system (1300) relates to the total track length (TTL) (mm), back focal length (BFL), effective focal length (F) (mm), image height (ImgH) (mm), effective diameter (CA) (mm), thickness (mm), TTL (mm), the optical axis distance TD (mm) from the first surface (S1) to the 18th surface (S18), the sum of refractive indices, the sum of Abbe numbers, the sum of thicknesses (mm), the sum of distances between adjacent lenses, the effective diameter characteristics, the sum of refractive indices of glass lenses, the sum of refractive indices of plastic materials, the field of view (FOV_H) (degrees), edge thickness (ET), F-number, etc.

The center thickness of the first to ninth lenses (301 to 309) is indicated as CT1 to CT9, the edge thickness at the end of the effective area of each lens is indicated as ET1 to ET9, the center gap between adjacent lenses is indicated as CG1 to CG8, and the edge gap between the edges of each lens is denoted as EG1 to EG8. BFL (Back focal length) is the optical axis distance from the image sensor (500) to the center of the last lens. TTL is the optical axis distance from the center of the first surface (S1) of the first lens (301) to the image surface of the image sensor (500).

As shown in FIG. 38, the lens surfaces of the second, third, fourth, fifth, sixth, seventh, eighth, and ninth lenses (402, 403, 404, 405, 406, 407, 408, 409) among the lenses of the lens unit in the fourth embodiment may include aspherical surfaces having a 30th-order asphericity coefficient. For example, the second, third, fourth, fifth, sixth, seventh, eighth, and ninth lenses (402, 403, 404, 405, 406, 407, 408, 409) may include lens surfaces having a 30th-order aspheric coefficient. As described above, aspherical surfaces with a 30th-order asphericity coefficient (a non-zero numerical value) can significantly alter the aspheric shape in the peripheral region, thereby effectively correcting the optical performance in the peripheral region of the field of view (FOV).

The thickness (T1-T9) of the first to ninth lenses (401-409) and the gap (G1-G8) between adjacent lenses may be set. As shown in FIG. 3, the thickness (T1-T9) of each lens in the Y-axis direction may be represented at gaps of 0.1 mm or 0.2 mm or more, and the gap (G1-G8) between each lens may be represented at gaps of 0.1 mm or 0.2 mm or more.

When comparing the absolute values of the curvature radii of each lens, the curvature radius of the fourth surface (S4) of the second lens (402) relative to the optical axis (OA) may be the largest among the lenses, and the curvature radius of the seventeenth surface (S17) of the ninth lens (409) may be the smallest among the lenses. The difference between the maximum and minimum curvature radii may be 10 times or more, for example, within the range of 10 to 15 times.

Since the effective diameter of a plastic lens is smaller than that of a glass lens, the lens disposed on the object side of a plastic lens may have a stronger refractive power to refract light through the plastic lens. Additionally, to increase the refractive power, the curvature radius of the lens surface may be smaller.

The lens surface facing the aperture (STOP) may be formed gently. The absolute value of the curvature radius of the lens surface facing the aperture (STOP) may be 10 or more. The curvature radius of the object side surface 7th surface (S7)) of the fourth lens (404) adjacent to the aperture (STOP) may satisfy the range of 10 or more and 20 or less. The lens adjacent to the aperture (STOP) affects the optical performance of the entire optical system, so the tilt caused by assembly tolerances must be minimized.

The absolute value of the curvature radius of the first surface (S1) of the first lens (401) may be greater than the absolute value of the curvature radius of the second surface (S2). The absolute value of the curvature radius of the third surface (S3) of the second lens (402) may be less than the absolute value of the curvature radius of the fourth surface (S4). The absolute value of the curvature radius of the fifth surface (S5) of the third lens (403) may be smaller than the absolute value of the curvature radius of the sixth surface (S6). The absolute value of the curvature radius of the seventh surface (S7) of the fourth lens (404) may be smaller than the absolute value of the curvature radius of the eighth surface (S8). The absolute value of the curvature radius of the ninth surface (S9) of the fifth lens (405) may be smaller than the absolute value of the curvature radius of the tenth surface (S10). The absolute value of the curvature radius of the eleventh surface (S11) of the sixth lens (406) may be smaller than the absolute value of the curvature radius of the twelfth surface (S12). The absolute value of the curvature radius of the 13th surface (S13) of the 7th lens (407) may be smaller than the absolute value of the curvature radius of the 14th surface (S14). The absolute value of the curvature radius of the 15th surface (S15) of the 8th lens (408) may be smaller than the absolute value of the curvature radius of the 16th surface (S16). The absolute value of the curvature radius of the 17th surface (S17) of the 9th lens (409) may be smaller than the absolute value of the curvature radius of the 18th surface (S18).

The ratio of the curvature radii of each lens may satisfy the following conditions.

5<L1R1/L1R2|<6 Condition 1:

0.5<|L2R1/L2R2|<1 Condition 2:

0.5<|L3R1/L3R2|<1 Condition 3:

0.5<|L4R1/L4R2|<1 Condition 4:

0.1<|L5R1/L5R2|<0.5 Condition 5:

0.5<|L6R1/L6R2|<1 Condition 6:

0.5<|L7R1/L7R2|<1 Condition 7:

0.1<|L8R1/L8R2|<0.5 Condition 8:

0.5<L9R1/L9R2<1 Condition 9:

When describing the center thickness (CT) of the lenses based on the optical axis, the center thickness (CT8) of the eighth lens (408) may be the greatest among the lenses, and the center thickness (CT1) of the first lens (401) may be the smallest among the lenses. The difference between the greatest center thickness and the smallest center thickness of the lenses may be in the range of 2 mm or more and 2.5 mm or less.

The center thickness of each lens may satisfy any one of the following conditions.

CT2,CT3,CT4,CT5,CT6,CT7,CT8,CT9>CT1 Condition 1:

CT3,CT4,CT6,CT8>CT2>CT1,CT5,CT7,CT9 Condition 2:

CT4,CT6,CT8>CT3>CT1,CT2,CT5,CT7,CT9 Condition 3:

CT6,CT8>CT4>CT1,CT2,CT3,CT5,CT7,CT9 Condition 4:

CT2,CT3,CT4,CT6,CT8>CT5>CT1,CT7,CT9 Condition 5:

CT8>CT6>CT1,CT2,CT3,CT4,CT5,CT7,CT9 Condition 6:

CT2,CT3,CT4,CT5,CT6,CT8,CT9>CT7>CT1 Condition 7:

CT8>CT1,CT2,CT3,CT4,CT5,CT6,CT7,CT9 Condition 8:

CT2,CT3,CT4,CT5,CT6,CT8>CT9>CT1,CT7 Condition 9:

The center gap (CG) between the lenses may be defined as follows: the center gap (CG1) between the first lens (401) and the second lens (402) may be the maximum, and at least one of the center gap (CG5) between the fifth and sixth lenses (405, 406) and the center gap (CG6) between the sixth and seventh lenses (406, 407) may be the minimum. The difference between the maximum center gap and the minimum center gap among the separated lens gaps may be 5 mm or more, for example, within the range of 5 mm to 7 mm.

The center gaps between each lens may satisfy the following conditions.

CG1>CG2,CG3,CG4,CG5,CG6,CG7,CG8 Condition 1:

CG1,CG8>CG2>CG3,CT4,CT5,CG6,CT7 Condition 2:

CG1,CG2,CG4,CG7,CG8>CG3>CG5,CG6 Condition 3:

CG1,CG8>CG4>CG2,CG3,CG5,CG6,CG7 Condition 4:

CG1,CG2,CG3,CG4,CG7,CG8>CG5=CT6 Condition 5:

CG1,CG2,CG8>CG7>CG3,CG4,CG5,CG6 Condition 6:

CG1>CG8>CG2,CG3,CG4,CG5,CG6,CG7 Condition 7:

CG1>CG8>CG2,CG3,CG4,CG5,CG6,CG7 Condition 8:

Regarding the effective diameter, a lens with the maximum effective diameter may be a lens made of glass material. The lens with the maximum effective diameter may be the first lens (401). Here, the effective diameter is an average of the effective diameter on the object side and the effective diameter on the sensor side of each lens. The lens surface with the maximum effective diameter may be the first surface (S1) of the first lens (401). The lens with the minimum effective diameter may be the third lens (403). The lens surface with the minimum effective diameter may be the sixth surface (S6) of the third lens (403). The effective diameter of a plastic lens may be smaller than that of a glass lens. A plastic lens may be disposed adjacent to the image sensor.

The effective diameter of each lens may satisfy any one of the following conditions.

CA_L1>CA_L2,CA_L3,CA_L4,CA_L5,CA_L6,CA_L7,CA_L8,CA_L9 Condition 1:

CA_L1,CA_L3,CA_L4,CA_L5,CA_L6,CA_L7,CA_L8,CA_L9>CA_L2 Condition 2:

CA_L1,CA_L4,CA_L5,CA_L6,CA_L7,CA_L8,CA_L9>CA_L3>CA_L2 Condition 3:

CA_L1,CA_L5,CA_L6,CA_L7,CA_L8,CA_L9>CA_L4>CA_L2,CA_L3 Condition 4:

CA_L1,CA_L6,CA_L9>CA_L5>CA_L2,CA_L3,CA_L4,CA_L7,CA_L8 Condition 5:

CA_L1,CA_L5,CA_L8,CA_L9>CA_L6>CA_L2,CA_L3,CA_L4,CA_L7 Condition 6:

CA_L1,CA_L5,CA_L6,CA_L8,CA_L9>CA_L7>CA_L2,CA_L3,CA_L4 Condition 7:

CA_L1,CA_L9>CA_L8>CA_L2,CA_L3,CA_L4,CA_L5,CA_L6,CA_L7 Condition 8:

CA_L1>CA_L9>CA_L2,CA_L3,CA_L4,CA_L5,CA_L6,CA_L7,CA_L8 Condition 9:

Explaining the refractive index, the refractive index of the second lens (402) may be the highest among the lenses and may exceed 1.7, for example, 1.72. The refractive index of the lens disposed on the sensor side of the aperture (STOP) may be the highest among the lenses. The refractive index of the first lens (401) may be the lowest among the lenses, less than 1.55, for example, less than 1.54. The difference between the maximum and minimum refractive indices may be 0.2 or more. By providing a low refractive index lens made of glass material closest to the object and a high refractive index lens made of glass material adjacent to the aperture (STOP), the incident efficiency can be increased, and the refractive power between the glass material and plastic material lenses can be controlled to guide the light to the image sensor (500).

The refractive index of each lens may satisfy any one of the following conditions.

n2,n3,n4,n5,n6,n7,n8,n9>n1 Condition 1:

n2>n1,n3,n4,n5,n6,n7,n8,n9 Condition 2:

n2,n4,n7,n9>n3=n5=n6=n8>n1 Condition 3:

n2,n7,n9>n4>n1,n3,n5,n6,n8 Condition 4:

n2>n7=n9>n1,n4,n3,n5,n6,n8 Condition 5:

When comparing the Abbe numbers, the Abbe number of the first lens (401) may be the largest among the lenses and may be 70 or higher. The Abbe number of at least one of the seventh lens (407) and the ninth lens (409) may be the smallest among the lenses and may be 25 or lower. The difference between the maximum refractive index and the minimum Abbe number may be 50 or higher. By maximizing the Abbe number of the first lens (401) disposed closest to the object side of the optical system (1200), color dispersion and chromatic aberration can be minimized. By providing the smallest Abbe number for the ninth lens (409) closest to the image sensor (500), the color dispersion of light passing between glass and plastic lenses can be controlled, and the color dispersion between glass and plastic lenses can be increased to guide the light to the image sensor (500).

The Abbe number of each lens may satisfy any one of the following conditions.

v1>v2,v3,v4,v5,v6,v7,v8,v9 Condition 1:

v1,v3,v4,v5,v6,v8>v2>v7,v9 Condition 2:

v1,v4>v3=v5=v6=v8>v2,v7,v9 Condition 3:

v1>v4>v2,v3,v5,v6,v7,v8,v9 Condition 4:

v1,v2,v3,v4,v5,v6,v8>v7=v9 Condition 5:

The focal lengths (F1, F3, F5, F7, F9) of lenses 1, 3, 5, 7, and 9 (401, 403, 405, 407, 409) may have a negative (−) sign. Lenses 1, 3, 5, 7, and 9 (401, 403, 405, 407, 409) may have negative (−) refractive power. The focal lengths (F2, F4, F6, F8) of lenses 2, 4, 6, and 8 (402, 404, 406, 408) may have positive (+) signs. The second, fourth, sixth, and eighth lenses (402, 404, 406, 408) may have positive (+) refractive power. The second lens (402) with positive (+) refractive power may be disposed on the sensor side of the first lens (401) with negative (−) refractive power. Through this, light incident from the object side can move away from the optical axis direction and then converge again toward the optical axis direction, thereby forming a stable optical path.

Additionally, the adjacent lenses, i.e., the sixth lens (406) and the seventh lens (407), and the eighth lens (408) and the ninth lens (409), may satisfy the following conditions.

Refractive index of a lens with positive refractive power<Refractive index of a lens with negative refractive power Condition 1:

Dispersion value of a lens with positive refractive power>Dispersion value of a lens with negative refractive power Condition 2:

Here, among the plastic lenses, the sixth lens (406) has positive refractive power, and the seventh lens (407) has negative refractive power. According to conditions 1 and 2, the refractive index of the sixth lens (406) may be smaller than that of the seventh lens (407), and the dispersion value of the sixth lens (406) may be greater than that of the seventh lens (407). Chromatic aberration occurring in plastic lenses can be corrected using plastic lenses. Additionally, when the sixth lens (406) and the seventh lens (407), which are consecutively disposed plastic lenses, satisfy a refractive index difference of 0.1 or more and 0.15 or less, and an Abbe number difference of 20 or more and 50 or less, the chromatic aberration occurring in the plastic lenses can be compensated by the plastic lenses.

Furthermore, among the plastic lenses, the eighth lens (408) has a positive refractive power, and the ninth lens (409) has a negative refractive power, such that according to conditions 1 and 2, the refractive index of the eighth lens (408) may be smaller than that of the ninth lens (409), and the dispersion value of the eighth lens (408) may be larger than that of the ninth lens (409). Chromatic aberration occurring in the plastic lenses can be corrected by the plastic lenses. Additionally, when the eighth lens (408) and the ninth lens (409), which are consecutively disposed plastic lenses, satisfy the conditions of a refractive index difference of 0.1 or more and 0.15 or less, and an Abbe number difference of 20 or more and 50 or less, the chromatic aberration occurring in the plastic lenses can be compensated for using the plastic lenses.

The shapes of the surfaces facing each other in two lenses with the effect of a composite lens may be similar. The difference in the absolute values of the curvature radii of the surfaces facing each other in two lenses with the effect of a composite lens may satisfy the range of 2 or more and 10 or less. The signs of the curvature radii of the surfaces facing each other in two lenses with the effect of a composite lens may be opposite. The product of the signs of the curvature radii of the opposing surfaces of two lenses with the effect of a composite lens may be negative (−).

An optical system exhibits chromatic aberration, which is corrected using a composite lens or two lenses disposed in series. As the temperature changes from low to high, the lenses repeatedly contract and expand. Lenses made of the same material have the same degree of change in lens characteristics due to temperature changes, so correcting chromatic aberration between lenses of the same material is effective even when the temperature changes. Therefore, in the fourth embodiment of the present invention, the sixth lens (406) and the seventh lens (407), and the eighth lens (408) and the ninth lens (409) can be used to correct chromatic aberration occurring in plastic lenses.

The maximum value of the distance between the two lenses with the largest Abbe number difference among the two adjacent lenses arranged between the optical axis and the effective diameter area may be smaller than the maximum value of the distance between other adjacent pairs of lenses. Here, the distance may refer to the distance between the two lenses from the optical axis to the effective diameter area. The two lenses with the largest Abbe number difference among the two adjacent lenses may be the sixth lens (406) and the seventh lens (407). The maximum value of the distance from the optical axis to the effective diameter area in a direction perpendicular to the optical axis, between the sensor side surface 12th surface (S12) of the sixth lens (406) and the object side surface 13th surface (S13) of the seventh lens (407), may be smaller than the maximum value of the distance between any two adjacent lenses. This allows the distance between two lenses made of difficult-to-bond plastic materials to be designed to be small, maximizing the Abbe number difference, thereby achieving the effect of reducing chromatic aberration to the same level as that of bonded lenses even when the lenses are not bonded.

When comparing focal lengths as absolute values, the focal length of the fifth lens (405) may be the longest among the lenses and may be 40 or more and 50 or less. The focal length of the eighth lens (408) may be the shortest among the lenses, and the absolute value of the focal length of the eighth lens (408) may be 10 or more and 11 or less.

The absolute value of the focal length of each lens may satisfy any one of the following conditions.

|f2|,|f3|,|f5|,|f7|,|f8|,|f9|>|f1|>|f4|,|f6| Condition 1:

|f3|>|f2|>|f1|,|f4|,|f5|,|f6|,|f7|,|f8|,|f9| Condition 2:

|f3|>|f1|,|f2|,|f4|,|f5|,|f6|,|f7|,|f8|,|f9| Condition 3:

|f1|,|f2|,|f3|,|f5|,|f6|,|f7|,|f8|,|f9|>|f4| Condition 4:

|f2|,|f3|>|f5|>|f1|,|f4|,|f6|,|f7|,|f8|,|f9| Condition 5:

|f1|,|f2|,|f3|,|f5|,|f7|,|f8|,|f9|>|f6|>|f4| Condition 6:

|f2|,|f3|,|f5|,|f9|>|f7|>|f1|,|f4|,|f6|,|f8| Condition 7:

|f2|,|f3|,|f5|,|f7|,|f9|>|f8|>|f1|,|f4|,|f6| Condition 8:

|f2|,|f3|,|f5|>|f9|>|f1|,|f4|,|f6|,|f7|,|f8| Condition 9:

The thickness (T1) of the first lens (401) may be within a range of 2 to 2.5 times the difference between the maximum thickness and the minimum thickness, and the center thickness (CT1) may be the minimum, while the edge thickness (ET1) may be the maximum. The thickness (T2) of the second lens (402) may have a maximum thickness within the range of 1 to 1.5 times the minimum thickness. The second lens (402) may have the maximum thickness at the center (CT2) and the minimum thickness at the edge (ET2). The thickness (T3) of the third lens (403) may be minimum at the center and maximum at the edge, with the maximum thickness being within the range of 1 to 1.5 times the minimum thickness. The thickness (T4) of the fourth lens (404) may be maximum at the center and minimum at the edge, with the maximum thickness being within the range of 2.5 to 3 times the minimum thickness. The thickness (T5) of the fifth lens (405) may be maximum at the center and minimum at the edge, with the maximum thickness ranging from 1.1 to 1.5 times the minimum thickness. The thickness (T6) of the sixth lens (406) may be maximum at the center and minimum at the edge, with the maximum thickness ranging from 2.5 to 3 times the minimum thickness. The thickness (T7) of the seventh lens (407) may be minimum at the center and maximum at the edge, with the maximum thickness ranging from 1.5 to 2 times the minimum thickness. The thickness (T8) of the eighth lens (408) may be maximum at the center and minimum at the edge, with the maximum thickness ranging from 2 to 2.5 times the minimum thickness. The thickness (T9) of the ninth lens (409) may be minimum at the center and maximum at the edge, with the maximum thickness being within the range of 1.1 to 1.5 times the minimum thickness.

The thickness of each lens may satisfy any one of the following conditions.

0.1<CT1/ET1<0.5,2<ET1/CT1<2.5 Condition 1:

1<CT2/ET2<1.5,0.5<ET2/CT2<1 Condition 2:

0.5<CT3/ET3<1,1<ET3/CT3<1.5 Condition 3:

2.5<CT4/ET4<3,0.1<ET4/CT4<0.5 Condition 4:

1<CT5/ET5<1.5,0.5<ET5/CT5<1 Condition 5:

2.5<CT6/ET6<3,0.1<ET6/CT6<0.5 Condition 6:

0.5<CT7/ET7<1,1.5<ET7/CT7<2 Condition 7:

2<CT8/ET8<2.5,0.1<ET8/CT8<0.5 Condition 8:

0.5<CT9/ET9<1,1<ET9/CT9<1.5 Condition 9:

1<ΣCT/ΣET<1.2,0.5<ΣET/ΣCT<1 Condition 10:

Among the gaps (G1-G7) between the lenses, the first gap (G1) between the first and second lenses (401, 402) may have a maximum at the center and a minimum at the edge. The second gap (G2) between the second and third lenses (402, 403) may have a maximum at the center and a minimum at the edge. The third gap (G3) between the third and fourth lenses (403, 404) may have the maximum value at the edge and the minimum value at the center. The fourth gap (G4) between the fourth and fifth lenses (404, 405) may have the minimum value at the center and the maximum value at the edge. The fifth gap (G5) between the fifth and sixth lenses (405, 406) may have a minimum center and a maximum edge. The sixth gap (G6) between the sixth and seventh lenses (406, 407) may have a maximum center and a minimum edge. The seventh gap (G7) between the seventh and eighth lenses (407, 408) may have a maximum center and a minimum edge. The eighth gap (G8) between the eighth and ninth lenses (408, 409) may have a maximum center and a minimum edge.

FIGS. 42, 44, and 46 are graphs showing the diffraction MTF (modulation transfer function) at room temperature, low temperature, and high temperature in the optical system of FIG. 37, respectively. These graphs represent the modulation (luminance ratio) as a function of spatial frequency.

As shown in FIGS. 42, 44, and 46, the deviation of the MTF between room temperature and low or high temperatures in the fourth embodiment of the invention may be less than 10%, i.e., 7% or less. FIGS. 43, 45, and 47 are graphs showing the aberration characteristics at room temperature, low temperature, and high temperature in the optical system of FIG. 37.

The aberration graphs in FIGS. 43, 45, and 47 show the measured values of spherical aberration (Longitudinal Spherical Aberration), astigmatic field curves (Astigmatic Field Curves), and distortion (Distortion) from left to right. In FIGS. 43, 45, and 47, the X-axis represents the focal length (mm) and distortion (%) and the Y-axis represents the image height (height). Additionally, the graph for spherical aberration corresponds to light in the wavelength bands of approximately 435 nm, 486 nm, 546 nm, 587 nm, and 656 nm, while the graphs for astigmatic aberration and distortion aberration correspond to light in the wavelength band of approximately 546 nm.

In the aberration diagrams of FIGS. 43, 45, and 47, the closer each curve approaches the Y-axis at room temperature, low temperature, and high temperature, the better the aberration correction function is interpreted to be. The optical system (1300) according to the fourth embodiment shows that the measured values are adjacent to the Y-axis in almost all areas. In other words, the optical system (1300) according to the fourth embodiment has improved resolution and can achieve good optical performance not only in the central part of the field of view (FOV) but also in the peripheral areas. Here, low temperature may refer to −20 °C or below, for example, −20 °C to −40 °C, room temperature may refer to 22 °C±5 °C or 18 °C to 27 °C, and high temperature may refer to 85 °C or above, for example, 85 °C to 405 °C.

As a result, as shown in FIGS. 43, 45, and 47, it can be seen that the reduction in brightness modulation from low temperature to high temperature is less than 10%, for example, 5% or less, or remains almost unchanged.

Table 12 compares changes in optical characteristics such as EFL, BFL, F-number (F #), TTL, and field of view (FOV_D) in the optical system according to the fourth embodiment. It can be seen that the change rate of optical characteristics at low temperatures relative to room temperature is 5% or less, for example, 3% or less, and the change rate of optical characteristics at low temperatures relative to room temperature is 5% or less, for example, 3% or less.

TABLE 12

| | | | | low | high |
|---|---|---|---|---|---|
| | Room | low | high | temperature/ | temperature/ |
| | temper- | temper- | temper- | Room | Room |
| | ature | ature | ature | temperature | temperature |
| EFL(F) | 6.23 | 6.19 | 6.28 | 99.35% | 100.80% |
| BFL | 1.60 | 1.60 | 1.60 | 100.00% | 100.00% |
| F# | 1.64 | 1.63 | 1.65 | 99.39% | 100.60% |
| TTL | 30.00 | 29.93 | 30.09 | 99.76% | 100.3% |
| FOV_D | 99.66 | 100.42 | 98.71 | 100.76% | 99.04% |

Therefore, as shown in Table 12, the changes in optical characteristics due to temperature changes from low to high temperatures, such as the change rate of the effective focal length (EFL), TTL, BFL, F number, and field of view (FOV_D), are 10% or less, i.e., 5% or less, for example, within the range of 0 to 5%. This design allows for temperature compensation of the plastic lens, even when using one or more plastic lenses, thereby preventing a decrease in the reliability of optical characteristics.

The optical system of the fourth embodiment disclosed above can effectively control aberration characteristics such as chromatic aberration and distortion aberration, and can achieve good optical performance not only in the center but also in the peripheral areas of the field of view (FOV).

The optical systems (1000, 1100, 1200, 1300) according to the first to fourth embodiments described above may satisfy at least one or more of the mathematical equations described below. Accordingly, the optical systems (1000, 1100, 1200, 1300) according to the first to fourth embodiments may have improved optical characteristics. For example, when the optical system (1000, 1100, 1200, 1300) satisfies at least one mathematical equation, the optical system (1000, 1100, 1200, 1300) can effectively control aberration characteristics such as chromatic aberration and distortion aberration, and can have good optical performance not only in the central part but also in the peripheral part of the field of view (FOV). Additionally, the optical system (1000, 1100, 1200, 1300) can achieve improved resolution. Furthermore, the thickness of the lenses at their optical axes (OA) and the gap between adjacent lenses at their optical axes (OA) as specified in the mathematical equations can be referenced in the first to fourth embodiments described above.

0.2<CG1/ΣCG<0.7 [Mathematical Equation 1]

In Mathematical Equation 1, CG1 is the center gap between the first lens (101, 201, 301, 401) and the second lens (102, 202, 302, 402), and ΣCG is the sum of the gaps between adjacent lenses. When Mathematical Equation 1 is satisfied, the light emitted from the first lens (101, 201, 301, 401), which has a significant influence on the entire optical system, sets the light path for the light entering the remaining lenses, and the optical system can achieve good optical performance at the set field of view and focal length. In the first to fourth embodiments, Mathematical Equation 1 may preferably satisfy 0.3<CG1/ΣCG<0.7.

0.1<CG1/ΣCT<0.5 [Mathematical Equation 2]

In Mathematical Equation 2, CG1 is the center gap between the first lens (101, 201, 301, 401) and the second lens (102, 202, 302, 402), and ΣCT is the sum of the center thicknesses of the lenses. When Mathematical Equation 2 is satisfied, the light emitted from the first lens (101, 201, 301, 401), which has a significant influence on the entire optical system, sets the light path for the light entering the remaining lenses, and the optical system can achieve good optical performance at the set field of view and focal length. In the first to fourth embodiments, Mathematical Equation 2 may preferably satisfy 0.1<CG1/ΣCT<0.4.

0.1<CG1/TTL<0.5 [Mathematical Equation 3]

In Mathematical Equation 3, CG1 is the center gap between the first lens (101, 201, 301, 401) and the second lens (102, 202, 302, 402), the distance (mm) along the optical axis (OA) from the center of the first surface (S1) of the first lens (101, 201, 301, 401) to the image surface of the image sensor (500), which is the TTL, can be determined. When Mathematical Equation 3 is satisfied, the light emitted from the first lens (101, 201, 301, 401), which has a significant influence on the entire optical system, is set to the remaining lenses, and the optical system can achieve good optical performance at the set field of view and focal length. In the first to fourth embodiments, Mathematical Equation 3 may preferably satisfy 0.1<CG1/TTL<0.3.

70<v1<90 [Mathematical Equation 4]

In Mathematical Equation 4, v1 is the Abbe number of the first lens (101, 201, 301, 401). In the optical system (1000, 1100, 1200, 1300), the influence of the first lens (101, 201, 301, 401) may be the greatest, and by increasing the Abbe number, dispersion can be minimized and chromatic aberration can be reduced. In the first to fourth embodiments, Mathematical Equation 4 may preferably satisfy the condition 75<v1<85.

0.5<ΣCT/TTL<0.8 [Mathematical Equation 5]

Mathematical Equation 5 sets the relationship between the sum of the center thicknesses (ΣCT) of the first to ninth lenses (101-109, 201-209, 301-309, 401-409) and TTL, which is a distance (mm) from the center of first surface (S1) of the first lenses (101, 201, 301, 401) to an image surface of image sensor (500) on the optical axis (OA).

To reduce TTL, more light refraction must occur. To increase light refraction, the power of the lenses must be increased, and to increase power, the lenses must be made thicker. If the value is below the lower limit of Mathematical Equation 5, the total thickness of the lenses decreases, resulting in weaker refractive power. If the value exceeds the upper limit of Mathematical Equation 5, the total thickness of the lenses increases excessively, leading to a problem of increase in TTL. In the first to fourth embodiments, Mathematical Equation 5 may preferably satisfy 0.5<ΣCT/TTL<0.7.

0.1<ΣCG/TTL<0.5 [Mathematical Equation 6]

Mathematical Equation 6 shows the relationship between the sum of the lens gaps between adjacent lenses (ΣCG) among the first to ninth lenses (101-109, 201-209, 301-309, 401-409) and the distance (mm) from the center of the first surface (S1) to the image surface of the image sensor (500) along the optical axis (OA), which is called TTL. To reduce TTL, more light refraction is required. To increase light refraction, the power of the lenses must be increased, and to increase power, the lenses must be made thicker. If the value is below the lower limit of Mathematical Equation 6, the total thickness of the lenses decreases, resulting in weaker refractive power and a power weaker than the desired value. If the upper limit of Mathematical Equation 6 is exceeded, the total thickness of the lenses increases excessively, causing the TTL to increase. In the first to fourth embodiments, Mathematical Equation 6 may preferably satisfy 0.2<ΣCG/TTL<0.4.

1.5<ΣCT/ΣCG<2.5 [Mathematical Equation 7]

In Mathematical Equation 7, ΣCT is the sum of the center thicknesses of the lenses, and ΣCG is the sum of the gaps between adjacent lenses. When Mathematical Equation 7 is satisfied, the optical system can achieve good optical performance at the specified field of view and focal length, and the TTL can be reduced. In the first to fourth embodiments, Mathematical Equation 7 may preferably satisfy 1.7<ΣCT/ΣCG<2.5.

25<ΣAbb/ΣIndex<40 [Mathematical Equation 8]

In Mathematical Equation 8, ΣAbb denotes the sum of the Abbe numbers of each lens, and ΣIndex denotes the sum of the refractive indices at the d-line of each lens. When Mathematical Equation 8 is satisfied, the optical system (1000, 1100, 1200, 1300) can achieve improved aberration characteristics and resolution. By setting the sum of the Abbe numbers and the sum of the refractive indices of the lenses according to Mathematical Equation 8, the optical characteristics can be controlled. In the first to fourth embodiments, Mathematical Equation 8 may preferably satisfy 28<ΣAbb/ΣIndex<35.

1<ΣCT/ΣET<1.5 [Mathematical Equation 9]

In Mathematical Equation 9, ΣCT is the sum of the center thicknesses of the lenses, and SET is the sum of the edge thicknesses, i.e., the ends of the effective areas of the lenses. When Mathematical Equation 9 is satisfied, the optical system can achieve good optical performance at the specified field of view and focal length, and the TTL can be reduced. In the first to fourth embodiments, Mathematical Equation 9 may preferably satisfy 1<ΣCT/ΣET<1.2.

0.1<CT1/ET1<0.6 [Mathematical Equation 10]

In Mathematical Equation 10, CT1 is the center thickness of the first lens (101, 201, 301, 401), and ET1 is the edge thickness of the first lens (101, 201, 301, 401). This allows setting the elements that affect the field of view of the optical system and the elements that affect the effective focal length (EFL). In the first to fourth embodiments, Mathematical Equation 10 may preferably satisfy 0.3<CT1/ET1<0.6.

1<GLCa_AVER/PLCa_AVER<1.5 [Mathematical Equation 11]

In Mathematical Equation 11, GLCa_AVER represents the average effective diameter of glass lenses, and PLCa_AVER represents the average effective diameter of plastic lenses. The lens barrel in which the lens unit is disposed has at least one inner barrel inside the lens barrel, and at least some of the plastic lenses included in the lens unit may be disposed in the inner barrel. For plastic lenses, due to their high expansion at high temperatures, they require a wider space within the lens barrel. By setting the effective diameter of the glass lens and the effective diameter of the plastic lens in Mathematical Equation 11, it is possible to suppress the degradation of optical characteristics due to temperature changes. The optical system (1000, 1100, 1200, 1300) can control the incident light and set elements that affect aberrations. In the first to fourth embodiments, Mathematical Equation 11 may preferably satisfy the condition 1<GLCa_AVER/PLCa_AVER<1.2.

1<CA_L1S1/CA_L1S2<2 [Mathematical Equation 12]

In Mathematical Equation 12, CA_L1S1 denotes the effective diameter of the first surface (S1) of the first lens (101, 201, 301, 401), and CA_L1S2 denotes the effective diameter of the second surface (S2) of the first lens (101, 201, 301, 401). When Mathematical Equation 12 is satisfied, degradation of optical characteristics due to temperature changes can be suppressed, and the optical system (1000, 1100, 1200, 1300) can control incident light and set elements that affect aberrations. In the first to fourth embodiments, Mathematical Equation 12 may preferably satisfy 1.5<CA_L1S1/CA_L1S2<1.8.

1<CA_L1/CA_L9<1.5 [Mathematical Equation 13]

In Mathematical Equation 13, CA_L1 denotes the effective diameter of the first lens (101, 201, 301, 401), and CA_L9 denotes the effective diameter of the ninth lens (109, 209, 309, 409). The lens barrel in which the lens unit is mounted includes at least one inner barrel, and at least some of the plastic lenses included in the lens unit may be mounted in the inner barrel. Plastic lenses require more space in the lens barrel due to their high expansion at high temperatures. Therefore, when the Mathematical Equation 13, which defines the relationship between the effective diameter of the first lens (101, 201, 301, 401) made of glass material and the effective diameter of the ninth lens (109, 209, 309, 409) made of plastic material, is satisfied, the degradation of optical characteristics due to temperature changes can be suppressed, and the optical system (1000, 1100, 1200, 1300) can control the incident light and set elements that affect aberrations. In the first to fourth embodiments, Mathematical Equation 13 may preferably satisfy 1<CA_L1/CA_L9<1.3.

2<CA_L1/ImgH<2.5 [Mathematical Equation 14]

Mathematical Equation 14 may establish the relationship between the effective diameter (CA_L1) of the first lens (101, 201, 301, 401) and ImgH, which is half the maximum diagonal length of the image sensor. When Mathematical Equation 14 is satisfied, the TTL is suitable for a vehicle optical system and can satisfy the specified field of view. If the value is below the lower limit of Mathematical Equation 14, the effective diameter of the lens in the optical system (1000, 1100, 1200, 1300) becomes the largest, resulting in an issue where the TTL becomes excessively long. If the upper limit of Mathematical Equation 14 is exceeded, the field of view becomes excessively large compared to the field of view satisfied by the optical system (1000, 1100, 1200, 1300). In the first to fourth embodiments, Mathematical Equation 14 may preferably satisfy 2.2<CA_L1/ImgH<2.4.

0.5<CT_Max/CG_Max<1.2 [Mathematical Equation 15]

In Mathematical Equation 15, CT_Max is the maximum center thickness among the lenses, and CG_Max is the maximum gap between adjacent lenses. When Mathematical Equation 15 is satisfied, the optical system can achieve good optical performance at the set field of view and focal length, and the TTL can be reduced. In the first to fourth embodiments, Mathematical Equation 15 may preferably satisfy 0.8<CT_Max/CG_Max<1.1.

1.5<CA_max/CA_min<2.5 [Mathematical Equation 16]

In Mathematical Equation 16, CA_max represents the maximum effective diameter among the object-side surfaces and sensor-side surfaces of the lenses, and CA_min represents the minimum effective diameter among the object-side surfaces and sensor-side surfaces of the lenses. When Mathematical Equation 16 is satisfied, the optical system can maintain optical performance while setting the size for a slim and compact structure. In the first to fourth embodiments, Mathematical Equation 16 may preferably satisfy the condition 1.8<CA_max/CA_min<2.2.

1.5<CA_max/CA_Aver<2 [Mathematical Equation 17]

In Mathematical Equation 17, CA_max represents the maximum effective diameter between the object side surfaces and sensor side surfaces of the lenses, and CA_Aver represents the average effective diameter between the object side surfaces and sensor side surfaces of the lenses. When Mathematical Equation 17 is satisfied, the optical system can maintain optical performance while setting the size for a slim and compact structure. In the first to fourth embodiments, Mathematical Equation 17 may preferably satisfy the condition 1.5<CA_max/CA_Aver<1.8.

0.5<CA_min/CA_Aver<1 [Mathematical Equation 18]

In Mathematical Equation 18, CA_Min represents the minimum effective diameter between the object side surfaces and sensor side surfaces of the lenses, and CA_Aver represents the average effective diameter between the object side surfaces and sensor side surfaces of the lenses. When Mathematical Equation 18 is satisfied, the optical system can maintain optical performance while setting the size for a slim and compact structure. In the first to fourth embodiments, Mathematical Equation 18 may preferably satisfy the condition 0.7<CA_min/CA_Aver<0.9.

2<CA_max/ImgH<3 [Mathematical Equation 19]

Mathematical Equation 19 shows that CA_max represents the maximum effective diameter among the object side surfaces and sensor side surfaces of the lenses, and Imgh denotes half of the maximum diagonal length of the image sensor (500). When Mathematical Equation 19 is satisfied, the optical system can maintain good optical performance and set the size for a slim and compact structure. In the first to fourth embodiments, Mathematical Equation 19 may preferably satisfy 2.5<CA_max/ImgH<3.

25<TTL<35 [Mathematical Equation 20]

In Mathematical Equation 20, TTL (Total track length) denotes the distance (mm) along the optical axis (OA) from the center of the first surface (S1) of the first lens (101, 201, 301, 401) to the image surface of the image sensor (500). When Mathematical Equation 20 is satisfied, a suitable vehicle optical system can be provided. In the first to fourth embodiments, Mathematical Equation 20 may preferably satisfy 28<TTL<32.

5<ImgH<7 [Mathematical Equation 21]

In Mathematical Equation 21, ImgH denotes ½ of the maximum diagonal length of the image sensor (500). Mathematical Equation 21 can set the diagonal size (ImgH) of the image sensor (500) and provide an optical system with a vehicle sensor size. In the first to fourth embodiments, Mathematical Equation 21 may preferably satisfy 5<ImgH<6.

1<BFL<2.5 [Mathematical Equation 22]

In Mathematical Equation 22, BFL is the optical axis distance from the image sensor (500) to the center of the sensor side surface of the last lens. When Mathematical Equation 22 is satisfied, the installation space for the filter (600) and cover glass can be secured, and the assembly of components can be improved through the gap between the image sensor (500) and the last lens, thereby improving the coupling reliability. In the first to fourth embodiments, Mathematical Equation 22 may preferably satisfy 1.3<BFL<2.5. If BFL is less than the range of Mathematical Equation 22, some light proceeding toward the image sensor may not be transmitted to the image sensor, which can cause a decrease in resolution. If BFL exceeds the range of Mathematical Equation 22, stray light may enter, leading to deterioration in the optical system's aberration characteristics.

2<F<5 [Mathematical Equation 23]

Mathematical Equation 23 allows the total focal length (F) to be set to suit the vehicle optical system. In the first to fourth embodiments, Mathematical Equation 23 may satisfy 2<F<3.

80<FOV_H<90 [Mathematical Equation 24]

In Mathematical Equation 24, FOV_H denotes the horizontal field of view (degrees) of the optical system (1000, 1100, 1200, 1300) and can provide a field of view suitable for an automotive optical system. Preferably, in the first to fourth embodiments, 80<FOV_H<85 may be satisfied.

1.5<TTL/CA_max<2.5 [Mathematical Equation 25]

In Mathematical Equation 25, CA_max refers to the largest effective diameter (mm) among the object side surfaces and sensor side surfaces of multiple lenses, TTL (Total track length) denotes the distance (mm) along the optical axis (OA) from the vertex of the first surface (S1) of the first lens (101, 201, 301, 401) to the image surface of the image sensor (500). Mathematical Equation 25 establishes the relationship between the total optical axis length of the optical system and the maximum effective diameter, thereby enabling the provision of an improved vehicle optical system. In the first to fourth embodiments, Mathematical Equation 25 may preferably satisfy the condition 1.8<TTL/CA_max<2.2.

5<TTL/ImgH<6 [Mathematical Equation 26]

Mathematical Equation 26 defines TTL (Total track length) as the distance (mm) along the optical axis (OA) from the vertex of the first surface (S1) of the first lens to the image surface of the image sensor (500), and ImgH as half of the maximum diagonal length of the image sensor (500). When Mathematical Equation 26 is satisfied, the optical system (1000, 1100, 1200, 1300) can have a TTL suitable for use with a vehicle-mounted image sensor (500), thereby providing improved image quality. In the first to fourth embodiments, Mathematical Equation 26 may preferably satisfy the condition 5.5<TTL/ImgH<6.

0.1<BFL/ImgH<0.5 [Mathematical Equation 27]

In Mathematical Equation 27, BFL is the optical axis distance from the image sensor (500) to the center of the sensor side surface of the last lens, and ImgH is ½ of the maximum diagonal length of the image sensor (500). When Mathematical Equation 27 is satisfied, the optical system (1000, 1100, 1200, 1300) can secure the BFL (back focal length) required to accommodate the size of the vehicle-mounted image sensor (500), set the gap between the last lens and the image sensor (500), and achieve good optical characteristics in both the central and peripheral regions of the field of view (FOV). In the first to fourth embodiments, Mathematical Equation 27 may preferably satisfy the condition 0.2<BFL/ImgH<0.5.

10<TTL/BFL<22 [Mathematical Equation 28]

In Mathematical Equation 28, TTL (Total track length) refers to the distance (mm) along the optical axis (OA) from the vertex of the first surface (S1) of the first lens (101, 201, 301, 401) to the image surface of the image sensor (500). BFL denotes the optical axis distance from the image sensor (500) to the center of the sensor side surface of the last lens. If Mathematical Equation 28 is satisfied, the optical system (1000, 1100, 1200, 1300) can secure BFL. In the first to fourth embodiments, Mathematical Equation 28 may preferably satisfy 12<TTL/BFL<21.5.

3<TTL/F<7 [Mathematical Equation 29]

Mathematical Equation 29 denotes that TTL (Total track length) is the distance (mm) along the optical axis (OA) from the vertex of the first surface (S1) of the first lens (101, 201, 301, 401) to the image surface of the image sensor (500), and F is the effective focal length of the optical system. Accordingly, an optical system for a driver assistance system can be provided. When the optical system (1000, 1100, 1200, 1300) according to the embodiment satisfies Mathematical Equation 29, the optical system (1000, 1100, 1200, 1300) can have an appropriate focal length within the set TTL range and maintain an appropriate focal length even when the temperature changes from low to high, thereby providing an optical system capable of forming an image. If the value is below the lower limit of Mathematical Equation 29, it is necessary to increase the refractive power of the lenses, making it difficult to correct spherical aberration or distortion aberration. If the value exceeds the upper limit of Mathematical Equation 29, the lenses may become longer in effective diameter or TTL, leading to the problem of the imaging lens system becoming larger. In the first to fourth embodiments, Mathematical Equation 29 may preferably satisfy the condition 4<TTL/F<5.

2<F/BFL<5 [Mathematical Equation 30]

In Mathematical Equation 30, F is the effective focal length of the optical system and BFL is the optical axis distance from the image sensor (500) to the center of sensor side surface of the last lens. When Mathematical Equation 30 is satisfied, the optical system (1000, 1100, 1200, 1300) has the set field of view and appropriate focal length, and can be provided as a vehicle optical system. Additionally, the optical system (1000, 1100, 1200, 1300) can minimize the gap between the last lens and the image sensor (500), thereby achieving good optical characteristics in the peripheral areas of the field of view (FOV). In the first to fourth embodiments, the Mathematical Equation 30 may preferably satisfy 2.5<F/BFL<5.

1<F/ImgH<2 [Mathematical Equation 31]

In Mathematical Equation 31, F is the effective focal length of the optical system and ImgH is ½ of the maximum diagonal length of the image sensor (500). Such an optical system (1000, 1100, 1200, 1310) can have improved aberration characteristics in the size of a vehicle image sensor (500). In the first to fourth embodiments, Mathematical Equation 31 may preferably satisfy 1<F/ImgH<1.5.

$$[ Mathematical Equation 32 ]$$

$$z = \frac{{cY}^{2}}{1 + \sqrt{1 - ( 1 + K ) {c}^{2} {Y}^{2}}} + {AY}^{4} + {BY}^{5} + {CY}^{4} + {DY}^{5} + {EY}^{4} + …$$

In Mathematical Equation 32, Z, as Sag, may represent the distance in the direction of the optical axis from any point on the aspherical surface to the vertex of the aspherical surface. Y may represent the distance in the direction perpendicular to the optical axis from an arbitrary point on the aspheric surface to the optical axis. c may represent the curvature of the lens, and K may represent the conic constant. Additionally, A, B, C, D, E, and F may represent aspheric constants.

The optical system (1000, 1100, 1200, 1300) according to the first to fourth embodiments may satisfy at least one or more of the Mathematical Equations 1 to 32. In this case, the optical system (1000, 1100, 1200, 1300) may have improved optical characteristics. In detail, when the optical system (1000, 1100, 1200, 1300) satisfies at least one or more of the Mathematical Equations 1 to 32, the optical system (1000, 1100, 1200, 1300) has improved resolution and can improve aberration and distortion characteristics. Additionally, the optical system (1000, 1100, 1200, 1300) can secure the back focal length (BFL) required for applying a vehicle-mounted image sensor (500), compensate for optical characteristic degradation caused by temperature changes, and minimizes the distance between the last lens and the image sensor (500), ensuring good optical performance in both the central and peripheral areas of the field of view (FOV).

Table 13 shows the results of the Mathematical Equations 1 to 31 described above for the optical system (1000, 1100, 1200, 1300) of the embodiment. Referring to Table 13, it can be seen that the optical system (1000, 1100, 1200, 1300) satisfies at least one, two or more, or three or more of the Mathematical Equations 1 to 31. In detail, the optical system (1000, 1100, 1200, 1300) according to the embodiment satisfies all of the Mathematical Equations 1 to 31. As a result, the optical system (1000, 1100, 1200, 1300) can have good optical performance in both the central and peripheral regions of the field of view (FOV) and excellent optical characteristics.

TABLE 13

| | | First | second | third | Fourth |
|---|---|---|---|---|---|
| Mathematical Equation | | embodiment | embodiment | embodiment | embodiment |
| 1 | 0.2 < CG1/ΣCG < 0.7 | 0.675 | 0.545 | 0.582 | 0.397 |
| 2 | 0.1 < CG1/ΣCT < 0.5 | 0.339 | 0.271 | 0.309 | 0.164 |
| 3 | 0.1 < CG1/TTL < 0.5 | 0.208 | 0.172 | 0.192 | 0.110 |
| 4 | 70 < v1 < 90 | 81.607 | 81.607 | 81.607 | 81.607 |
| 5 | 0.5 < ΣCT/TTL < 0.8 | 0.614 | 0.635 | 0.623 | 0.670 |
| 6 | 0.1 < ΣCG/TTL < 0.5 | 0.309 | 0.316 | 0.331 | 0.277 |
| 7 | 1.5 < ΣCT/ΣCG < 2.5 | 1.988 | 2.012 | 1.883 | 2.417 |
| 8 | 25 < ΣAbb/ΣIndex < 40 | 30.158 | 30.158 | 30.158 | 30.664 |
| 9 | 1 < ΣCT/ΣET < 1.5 | 1.033 | 1.053 | 1.047 | 1.059 |
| 10 | 0.1 < CT1/ET1 < 0.6 | 0.421 | 0.514 | 0.490 | 0.409 |
| 11 | 1 < GLCa_AVER/PLCa_AVER < 1.5 | 1.168 | 1.116 | 1.157 | 1.113 |
| 12 | 1 < CA_L1S1/CA_L1S2 < 2 | 1.667 | 1.652 | 1.652 | 1.684 |
| 13 | 1 < CA_L1/CA_L9 < 1.5 | 1.245 | 1.166 | 1.244 | 1.150 |
| 14 | 2 < CA_L1/ImgH < 2.5 | 2.386 | 2.235 | 2.354 | 2.311 |
| 15 | 0.5 < CT_Max/CG_Max < 1.2 | 0.560 | 0.723 | 0.606 | 1.059 |
| 16 | 1.5 < CA_max/CA_min < 2.5 | 2.024 | 1.925 | 2.028 | 2.118 |
| 17 | 1.5 < CA_max/CA_Aver < 2 | 1.684 | 1.602 | 1.666 | 1.608 |
| 18 | 0.5 < CA_min/CA_Aver < 1 | 0.832 | 0.832 | 0.822 | 0.759 |
| 19 | 2 < CA_max/ImgH < 3 | 2.982 | 2.785 | 2.933 | 2.900 |
| 20 | 25 < TTL < 35 | 30.000 | 30.000 | 30.000 | 30.000 |
| 21 | 5 < ImgH < 7 | 5.145 | 5.145 | 5.145 | 5.145 |
| 22 | 1 < BFL < 2.5 | 2.300 | 1.467 | 1.400 | 1.600 |
| 23 | 5 < F < 7 | 6.230 | 6.230 | 6.230 | 6.230 |
| 24 | 80 < FOV_H < 90 | 83.0 | 83.0 | 83.0 | 83.0 |
| 25 | 1.5 < TTL/CA_max < 2.5 | 1.955 | 2.094 | 1.988 | 2.011 |
| 26 | 5 < TTL/ImgH < 6 | 5.831 | 5.831 | 5.831 | 5.831 |
| 27 | 0.1 < BFL/ImgH < 0.5 | 0.447 | 0.285 | 0.272 | 0.311 |
| 28 | 10 < TTL/BFL < 22 | 13.043 | 20.450 | 21.429 | 18.750 |
| 29 | 3 < TTL/F < 7 | 4.815 | 4.815 | 4.815 | 4.815 |
| 30 | 2 < F/BFL < 5 | 2.709 | 4.247 | 4.450 | 3.894 |
| 31 | 1 < F/ImgH < 2 | 1.211 | 1.211 | 1.211 | 1.211 |

FIG. 49 is an example of a plan view of a vehicle to which a camera module or optical system according to an embodiment of the invention is applied. Referring to FIG. 49, a vehicle camera system according to an embodiment of the invention includes an image generation unit (11), a first information generation unit (12), a second information generation unit (21, 22, 23, 24, 25, 26), and a control unit (14). The image generation unit (11) may include at least one camera module (31) disposed on his or her vehicle, and may capture the front of the his or her vehicle and/or the driver to generate a front view image of the his or her vehicle or an interior view image of the his or her vehicle. The image generation unit (11) can capture not only the front of the his or her vehicle but also the surroundings of the his or her vehicle in one or more directions using the camera module (31) to generate a surrounding image of the his or her vehicle. Here, the front video and surrounding video may be digital video and may include color video, black-and-white video, and infrared video. Additionally, the front video and surrounding video may include still images and moving images. The video generation unit (11) provides the driver video, front video, and surrounding video to the control unit (14).

Next, the first information generation unit (12) may include at least one radar and/or camera disposed on the his or her vehicle, and detects the front of the his or her vehicle to generate first detection information. Specifically, the first information generation unit (12) is disposed on the his or her vehicle and detects the positions and speeds of vehicles located in front of the his or her vehicle, the presence and positions of pedestrians, etc., to generate the first detection information.

Using the first detection information generated by the first information generation unit (12), it is possible to control the distance between the his or her vehicle and a vehicle in front to maintain a constant distance, and to enhance the stability of vehicle operation in specific cases such as when the driver wishes to change the driving lane of the vehicle or during reverse parking. The first information generation unit (12) provides the first detection information to the control unit (14). The second information generation unit (21, 22, 23, 24, 25, 26) generates second detection information by detecting each side of the his or her vehicle based on the front video generated by the video generation unit (11) and the first detection information generated by the first information generation unit (12). Specifically, the second information generation unit (21, 22, 23, 24, 25, 26) may include at least one radar and/or camera disposed on the his or her vehicle, and may detect the positions and speeds of vehicles located on the sides of the his or her vehicle or capture images. Here, the second information generation unit (21, 22, 23, 24, 25, 26) may be disposed at the front corners, side mirrors, and rear center and rear corners of the his or her vehicle.

Among these vehicle camera systems, at least one information generation unit may be equipped with an optical system described in the above-mentioned embodiment and a camera module having the same, and may provide or process information obtained through the front, rear, each side, or corner areas of the vehicle to the user to protect the vehicle and objects from automatic driving or surrounding safety hazards.

The optical system of the camera module according to the embodiments of the invention may be installed in multiple units within a vehicle for safety regulations, enhanced autonomous driving functions, and increased convenience. Additionally, the optical system of the camera module is applied within a vehicle as a component for controlling systems such as the Lane Keeping Assistance System (LKAS), Lane Departure Warning System (LDWS), and Driver Monitoring System (DMS). Such vehicle camera modules can provide stable optical performance even under varying ambient temperatures and offer cost-competitive modules, thereby ensuring the reliability of vehicle components.

The features, structures, and effects described in the above embodiments are included in at least one embodiment of the present invention and are not necessarily limited to a single embodiment. Furthermore, the features, structures, and effects illustrated in each embodiment may be combined or modified by those skilled in the art to be practiced in other embodiments. Therefore, the contents related to such combinations and modifications should be interpreted as falling within the scope of the present invention.

Additionally, although the above description has focused on the embodiments, these are merely examples and do not limit the present invention. Those skilled in the art will understand that various modifications and applications not explicitly described herein are possible within the scope of the present invention, provided that they do not depart from the essential characteristics of the embodiments. For example, each component specifically shown in the embodiments may be modified. Any differences related to such modifications and applications should be interpreted as falling within the scope of the present invention as defined in the appended claims.

1. An optical system comprising first to ninth lenses disposed along an optical axis and each lens having an object side and a sensor side, wherein the first lens has negative (−) refractive power, the fourth lens has positive (+) refractive power, the sixth lens has positive (+) refractive power, the seventh lens has negative (−) refractive power, the eighth lens has positive (+) refractive power, and the ninth lens has negative (−) refractive power,
wherein a thickness of the eighth lens is the largest among thicknesses of the first to ninth lenses on the optical axis,
wherein a distance between the first lens and the second lens is the largest among distances between adjacent lenses on the optical axis, and
wherein the ninth lens has a convex meniscus shape toward the sensor side.

2. The optical system of claim 1, wherein at least one of the first lens and the fourth lens is made of glass, and
wherein at least one of the second to third lenses and the fifth to ninth lenses is made of plastic.

3. The optical system of claim 1, wherein an aperture is disposed between the second lens and the third lens, wherein at least one of the curvature radii of the sensor side surface of the second lens facing the aperture and the curvature radii of the sensor side surface of the third lens satisfy the range of 10 or more to 20 or less.

4. The optical system of claim 1, wherein the object side of the first lens has a convex meniscus shape.

5. The optical system of claim 1, wherein the absolute value of the focal length of the fifth lens is the largest among the first to ninth lenses.

6. The optical system of claim 1, wherein a maximum distance between the two lenses with the largest difference in Abbe number among the lenses disposed adjacent to each other from the optical axis to the effective diameter area is smaller than the maximum distance between other adjacent pairs of lenses.

7. The optical system of claim 1, wherein the sixth lens and the seventh lens have a largest difference in Abbe number among the adjacent lenses.

8. The optical system of claim 1, satisfying the following condition:
0.2<CG1/ΣCG<0.7 <Condition>
(In the above condition, CG1 is the distance between the first lens and the second lens on the optical axis, and ΣCG is the sum of the gaps between adjacent lenses on the optical axis).

9. The optical system of claim 1, satisfying the following condition:
5<TTL/ImgH<6 <Condition>
(In the above condition, TTL is the distance along the optical axis from the vertex of the object side surface of the first lens to an image surface of an image sensor, and ImgH is ½ of a maximum diagonal length of the image sensor).

10. An optical system comprising first to ninth lenses disposed along an optical axis and each lens having an object side and a sensor side, wherein the first lens has a negative (−) refractive power, the fourth lens has a positive (+) refractive power, the sixth lens has a positive (+) refractive power, the seventh lens has a negative (−) refractive power, the eighth lens has a positive (+) refractive power, and the ninth lens has a negative (−) refractive power,
wherein an effective diameter of the second lens or the third lens is the smallest among effective diameters of the first to ninth lenses,
wherein the effective diameter of the first lens is the largest among the first to ninth lenses, and
wherein the ninth lens has a convex meniscus shape toward the sensor side.

11. The optical system of claim 10, wherein a distance between the first lens and the second lens is the largest among distances between adjacent lenses on the optical axis.

12. The optical system of claim 10, wherein an aperture is disposed between the third lens and the fourth lens,
wherein the optical system comprises a first lens group disposed on the object side with respect to the aperture and a second lens group disposed on the sensor side with respect to the aperture, and
wherein a sign of a composite focal length of the first lens group is different from that of the second lens group.

13. The optical system of claim 10, wherein at least one of the lenses disposed on the object side and sensor side of the aperture is made of glass.

14. The optical system of claim 10, wherein a maximum distance between the sixth lens and the seventh lens, from the optical axis to the effective diameter area, is smaller than the maximum distance between other adjacent lenses.

15. The optical system of claim 10, satisfying the following condition:
1.5<ΣCT/ΣCG<2.5 <Condition>
(In the above condition, ΣCT refers to the sum of center thicknesses of the first to ninth lenses on the optical axis, and ΣCG refers to the sum of gaps between adjacent lenses on the optical axis).

16. An optical system comprising first to ninth lenses disposed along an optical axis and each lens having an object side and a sensor side, wherein the first lens has a negative (−) refractive power, the second lens has a negative (−) refractive power, the third lens has a positive (+) refractive power, the fourth lens has a positive (+) refractive power, the fifth lens has a negative (−) refractive power, the sixth lens has a positive (+) refractive power, the seventh lens has a negative (−) refractive power, the eighth lens has a positive (+) refractive power, and the ninth lens has a negative (−) refractive power,
wherein the ninth lens has a convex meniscus shape toward the sensor side.

17. The optical system of claim 16, wherein at least one of the first lens and the fourth lens is made of glass, and
wherein at least one of the second to third lenses and the fifth to ninth lenses is made of plastic.

18. The optical system of claim 16, wherein an aperture is disposed between the second lens and the third lens,
wherein at least one of the curvature radii of the sensor side surface of the second lens facing the aperture and the curvature radii of the sensor side surface of the third lens satisfy the range of 10 or more to 20 or less.

19. The optical system of claim 16, wherein the absolute value of a focal length of the fifth lens is the largest among the first to ninth lenses.

20. The optical system of claim 16, wherein a maximum distance between the two lenses with a largest difference in Abbe number among the lenses disposed adjacent to each other from the optical axis to an effective diameter area is smaller than the maximum distance between other adjacent pairs of lenses.
